(19) United States
(12) Patent Application Publication
(10) Pub. No.: US 2011/0114190 A1
(43) Pub. Date: May 19, 2011

(54) MICROFLUIDIC DROPLET GENERATION AND/OR MANIPULATION WITH ELECTRORHEOLOGICAL FLUID

(75) Inventors: Weijia Wen, Hong Kong (CN); Ping Sheng, Hong Kong (CN); Xize Niu, London (GB); Mengying Zhang, Hong Kong (CN); Jinbo Wu, Hong Kong (CN)

(73) Assignee: THE HONG KONG UNIVERSITY OF SCIENCE AND TECHNOLOGY, Hong Kong (CN)

(21) Appl. No.: 12/946,967

(22) Filed: Nov. 16, 2010

Related U.S. Application Data
(60) Provisional application No. 61/272,887, filed on Nov. 16, 2009.

(51) Int. Cl. F15D 1/00; B01L 3/00

(52) U.S. Cl. 137/1; 422/504

(57) ABSTRACT

The subject disclosure relates to microfluidic devices, systems and methodologies that facilitate generation of droplets, control, and/or manipulation thereof with electrorheological (ER) fluids. In one aspect, ER fluids can be employed with a carrier fluid or as a carrier fluid to enable droplet generation, control, and/or manipulation. As a further advantage, embodiments of the disclosed subject matter can include droplet generation, control, and/or manipulation for liquids, gases, combinations, etc. Further non-limiting embodiments are provided that illustrate the advantages and flexibility of the disclosed structures.

### CROSS-REFERENCE TO RELATED APPLICATIONS

This application claims priority to U.S. Provisional Patent Application Ser. No. 61/272,887, filed on Nov. 16, 2009, and entitled MICROFLUIDIC DROPLET GENERATION AND MANIPULATION WITH ELECTRORHEOLOGICAL FLUID, the entirety of which is hereby incorporated by reference.

### FIELD OF THE INVENTION

The subject disclosure relates to microfluidic devices, systems and methodologies and, more specifically, to structures, devices, and methods for generation of droplets and manipulation and/or control thereof.

### BACKGROUND OF THE INVENTION

The study of microfluidics concerns the behavior, precise control, and manipulation of fluids that are geometrically restricted to relatively dimensionally small spaces (e.g., spaces typically on a sub-millimeter scale). The field of microfluidics has found a diverse array of actual and potential applications ranging from drug delivery, point-of-care diagnostic chips, organic synthesis, micro reactors, etc.

In addition, droplet-based microfluidics has become increasingly attractive, because of its ability to perform a large number of different experiments without increasing the device size or complexity, for example. For instance, in droplet form, reagents can be conveyed precisely in discrete volumes (e.g. ranging from nanoliter to picoliter size), so that high throughput chemical reaction and single cell manipulation in bio-testing can be achieved. As a further example, mixing of reagents in droplet form has been proven to be achievable on the order of milliseconds, thus enabling multi-step chemical reactions via droplet microfluidics.

Digital microfluidics concerns the manipulation and/or control of droplets by use of digital signals (e.g., signals that can be referred to as a digital one (1) or a digital zero (0)), such as in lab-on-a-chip systems based upon micromanipulation of discrete droplets, etc. For example, droplet-based microfluidics can involve the generation, detection, control, and/or manipulation (e.g., fission, fusion, and/or sorting, etc.) of discrete droplets inside micro-devices.

Conventionally, droplet generation and/or manipulation has generally been accomplished through microfluidic channel geometry methods, such as flow-focusing geometry, as well as other active control methods such as electrowetting on dielectric (EWOD). However, it can be understood that forces involved in these active methods are usually small compared to hydrodynamic forces in microfluidic channels. As a result, it can be challenging to significantly alter droplets' flow behavior. In particular, dielectric electrostatic forces that can be employed to deflect droplets in microfluidic channels are usually small compared to the hydrodynamic forces in the microchannels. Accordingly, it is difficult to significantly alter droplets' flow behavior, which causes individual droplet manipulation to remain a challenge.

In other contemporary methods, mechanical forces can be utilized for droplet generation either in a multilayer chip or in a moving-wall approach. What's more, rheological characteristics of a fluid comprising droplets can be utilized to manipulate the droplets (e.g., ferrofluid droplets can be affected via a magnetic field, by tailoring its magneto-rheological properties, etc.). However, while individual droplet control and/or manipulation can be achieved, such approaches can suffer from difficulties associated with large-scale integration or fast-response actuation as a function of the relatively sizable magnetic coils and/or fast heat transfer required inside associated chips.

In yet other fields, electrorheological (ER) fluids have been studied on a macro scale as a type of “smart” material. For example, ER fluids or suspensions can comprise a type of colloid whose rheological characteristics can be tunable under the application of an electric field. For instance, under a sufficiently strong electric field, ER fluids can transform into an anisotropic solid, with a yield stress characterizing its strength. As a further example, a transformation from liquid-like to solid-like behavior of an ER fluid can be very fast and can be reversible when the electric field is removed. Accordingly, ER fluids can provide simple, quiet, and fast interfaces between electrical controls and mechanical systems.

However, as described above, individual droplet manipulation remains a challenge. In addition, generation and/or manipulation of bubbles can be much more difficult, due in part to the differences between gas bubble characteristics as compared with typical liquid droplet characteristics. It is thus desired to provide structures, devices, and methods for microfluidic droplet generation and manipulation and/or control thereof with electrorheological fluid.

### SUMMARY OF THE INVENTION

The following presents a simplified summary of the specification in order to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

In various embodiments, the disclosed subject matter relates to active micro-droplet/bubble generation and/or manipulation, control, digitalization, etc. of droplets and/or bubbles using electrorheological fluids and electrical signals. Accordingly, various embodiments of the disclosed subject matter provide structures, devices, and/or methods for microfluidic droplet generation and manipulation and/or control thereof with electrorheological fluid. In a non-limiting aspect, ER fluids can be employed with a carrier fluid or as a carrier fluid to enable droplet generation, control, and/or manipulation. As a further advantage, embodiments of the disclosed subject matter can include droplet generation, control, and/or manipulation for liquids, gases, combinations, etc.

Accordingly, in non-limiting embodiments, exemplary microfluidic systems can comprise one or more channel network(s) that can facilitate generating and/or controlling one or more fluid droplet(s) comprising an ER fluid droplet, a non-ER fluid droplet, a gas bubble, etc. Exemplary microfluidic systems can further comprise one or more electrode(s) associated with a portion of the one or more channel network(s) and adapted to apply an electric field to a portion of the one or more channel network(s) to influence flow of an ER fluid to facilitate generating and/or controlling the one or more fluid droplet(s). In a non-limiting aspect, one or more electrode(s) can be further configured receive or send an electrical signal from or to a portion of a microfluidic controller component.

In addition, exemplary microfluidic methodologies can comprise applying an electric field to an ER fluid in a fluid channel to facilitate generating and/or manipulating one or more fluid droplet(s) in the fluid channel. In other embodiments, microfluidic devices that facilitate generating and/or controlling one or more fluid droplet(s) are provided according to various aspects of the disclosed subject matter.

These and other additional features of the disclosed subject matter are described in more detail below.

### BRIEF DESCRIPTION OF THE DRAWINGS

The devices, structures, and methodologies of the disclosed subject matter are further described with reference to the accompanying drawings in which:

FIG. 1 is a schematic illustration depicting non-limiting aspects of generating droplets of Electrorheological (ER) or Giant Electrorheological (GER) fluid in a carrier fluid by controlling the flow of ER or GER fluid using one or more electrode(s);

FIG. 2 is a schematic illustration depicting further exemplary aspects of generating droplets of a first fluid in a ER or GER carrier fluid by controlling the flow of ER or GER carrier fluid using one or more electrode(s);

FIG. 3 depicts a schematic illustration of an exemplary microfluidic chip suitable for incorporation of aspects of the disclosed subject matter and that can facilitate generating and controlling ER or GER droplets in a carrier fluid;

FIGS. 4-5 depict a graph and images exemplifying GER droplet generation under different GER fluid flow rates, with droplet length (e.g., normalized by flow rate) plotted as a function of period T of the electrical control signals, according to various aspects of the disclosed subject matter;

FIG. 6 depicts optical images that demonstrate exemplary non-limiting GER droplets' deformation under an exemplary applied electric field;

FIG. 7 depicts a graph demonstrating exemplary non-limiting pressure differentials generated by GER droplets under different electric fields, for two different nanoparticle concentrations of the GER fluid;

FIG. 8 illustrates a schematic diagram of an exemplary non-limiting GER droplet display suitable for incorporation of aspects of the disclosed subject matter;

FIG. 9 depicts optical images generated by the exemplary non-limiting GER droplet display as described with reference to FIG. 8;

FIG. 10 illustrates a schematic diagram of an exemplary non-limiting chip component suitable for incorporation of aspects of the disclosed subject matter, in which orthogonal channels capable of forming water droplet “packages,” and optical images (right) of the “packages” formed with different numbers of water droplets sandwiched between two GER droplets are depicted;

FIG. 11 depicts a schematic illustration demonstrating non-limiting aspects of droplet generation using an exemplary flow-focusing junction, according to the disclosed subject matter;

FIG. 12 depicts a schematic illustration of further non-limiting aspects of droplet generation using an exemplary T-junction;

FIGS. 13-14 depict exemplary non-limiting electric field control signals and resultant droplets generated, according to various aspects of the disclosed subject matter;

FIGS. 15-16 depict graphs demonstrating exemplary frequency of droplet generation (F) under two non-limiting implementations, plotted as a function of flow rate (Q);

FIGS. 17-18 demonstrates electrically controlled generation of an exemplary droplet train of a first and second fluid from two converging channels;

FIG. 19 depicts an exemplary non-limiting schematic diagram of a portion of a microfluidic chip comprising a network of channels, suitable for incorporation of aspects of the disclosed subject matter, in which the ordering of droplets can be exchanged;

FIG. 20 depicts exemplary non-limiting optical images of a subset of a network of channels, in which exchanging order of droplets is demonstrated;

FIG. 21 illustrates a non-limiting schematic depiction of an exemplary microfluidic chip suitable for incorporation of aspects of the disclosed subject matter, in which droplets of a first fluid can be generated and/or controlled in an ER fluid (e.g., ER fluid, GER fluid, etc.) employed as a carrier fluid;

FIGS. 22-24 depict optical images of an exemplary channel in which nitrogen (N₂) bubbles have been generated under different gas pressures at the same flow rate of carrier fluid;

FIG. 25 depicts a non-limiting diagram that illustrates fabrication of an exemplary non-limiting microfluidic channel mold in accordance with various aspects of the disclosed subject matter;

FIGS. 26-27 depict flowcharts demonstrating various aspects of exemplary non-limiting methodologies that facilitate microfluidic droplet generation, manipulation, and/or control; and

FIG. 28 depicts an exemplary non-limiting functional block diagram for implementing microfluidic droplet generation, manipulation, and/or control systems and devices in accordance with various aspects of the disclosed subject matter.

### DETAILED DESCRIPTION OF ILLUSTRATIVE EMBODIMENTS

### Overview

As used herein, the term “droplet” can include a liquid droplet, a gaseous droplet (e.g., a bubble), combinations thereof, and so on as the context allows. For instance, in some contexts a reference to droplets (e.g., of a non-ER fluid) can comprise either or both liquid droplets and gaseous droplets (e.g., bubbles of a gas). In addition, as used herein, the terms “channel network” and “fluid channel network” are intended to comprise one or more channel(s) or fluid channel(s) adapted to contain, store, carry, direct, guide, deliver, or otherwise serve as a conduit for flow of a fluid of interest in a microfluidic application. As further used herein, the term fluid is intended to encompass one or more of a liquid, a gas, a liquid vapor, a solution, a suspension of one or more solid(s) in one or more liquid(s), or any combination thereof, and so on.

Thus, it can be understood that, in various aspects, the terms “channel network” and “fluid channel network” as well as the terms “channel” and “fluid channel” can comprise one or more connection(s) to one or more other channel(s), fluid channel(s), junction(s), other “channel network(s)” and/or “fluid channel network(s),” and/or other component(s), subcomponent(s), or portion(s) thereof (e.g., one or more connection(s) to one or more sensor(s), valve(s), heat exchanger(s), flow controller(s), fluid accumulator(s) or reservoir(s), such as liquid, and/or gas accumulator(s) or reservoir(s), etc., connection(s) to one or more liquid and/or gas supply/supplies, connection(s) to liquid and/or gas reaction vessel(s), disposal line(s), chemical and/or biological assay(s), biological tissue(s), such as blood vessel(s), or other fluid carrying tissue(s), etc.). In addition, in further non-limiting aspects, the terms “channel network” and “fluid channel network” can also comprise one or more associated electrode(s) adapted to send and/or receive an electrical signal (e.g., a detected signal, an electrical control signal, etc.) that can facilitate one or more of generation and controlling or manipulating one or more fluid droplet(s).

Moreover, while various embodiments described herein refer to a “pair” or “pairs” of electrodes, for example, to facilitate generating an electric field in a portion of a channel, it is to be understood that further non-limiting embodiments can comprise other arrangements (e.g., one or more electrode(s), in conjunction with a ground plane, and so on etc.) to facilitate generating an electric field in a portion of a channel.

As mentioned, ER fluids are a type of colloid whose rheological characteristics are tunable under the application of an electric field. Thus, ER fluids can be described as suspensions of extremely fine non-conducting particles in an electrically insulating fluid, the apparent viscosity of which can change reversibly by an order of up to 100,000, as a non-limiting example, in response to application of an electric field. For example, a typical ER fluid can go from the consistency of a liquid to that of a gel (or even substantially harder or more rigid), and back, with response times on the order of milliseconds.

Recently, a type of ER fluid has been developed having what can be described as a giant electrorheological (GER) effect (e.g., U.S. Pat. No. 6,852,251, which is incorporated herein by reference), which fluid is able to sustain higher yield strengths than many other ER fluids. For instance, a fluid having a typical giant GER effect can reach a yield strength of 300 kiloPascals (kPa) under an applied electric field of 5 kiloVolt per millimeter (kV/mm). Such GER fluids have found successful applications in microfluidic in a variety of microfluidic devices such as a valve, a pump, a mixer, etc.

As a non-limiting example, as described in U.S. Pat. No. 6,852,251, one type of GER fluid can comprise urea-coated nanoparticles suspended in an oil. For instance, as a non-limiting example, nanoparticles can be mixed with silicone oil in a volume fraction between 0.05 and 0.50, to form ER fluids, as well as other possible oils (e.g., mineral oils, engine oils, and hydrocarbon oils, sunflower oil, oils having a viscosity ranging from 0.5 to 1 Pascal Second (PaS), and so on, etc.). Thus, under a sufficiently strong electric field, GER fluid can be transformed into an anisotropic solid, with a yield stress characterizing its strength. For instance, under an applied field larger than 1 kV/mm, a GER fluid can exhibit solid-like behavior (e.g., can have the ability to transmit shear stress, etc.). Moreover, compared to conventional ER fluids, for example, a GER fluid can have a much larger ER response under the same applied field. It should be noted that these rheological variations can occur, for example, within 10 milliseconds (ms), and can be reversible when the field is removed.

As a further non-limiting example, one type of GER fluid can comprise nanoparticles (e.g., urea coated nanoparticles of Barium Titanium Oxalate, etc.) suspended in an oil (e.g., silicone oil, sunflower oil, etc.). For instance, in exemplary non-limiting examples, GER particles can be fabricated by dissolving barium chloride and rubidium chloride in distilled water at 50-70 degrees Celsius (° C.), and oxalic acid can be dissolved in water at 65° C. in an ultrasonic tank with titanium tetrachloride and urea solution slowly added thereafter. The two solutions can be mixed in an ultrasonic bath at 65° C. resulting in a nanometer-sized precipitate that can be washed with deionized water, filtered, and then dried to remove all trace water. According to a non-limiting aspect, nanoparticles obtained can have a 50 nanometer (nm) core of barium titanyl oxalate.

In a further non-limiting aspect, sunflower seed oil and GER particles can be mixed in a mixer/mill (e.g., a SPEX SamplePrep® 8000-series Mixer/Mills) for 30 minutes in a weight ratio of 5% to 40% GER particles. The mixture can be further filtered with sieves (e.g., with sieves having pore size around 10 micrometers) to remove the large aggregates, for example. It can be understood that with an applied field larger than 1 kV/mm, exemplary GER fluids can exhibit solid-like behavior (e.g., ability to transmit shear stress, etc.). Note further that, in a non-limiting aspect, a GER fluid can have relationship between electrical field strength and yield strength that is linear (e.g., approximately linear) after an electric field reaches 1 kV/mm. Thus, in a non-limiting aspect, a GER fluid can be described as having a high yield strength yet low electrical field strength and low current density fluid compared to many other ER fluids.

Accordingly, while ER fluids are described herein with reference to the various exemplary embodiments, it is to be understood that GER fluids are one type of ER fluid that can be employed with various non-limiting implementations of the disclosed subject matter. In a further non-limiting aspect, as used herein, reference to the term “non-ER fluid” is intended to refer to a fluid that lacks significant electrorheological effect (e.g., ability to transform from liquid-like to solid-like behavior under an applied electric field of a given strength, ability to transmit shear stress, high yield stress, etc.) relative to an ER fluid, a GER fluid, etc. as the context provides.

Consequently, according to various embodiments, the disclosed subject matter provides structures, devices, and methods for generation of droplets of ER fluids and manipulation and/or control thereof. As used herein, references to the terms “control” and/or “manipulation” in reference to a droplet can include facilitating or accomplishing one or more of droplet fission, droplet fusion, droplet sorting, droplet encoding, droplet digitalizing, droplet directional switching, droplet storage, droplet disposal, droplet order exchange, droplet arrangement, droplet size, shape, spacing, or sequence specification, determining relative position of different types of droplets, droplet display, any combinations thereof, and other control and/or manipulation functions as desired for droplets. In a non-limiting aspect, an ER fluid can be made to perform like a “switch” that can flow under the control of an applied electrical signal. In yet another non-limiting aspect, the switch-like function of the ER fluid can be made to manipulate other fluids' droplets and/or their flow behaviors.

In a further non-limiting aspect, the disclosed subject matter provides approaches to applying ER fluid droplet generation, control, and/or manipulation in droplet-based microfluidic devices. In various non-limiting embodiments, an ER fluid can be used in the form of droplets carried by another carrier fluid. In further non-limiting embodiments, an ER fluid can be as used a carrier fluid, for example, to control other fluids (e.g., liquid droplets, gaseous droplets (bubbles), etc.).

In an aspect of the disclosed subject matter, proper microfluidic chip design with integrated electrodes can facilitate exemplary functions such as droplet generation, droplet separation, and/or droplet flow direction, and can be electrically controlled through digitized signals. For example, various embodiments of the disclosed subject matter facilitate droplet encoding, digitalizing, directional switching, storage, and/or order exchange. The disclosed subject matter, in other non-limiting implementations, can achieve digital active control of microfluidic droplet generation and flow manipulation by employing ER fluid in microfluidic chips.

Accordingly, in various implementations, a digital signal can be used to control the generation, subsequent movement, and/or behavior of droplets. Furthermore, according to an aspect, certain “logical operations” (e.g., exchanging the order of droplets, etc.) can be performed under digital control. As a result, the sequence and relative position of different types of droplets (e.g., droplet of a first fluid and droplet of a second disparate fluid) can be controlled by digital signals applied to electrode pairs in channels.

As described above, in some contexts the reference to droplets (e.g., of a non-ER fluid) can comprise either or both liquid droplets and gaseous droplets (e.g., bubbles of a gas). As further described above, while ER fluids are described herein, it is to be understood that GER fluids are one type of ER fluid. For instance, an exemplary preparation of an ER fluid can comprise a surrounding fluid mixed with particles of ER material. Similarly, a GER fluid can comprise particles of GER material mixed with a surrounding fluid.

For the purposes of illustration and not limitation, particles of GER material can comprise particles or a composite material comprising metal salts of the form M1ₓM2₂₋₂ₓTiO(C₂O₄)₂, where M1 can be selected from the group consisting of barium (Ba), strontium (Sr), and calcium (Ca), where M2 can be selected from the group consisting of Rubidium (Rb), Lithium (Li), sodium (Na), and potassium (K), and where a promoter can be selected from the group consisting of urea, butyramide, and acetamide. In particular non-limiting implementations, a surrounding fluid can comprise an electrically insulating hydrophobic liquid. In further exemplary implementations, ER or GER particles can comprise between 5% and 40% by weight of the ER or GER fluid.

As described above, reference herein to ER fluid, particles or material should be understood to include, but are not limited to, GER fluid, particles or materials. GER particles, according to various embodiments, can be fabricated by any suitable method. As a non-limiting example, GER fluid can be prepared by mixing selected GER particles with sunflower seed oil in weight concentrations ranging from 5% to 40%, for which mixtures can be put in a mixer/mill (e.g., a SPEX SamplePrep® 8000-series Mixer/Mill) for 30 minutes and further filtered with sieves (e.g., with pore size around 10 micrometers (μm)) to remove large aggregates.

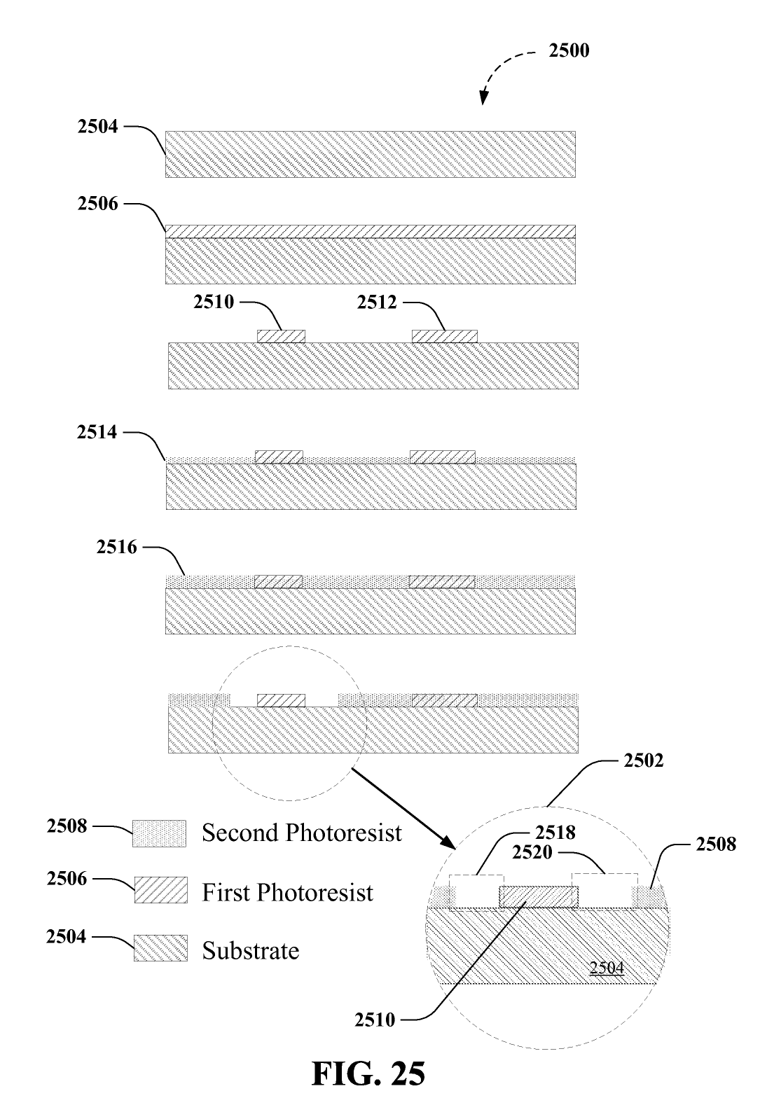

As more fully described below with regard to FIG. 25, for example, in an aspect, a soft lithographic technique can be employed in microchip fabrication (e.g., microchannel fabrication). In particular non-limiting implementations, a negative photoresist (e.g., SUB, etc.) can be employed to fabricate a channel mold. For instance, one or more electrodes (e.g., parallel electrodes, etc.) can be fabricated from three dimensional patterning of conductive Polydimethylsiloxane (PDMS), according to an aspect. As such, PDMS electrodes can be patterned with a conducting particle/PDMS-based conducting composite (e.g., a carbon-black/PDMS mixture, silver (Ag)-PDMS, other conducting particle/PDMS-based conducting composite, other suitable compositions, etc.) as can be understood.

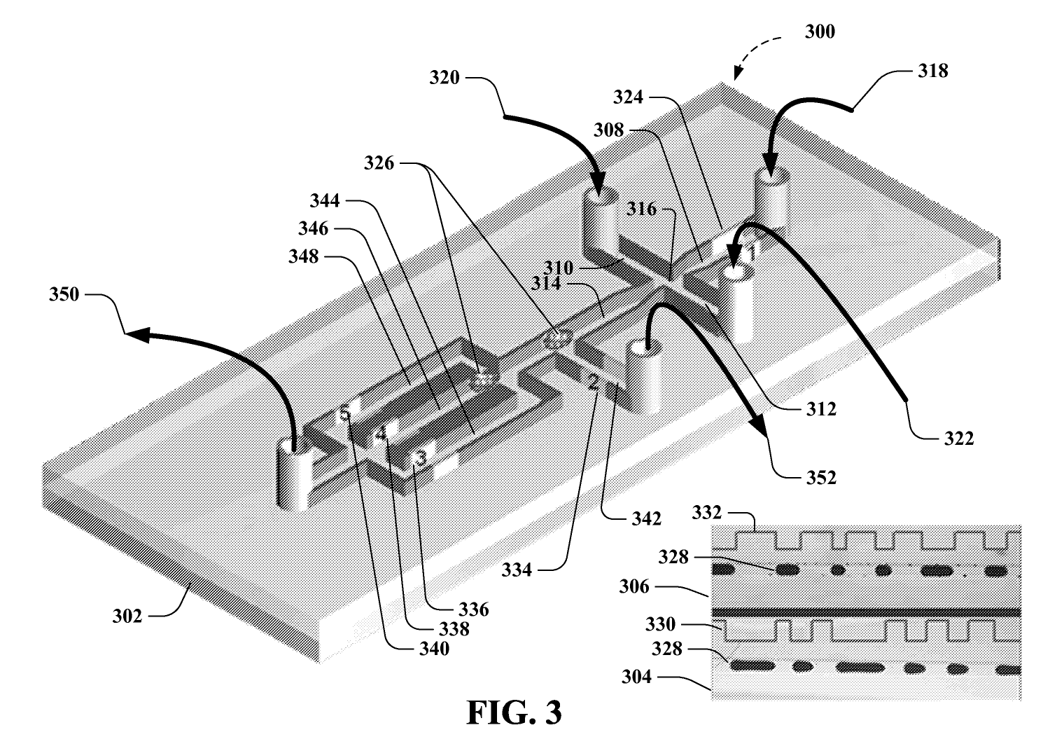

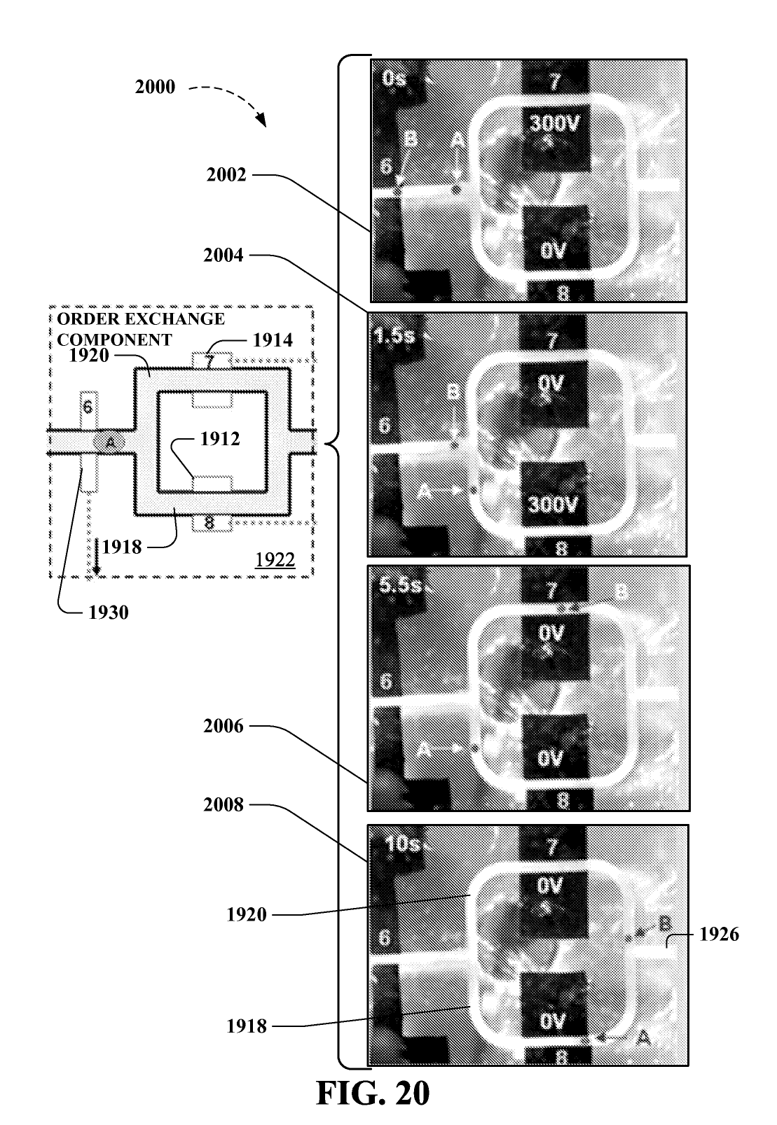

Accordingly, a conducting particle/PDMS-based conducting composite mixture can be placed on the substrate with the channel mold. After curing and bonding to another bottom layer (e.g., a bottom layer of PDMS, etc.) and embedding parallel electrodes on the channel walls, a microfluidic chip can be completed. As non-limiting examples, design and fabrication of electrode-embedded PDMS chips can comprise embedding conductive PDMS with a lithographic process that is compatible with three dimensional structures. For instance, non-limiting implementations of microfluidic chip designs are described with reference to FIGS. 3 and 20 below.

### Exemplary Non-Limiting Embodiments of Microfluidic Droplet Generation, Manipulation

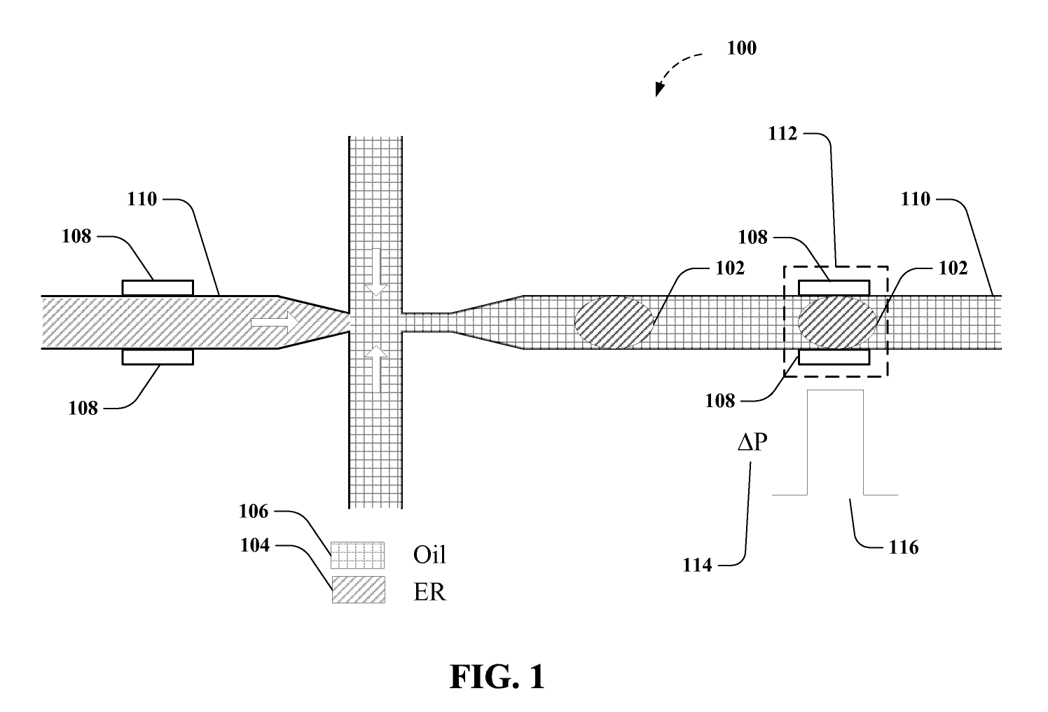

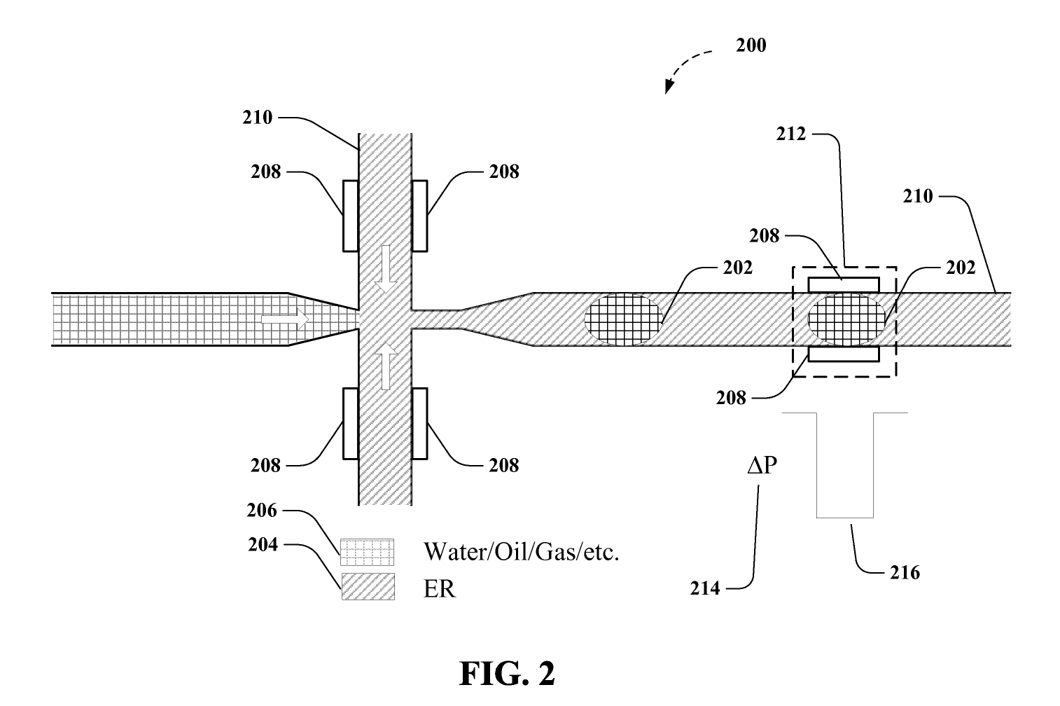

While a simplified overview has been described above in order to provide a basic understanding of some aspects of the specification, various approaches that facilitate generation, control, and/or manipulation of droplets are now described. For instance, FIG. 1 is a schematic illustration 100 depicting non-limiting aspects of generating droplets 102 of an ER or an GER fluid 104 in a carrier fluid 106 (e.g., an oil) by controlling the flow of ER or GER fluid 104 using one or more electrode(s) 108. FIG. 2 is a schematic illustration 200 depicting further exemplary aspects of generating droplets 202 of a first fluid 206 (e.g., water, oil, gas, etc.) in a ER or GER carrier fluid 204 by controlling the flow of ER or GER carrier fluid 204 using one or more electrode(s) 208.

As can be seen in FIG. 1, droplets 102 can be droplets 102 of ER fluid 104 carried in a carrier fluid 106 (e.g., such as an oil). In contrast, as can be seen in FIG. 2, ER fluid 204 can act as a carrier fluid and droplets 202 of another material 206 (e.g. water, oil, gas, etc.) can be carried by the ER fluid 204. It can be understood, that according to a non-limiting aspect, carrier fluid 106 of FIG. 1 can be immiscible with ER fluid 104, or at least partially immiscible. Likewise, according to a further non-limiting aspect, ER carrier fluid 204 of FIG. 2 can be immiscible with another material 206 (e.g. water, oil, gas, etc.) that can be carried by the ER fluid 204, or at least partially immiscible.

In various non-limiting implementations, embodiments of the disclosed subject matter can control the rate of flow of ER fluid (e.g., ER 104, 204, etc.) and/or ER droplets 102 by application of an electric field (e.g., by excitation of one or more electrode(s) (e.g., one or more electrode(s) 108, 208), etc.), which, according to exemplary implementations, can be embedded into a wall of a channel (e.g., channel 110, 210, etc.) carrying the ER fluid. According to various aspects, ER fluid (e.g., ER 104, 204, etc.) or droplet(s) (e.g., droplets 102, 202, etc.) can be caused to stop temporarily by employing an electric field of sufficient strength (e.g., an electric field above a certain threshold), which can be dependent upon, for example, flow rate(s), density of ER particles in droplet(s) (e.g., droplets 102, 202, etc.) or ER fluid (e.g., ER 104, 204, etc.), ER material used, dimensions of the channel (e.g., width and height of channel 110, 210, etc.).

Accordingly, it can be understood that, in various non-limiting implementations, movement of fluid (e.g., ER fluid (e.g., ER 104, 204, etc.), carrier fluid 106 (e.g., such as an oil), another material 206 (e.g. water, oil, gas, etc.), etc.) can be stopped, started, and/or generation and/or movement of droplets can be controlled by using the physical reaction of ER fluid (e.g., ER 104, 204, etc.) or droplet(s) (e.g., droplets 102, 202, etc.) to electric field that can be ‘switched’ to turn on, turn off, and/or vary the flow of the fluid (e.g., ER fluid (e.g., ER 104, 204, etc.), carrier fluid 106 (e.g., such as an oil), another material 206 (e.g. water, oil, gas, etc.), etc.).

For instance, referring again to FIG. 1, it can be seen that the movement of ER droplets 102 can be controlled, in addition to controlling the flow of carrier fluid 106 immediately upstream of the ER droplet 102. For example, if ER droplet 102 is stopped between a pair 112 of electrodes 108, it can be seen that the stopped ER droplet 102 can form a plug blocking the channel associated with pair 112 of electrodes 108, which can in turn facilitate stopping flow of carrier fluid 106 immediately behind it. Similarly, if flow of the ER fluid (e.g., ER 204, etc.) is stopped between a pair 212 of electrodes 208, it can be seen that the stopped ER fluid can form a plug blocking the channel associated with pair 212 of electrodes 208, which can in turn facilitate stopping flow of droplet(s) (e.g., droplets 202, etc.) immediately behind it. In either case, it can be understood that a pressure difference (e.g., pressure difference, ΔP, 114, 214, etc.) can be induced by ER fluid (e.g., ER droplets 102, ER 204, etc.) inside the associated that can be controlled (e.g., controlled by varying electrode field strength, droplet size, particle concentration in the ER suspension, etc.).

Thus, it can be appreciated that, in various non-limiting embodiments, ER droplet(s) (e.g., droplets 102, etc.) can be generated according to aspects of the disclosed subject matter by, for example, a flow-focusing approach as depicted schematically in FIG. 1. FIG. 3 depicts a schematic illustration 300 of an exemplary fluid flow device (e.g., microfluidic chip 302), suitable for incorporation of aspects of the disclosed subject matter, and which exemplary microfluidic chip 302 can facilitate generating and/or controlling ER or GER droplet(s) (e.g., droplets 102, etc.) in a carrier fluid (e.g., in a carrier fluid 106 such as an oil, etc.). The right lower insets of FIG. 3 show two images 304 and 306 of GER droplets generated in accordance with electrical control signals applied to a pair of electrodes in microfluidic chip 302 as further described below. For purposes of illustration and not limitation, microfluidic chip 302 can comprise a microfluidic chip having a chip size of approximately 3 centimeters (cm)×2 cm×0.4 cm.

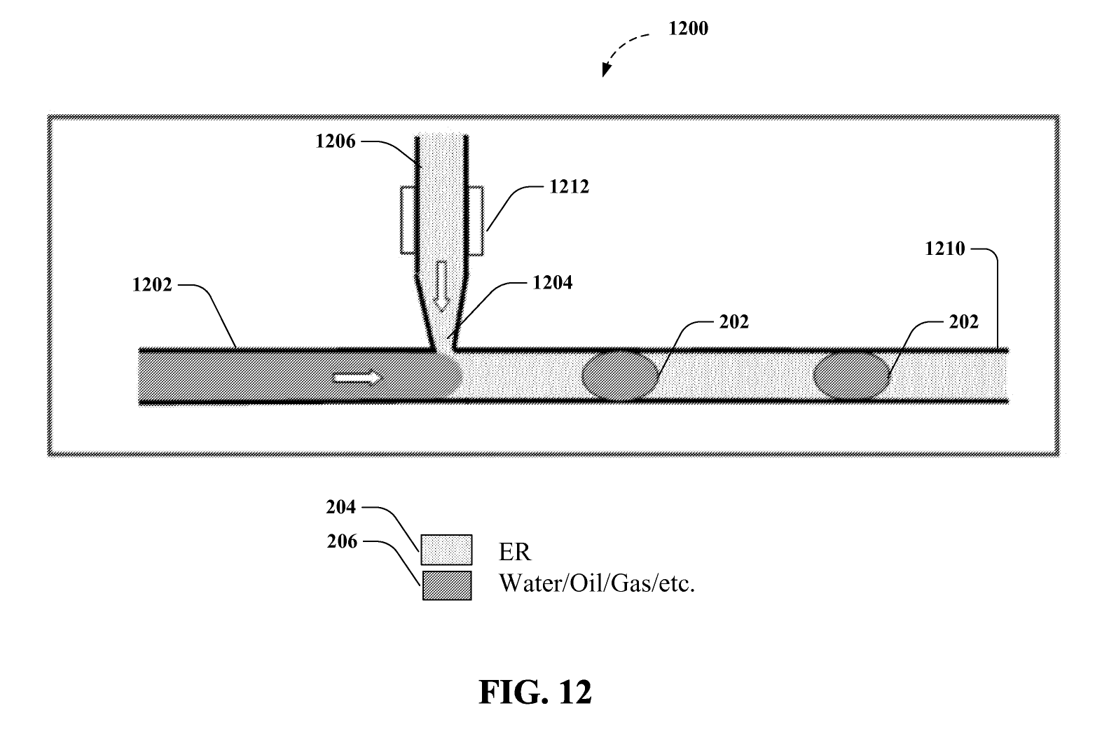

In addition, microfluidic chip 302 can comprise a first 308, second 310, third 312, and fourth 314 channels joined at a junction 316, similar to that depicted with reference to FIG. 1, for example. According to an aspect, one or more of first 308 and fourth 314 channel(s) can taper to a narrower width as they approach junction 316, which can advantageously promote the focusing of the flow of fluid (e.g., ER fluid, GER fluid, such as ER 104, etc.) and can facilitate generating droplet(s) (e.g., droplets 102, etc.). While a flow-focusing approach that employs four channels as described with reference to FIGS. 1-3 can be used to facilitate generating droplet(s) (e.g., droplets 102, etc.), additionally and/or alternatively, a T-junction approach such as that described below with reference to FIG. 12 can be employed, for example, without employing a third channel. Accordingly, it can be understood that other variations can be possible within the scope of the disclosed subject matter.

According to various non-limiting implementations, an ER fluid (e.g., ER fluid, GER fluid, such as ER 104, etc.) can be injected into first channel 308 from a source of ER fluid 318. In further non-limiting aspects, a carrier fluid (e.g., carrier fluid 106, such as an oil, etc.) can be injected into the second 310 and third 312 channels from one or more source(s) 320, 322 of carrier fluid (e.g., carrier fluid 106, such as an oil, etc.). Accordingly, in various embodiments, a stream of ER fluid (e.g., ER fluid, GER fluid, such as ER 104, etc.) and one or more stream(s) of carrier fluid (e.g., carrier fluid 106, such as an oil, etc.) can flow towards the junction 316.

In various aspects, flow of ER fluid (e.g., ER fluid, GER fluid, such as ER 104, etc.) in first channel 308 can be controlled (e.g., stopped, started, have its speed regulated, etc.) by application of an electric field (e.g., via a control signal such as control signal 116, 216, etc.) between pair 324 of electrodes facing each other on opposite sides of first channel 308, for example, as described above regarding electrode pair 112 of FIG. 1, electrode pair 212 of FIG. 2, etc. Thus, it can be understood that at junction 316, ER fluid (e.g., ER fluid, GER fluid, such as ER 104, etc.) in first channel 308 and carrier fluid (e.g., carrier fluid 106, such as an oil, etc.) from one or more of second 310 and third 312 channel(s) can combine to form one or more droplet(s) 326 (e.g., such as droplet(s) 102, etc.) of ER fluid carried (e.g., ER fluid, GER fluid, such as ER 104, etc.) by the carrier fluid into fourth channel 314.

It can be further understood that the size and frequency of droplets of ER fluid (e.g., ER fluid, GER fluid, such as ER 104, etc.) entering fourth channel 314 can be controlled by variations of the applied electric field (e.g., via a control signal such as control signal 116, etc.), for example, between pair 324 of electrodes on opposite sides of first channel 308. For instance, images 304 and 306 in FIG. 3 depict variations 328 in droplet size (e.g., size of droplet(s) 326 of ER fluid such as a GER fluid) and/or periodicity generated in response to variations in electrical control signals 330, 332 applied to a pair 324 of electrodes on opposite sides of first channel 308 in microfluidic chip 302. Thus, it can be understood that, in various non-limiting embodiment, the disclosed subject matter facilitates control of variations in droplet size and/or separation, and so on, between two successive droplets, which can be tuned, for example, by adjusting frequency and/or duty cycle of the control signal (e.g., control signal 116, electrical control signals 330, 332, etc.) applied to pair 324 of electrodes on opposite sides of first channel 308 in microfluidic chip 302.

Such control is exemplified in images 304 and 306 in FIG. 3, in which correspondence between variations in the electrical control signals (e.g., electrical control signals 330, 332, etc.) applied to pair 324 of electrodes on opposite sides of first channel 308 in microfluidic chip 302 and variations 328 droplet size and/or periodicity can be seen. For example, it can be seen that droplet(s) 326 of ER fluid (such as a GER fluid) can be generated, for instance, when electrical control signal (e.g., electrical control signals 330, 332, etc.) was low.

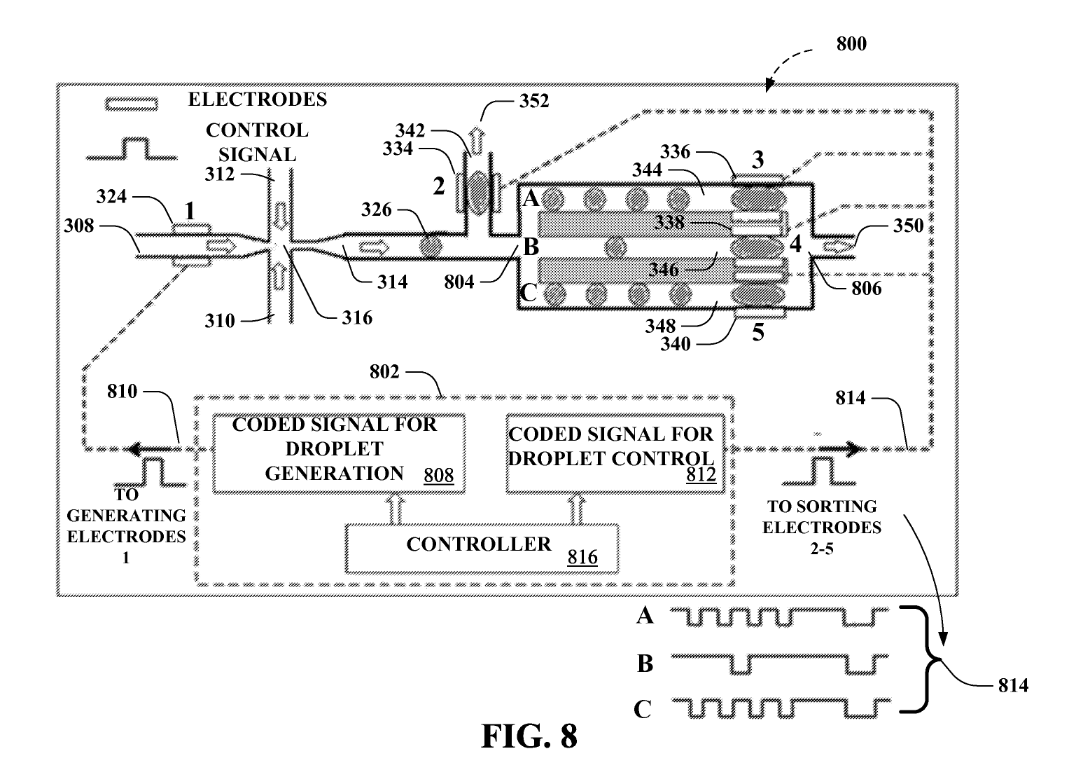

Thus, in an aspect of the disclosed subject matter, proper microfluidic chip design with integrated electrodes can facilitate exemplary functions such as droplet generation, droplet separation, and droplet flow direction, and can be electrically controlled through digitized signals. For example, various embodiments of the disclosed subject matter facilitate droplet encoding, digitalizing, directional switching, storage, and/or order exchange. The disclosed subject matter, in other non-limiting implementations, can achieve digital active control of microfluidic droplet generation and flow manipulation by employing ER fluid in microfluidic chips. In a further aspect, electrodes such as pair 324 of electrodes on opposite sides of first channel 308 in microfluidic chip 302 can be advantageously embedded into one or more side(s) of an associated channel (e.g., first channel 308 associated with pair 324 of electrodes, etc.) as shown, for example, in FIG. 3. Likewise for any of pairs 334, 336, 338, 340 of electrodes in respective associated fifth 342, sixth 344, seventh 346, and eighth 348 channels of exemplary microfluidic chip 302 as further described below regarding FIG. 8, etc., for example.

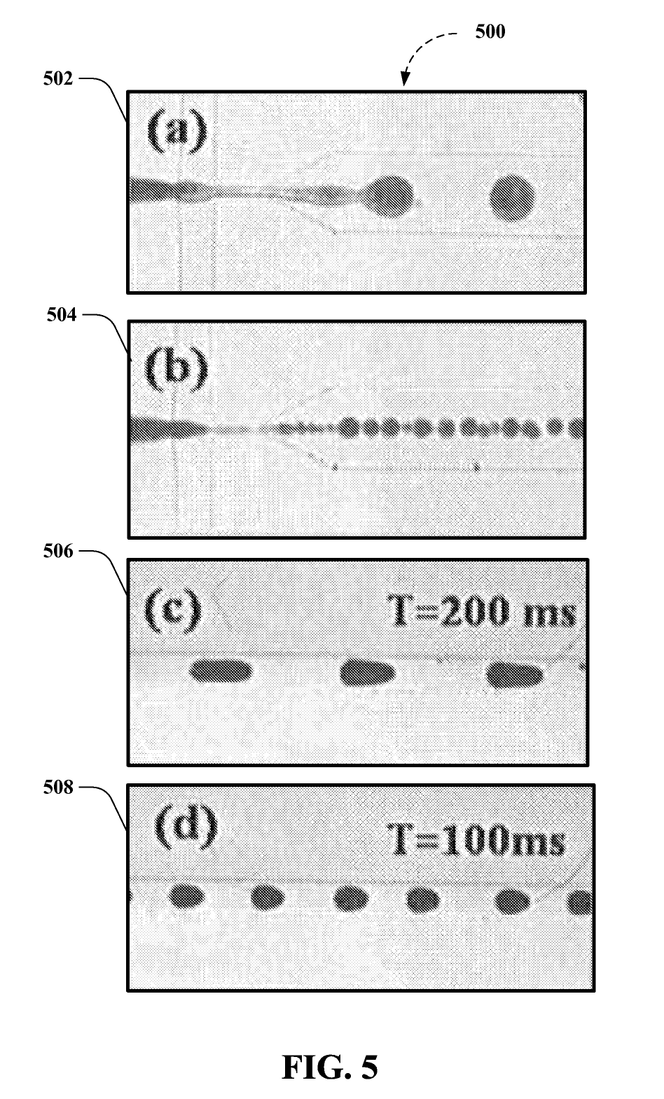

In further non-limiting implementations, microfluidic chip 302 can employ a continuous-phase GER fluid injected into the first channel 308. In addition, one or more source(s) 320, 322 of carrier fluid (e.g., carrier fluid 106, such as an oil, silicone oil carrier fluid, etc.) can be injected into the second 310 and third 312 channels, respectively. Thus, one or more droplet(s) 326 (e.g., such as one or more droplet(s) 326, etc.) of ER fluid (e.g., ER fluid, GER fluid, such as ER 104, etc.) can be generated in a passive scheme, and it could be either monodispersed 502 or polydispersed 504 as described below regarding FIG. 5, for instance, when a voltage between pair 324 of electrodes is set to zero (e.g., no electrical control signals applied).

For example, images 304 and 306 in FIG. 3 depict variations 328 in droplet size (e.g., size of droplet(s) 326 of ER fluid such as a GER fluid) and/or periodicity generated in response to variations in electrical control signals 330, 332 applied to a pair 324 of electrodes on opposite sides of first channel 308 in microfluidic chip 302. Such electrical control signal can comprise a series of pulses (e.g., such as in a digital signal, etc.) that can be transmitted by a controller (not shown) to pair 324 of electrodes. As can be understood, while a controller is not shown integrated to the microfluidic chip 302 in FIG. 3, it could either be integrated with microfluidic chip 302, as further described below regarding FIG. 8, for example, or alternatively, a controller can be provided externally. Accordingly, by applying a varying electric field between a pair of electrodes (e.g., pair 324 of electrodes on opposite sides of first channel 308 in microfluidic chip 302, etc.), such as, for example, a digital square wave DC field, uniform droplets can be advantageously obtained. As a further advantage, droplet uniformity can remain stable over a wider range of flow rates according to further non-limiting aspects of the disclosed subject matter. In addition, microfluidic chip 302 can comprise one or more of main channel out 350 and side channel 352, among other outlet port(s) or channel(s), to facilitate selection and/or distribution of droplet(s), bubble(s), mixture(s), carrier fluid(s), ER fluid(s), and so on, for example.

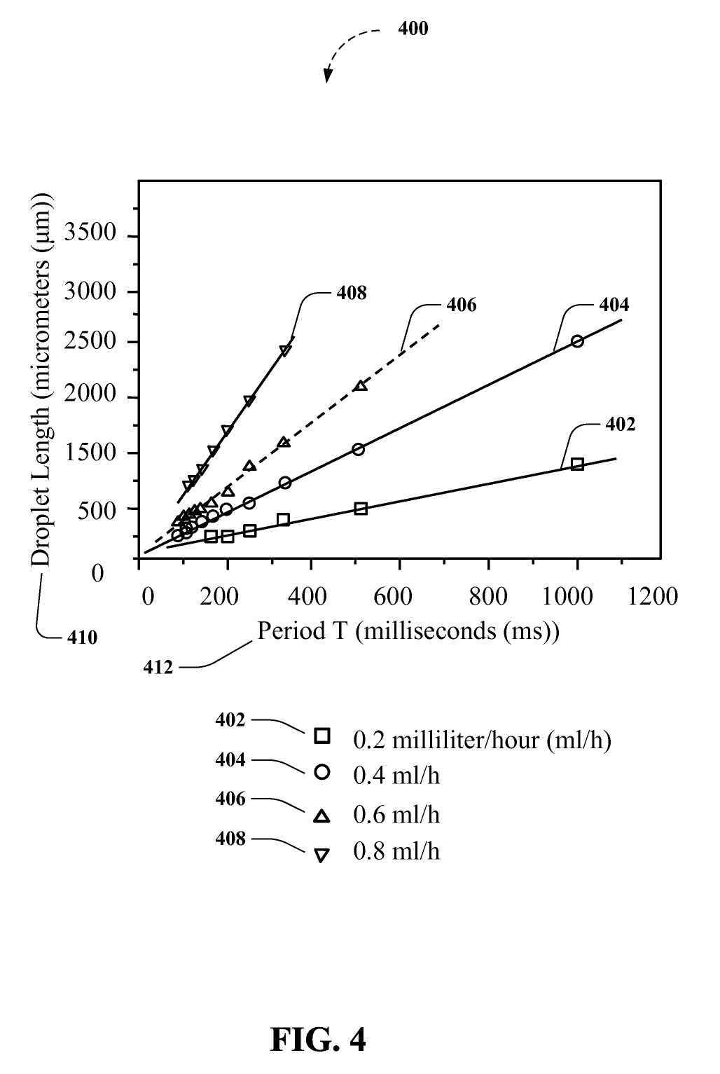

FIGS. 4-5 depict a graph 400 and images 500 exemplifying GER droplet generation under different GER fluid flow rates (402, 404, 406, 408), with droplet length 410 (e.g., normalized by flow rate) plotted as a function of period T 412 (frequency, and/or duty cycle) of electrical control signals (e.g., electrical control signals 330, 332, etc.), according to various aspects of the disclosed subject matter. It is noted that period T 412 of electrical control signals (e.g., electrical control signals 330, 332, etc.) can be adjusted to impact stable droplet production (e.g., GER droplet production, etc.).

For example, in non-limiting implementations, as period T 412 is adjusted beyond a particular working range, GER droplet generation or production can become unstable. However, according to various aspects, exemplary implementations of the disclosed subject matter can facilitate GER droplets synchronization and relative phase variation between the droplets, by controlling two or more GER inlets independently in the stable region. It can be seen in FIG. 4 that, according to various non-limiting implementations, for a given flow rate (402, 404, 406, 408, etc.) in the stable working range of period T 412, the droplet length can advantageously vary linearly with period T 412 between electrical pulses (e.g., variations of electrical control signals such as electrical control signals 330, 332, etc.).

Panels 502, 504, 506, and 508 of FIG. 5 are black and white images depicting exemplary droplet generation (e.g., GER droplet generation, etc.) in which image 502 and 504 show both stable 502 and unstable 504 droplet generation with no electrical signals applied. For instance, image 502 shows stable generation under a low flow rate 0.2 ml/h and image 504 shows unstable generation under a high flow rate of 4 ml/h for the GER fluid. Images 506 and 508 show stable generation that can be achievable with the application of electrical control signals, according to various aspects, under both low flow rate 506 and a relatively higher flow rate 508.

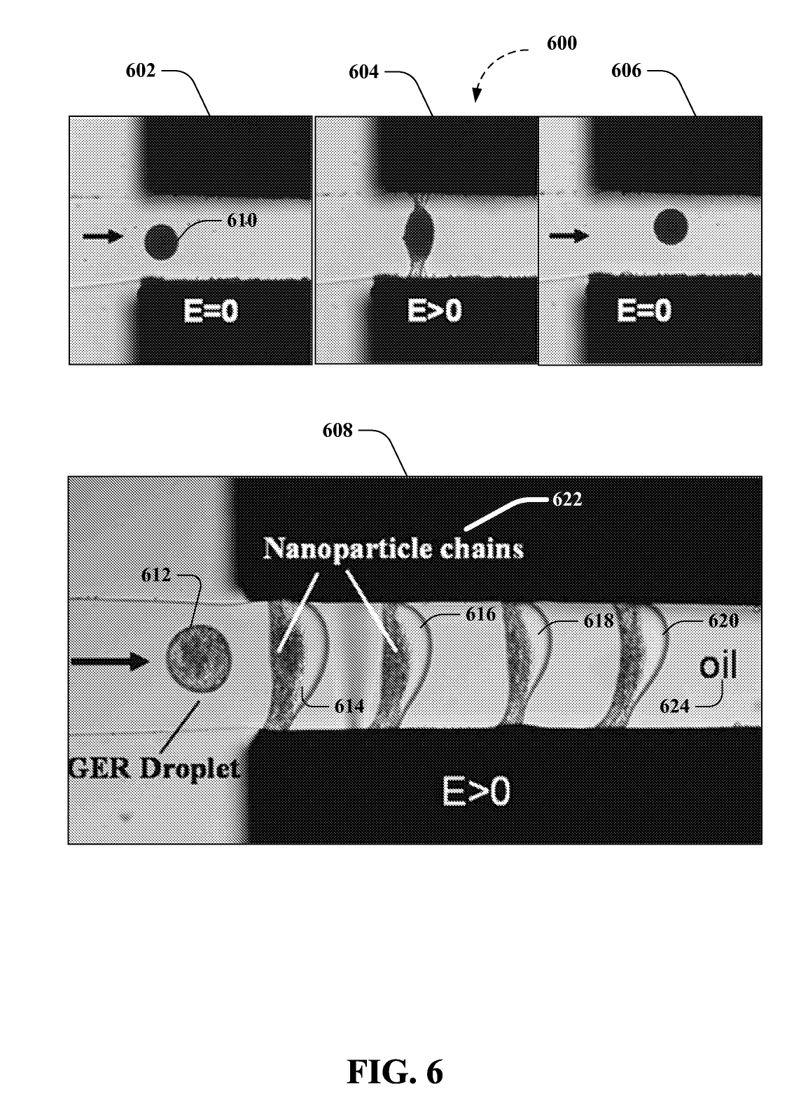

Thus, it can be seen that pair 324 of electrodes on opposite sides of first channel 308 in microfluidic chip 302 can facilitate the manipulation of a continuous ER fluid flow (e.g., GER fluid flow, etc.). For instance, as a voltage is applied to pair 324 of electrodes on opposite sides of first channel 308 in microfluidic chip 302, it can be understood that viscosity of ER fluid (e.g., GER fluid, etc.) flowing can be increased due in part to formation of nanoparticle chains across pair 324 of electrodes on opposite sides of first channel 308 in microfluidic chip 302 as further described with reference to FIG. 6. As a result of the voltage applied to pair 324 of electrodes, less ER fluid (e.g., GER fluid, etc.) is injected into the flow-focusing part.

As an example, when an electric field that is higher than a threshold (e.g., 2 kiloVolt per millimeter (kV/mm) for a 40 weight percentage (wt %) GER fluid, etc.) is applied to pair 324 of electrodes, the GER fluid stream can be temporarily stopped, resulting in only carrier fluid (e.g., carrier fluid 106, such as an oil, silicone oil carrier fluid, etc.) being injected into the second 310 and third 312 channels, respectively, and reaching junction 316. Subsequently, when an applied electric field is removed (e.g. when electrical control signals 330, 332 is below the threshold, between pulses, turned off, removed, etc.), the GER fluid flow can resume.

Thus, according to various aspects of the disclosed subject matter, ER fluid (e.g., GER fluid, etc.) droplets' generation can be digitally controlled by an electrical control signal (e.g., electrical control signals 330, 332, etc.). Moreover, as described above, droplet size (e.g., size of droplet(s) 326 of ER fluid such as a GER fluid) and/or separation between two successive droplets can be tuned by adjusting, for instance, frequency and/or duty cycle of control signals (e.g., electrical control signals 330, 332, etc.) applied to the electrode pair 324 on opposite sides of first channel 308 in microfluidic chip 302, for example. As further described above, aspects of such control is illustrated in images 304 and 306 of FIG. 3, in which correspondence between the electrical control signals 330, 332 applied to electrode pair 324 and the encoding of droplets can be observed. For example, it can be seen that one or more droplet(s) (e.g., GER droplets 326, etc.) can be generated when one or more electrical control signal(s) (e.g., electrical control signals 330, 332, etc.) are set low.

FIG. 6 depicts optical images 602, 604, 606, 608 that demonstrate exemplary non-limiting GER droplets' deformation under variations in applied electric field (E) (e.g., variations in electrical control signals 330, 332, etc.) and under variations in channel flow (as indicated in images 602, 604, 606, and 608 by the presence or absence of right-pointing arrows in the associated channel). For example, optical images 602, 604, 606, 608 demonstrate the behavior of droplets (e.g., GER droplets) in a channel (e.g., first channel 308) in the vicinity of an electrode pair (e.g., electrode pair 324 on opposite sides of first channel 308 in microfluidic chip 302). It can be seen that a droplet (e.g., GER droplet 610, etc.), with no electric field applied (e.g., E=0, electric field below a threshold, etc.) and at a sufficiently low flow rate, typically takes on a spherical shape as in image 602.

However, when an electric field of sufficient strength (and a sufficiently low flow rate) is applied (e.g., 500 Volts per millimeter (V/mm) in particular non-limiting implementations, etc.) the droplet (e.g., GER droplet 610, etc.) can become elongated with one or more of the two end(s) approaching or touching electrodes (e.g., such as one or more of electrode(s) of electrode pair 324 on opposite sides of first channel 308, etc.) as in image 604. Thus, it can be understood that, according to various aspects, the droplet (e.g., GER droplet 610, etc.) and/or flow in the associated channel (e.g., first channel 308, etc.) can become diminished or stopped.

Subsequently, when the applied electric field is removed (e.g., E=0, electric field below a threshold, etc.), droplet (e.g., GER droplet 610, etc.) can resume, or nearly or substantially resume, its original spherical shape and can again flow in the associated channel (e.g., first channel 308, etc.) as shown in image 606. It is also noted that in image 604, according to various non-limiting embodiments, the droplet (e.g., GER droplet 610, etc.) can expand to form a plug, which can effectively block the associated channel (e.g., first channel 308, etc.). Thus, it can be understood that, according to non-limiting implementations, as the droplet (e.g., GER droplet 610, etc.) is stopped and/or forms a plug that can block the channel, carrier fluid (e.g., carrier fluid 106, such as an oil, silicone oil carrier fluid, etc.) upstream of the droplet (e.g., upstream of GER droplet 610, etc.) can be switched from a state of flowing to a state of diminished flow, no flow, or stopped flow. Accordingly, in various aspects, the droplet (e.g., GER droplet 610, etc.) together with electrode pair (e.g., electrode pair 324 on opposite sides of first channel 308 in microfluidic chip 302) can function to provide a logic “switcher” or “stopper.”

Thus, deformation of droplet(s) 610 (e.g., GER droplets 326, etc.) can be seen in images 602, 604, 606 with an applied electric field (e.g., E·0, electric field above a threshold, etc.) in image 604, as well as the subsequent reversion back to a spherical shape in image 606 when the electric field was turned off or removed (e.g., E=0, electric field below a threshold, etc.) for an exemplary GER fluid having 40 wt % nanoparticles. It is noted that, as described above, when electric field was applied (e.g., E>0, electric field above a threshold, etc.) as in image 604, the droplet 610 can be stopped.

Image 608 of FIG. 6 further demonstrates deformation of a droplet train under an applied electric field (e.g., non-zero electrical control signals 330, 332, etc.) for droplets generated from a GER fluid with 5 wt % nanoparticles, a lower GER nanoparticle concentration than is depicted for images 602, 604, and 606. It is noted that droplet 612 on the left of image 608 and outside the influence of an applied electric field can retain a spherical shape (or a substantially spherical shape) at sufficiently low flow rates. However, for those droplets (e.g., droplets 614, 616, 618, and 620) under an applied electric field (e.g., E>0, electric field above a threshold, etc.) in image 608, the droplets can be stretched as previously described, and as evidenced by the clearly visible separation of GER nanoparticles from the surrounding sunflower oil. In particular, nanoparticles chains or columns 622 formed by the nanoparticles under an applied electric field (e.g., E>0, electric field above a threshold, etc.) in image 608 are plainly identifiable. In addition, sunflower oil can be seen in image 608 to be pushed forward to form a curved front with carrier fluid (e.g., carrier fluid 106, such as an oil, silicone oil carrier fluid 624, etc.), owing to a pressure differential generated by the slowed channel flow.

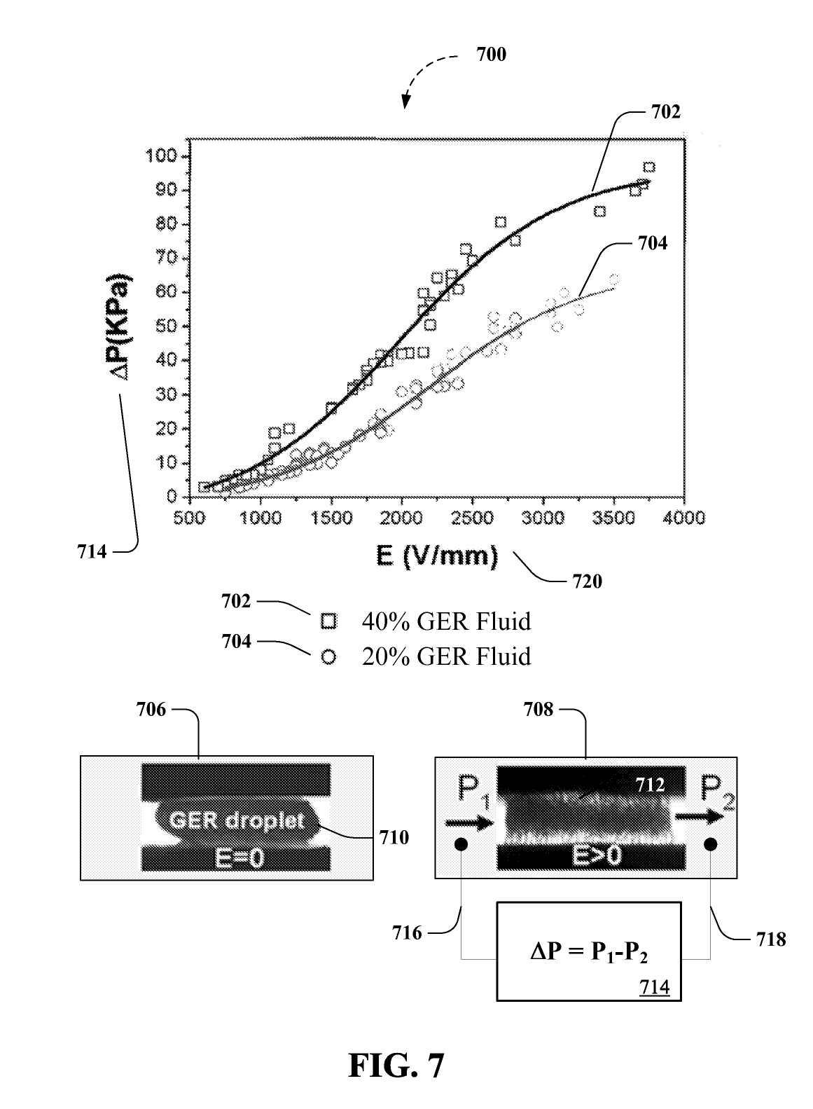

For instance, FIG. 7 depicts a graph and associated images demonstrating exemplary non-limiting pressure differentials generated by droplets (e.g., GER droplets, etc.) under different electric fields, for two different nanoparticle concentrations 702 and 704 of the ER fluid (e.g., GER fluid, etc.), and for an electrode length of is 1 mm. Images 706 and 708 demonstrate deformation droplets with no electric field (e.g., E=0, electric field below a threshold, etc.) 706 and under an electric field (e.g., E>0, electric field above a threshold, etc.) 708 and the resulting pressure difference established across a droplet (e.g., GER droplet 710, etc.) when it is stopped under the application of an electric field (e.g., E>0, electric field above a threshold, etc.). It can be seen from FIG. 7 that droplet (e.g., GER droplet 710, etc.) can be squeezed into a channel (e.g., such as first channel 308) to form a plug 712 between a pair of electrodes (e.g., such as pair 324 of electrodes, etc.) as shown image 708 of FIG. 7.

For instance, when an electric field was applied (e.g., E>0, electric field above a threshold, etc.), the droplet/plug 712 columns formed (internally to the droplet as demonstrated above regarding FIG. 6) by ER nanoparticles (e.g., GER nanoparticles, etc.) stretching across the electrodes to form nanoparticle chains or columns (e.g., such as the electrodes of pair 324 of electrodes, etc.) in image 708. As a result, flow in the associated channel can be stopped and a pressure differential 714 (ΔP=P₁−P₂) can be established, which can be measured, for example, with a pressure sensor (e.g., Honeywell™ Inc. Sensym™ ASCX15DN) connected to the channel at points upstream (e.g., P₁) and downstream (e.g., P₂) of electrodes (e.g. electrodes of length=1 mm) via the two branch channels shown schematically as 716 and 718.

For example, results of measured ΔP 714 are demonstrated in FIG. 7 for exemplary droplets (e.g., GER droplet 710, etc.) having non-limiting ER nanoparticles (e.g., GER nanoparticles, etc.) concentrations of 40% (702) and 20% (704). It can be seen in FIG. 7 that, according to various non-limiting embodiments, differential pressure 714 can increase according to a nonlinear relation that can saturate at higher electric field strengths 720. For instance, maximum pressure differential can be more than 90 kPa/mm for the GER fluid 702 with 40 wt % of nanoparticles. It can be understood that such pressure differentials 714 can be adequate for most microfluidic applications. Accordingly, it can be further understood that such pressure differentials 714, (e.g., such as has been demonstrated to be capable of being induced by exemplary GER droplets) can be adjusted readily according to various aspects of the disclosed subject matter, for example, by varying the strength of the electric field 720, droplet size, and/or, ER nanoparticles (e.g., GER nanoparticles, etc.) concentration in ER fluid (e.g., GER fluid, etc.). While the disclosed subject matter has been described above in connection with various embodiments, it is to be understood that other similar embodiments may be used with, or modifications and additions may be made to, the described embodiments for performing the same or similar functions as described herein without deviating from the disclosed subject matter.

FIG. 8 illustrates a schematic diagram of an exemplary non-limiting GER droplet display or microfluidic chip 800 suitable for incorporation of aspects of the disclosed subject matter. Accordingly, exemplary non-limiting GER droplet display or microfluidic chip 800 of FIG. 8 describe can perform various droplet manipulations (e.g., ER droplet manipulations, GER droplet manipulations, etc.), such as, for example, digital encoding, direction switching, storage, and so on. For ease of explanation and not limitation, FIG. 8 uses similar nomenclature and/or reference characters as that for FIG. 3, where appropriate, to depict similar functional characteristics or features as that described above, for example, regarding FIGS. 3-7, etc.

For example, according to various non-limiting embodiments of the disclosed subject matter, due in part to the behavior of one or more droplet(s) (e.g., ER droplets 102, GER droplets 326, 328, 610, 614, 616, 618, 620, 710, 712, etc.) under an applied electric field, the one or more droplet(s) together with the carrier fluid (e.g., carrier fluid 106, such as an oil, of silicone oil carrier fluid 624, etc.) can be controlled by one or more digital signal(s) (e.g., such as electrical control signal(s) 116, 216, 330, 332, etc.) applied through one or more electrode(s) that are placed in associated channels (e.g., such as an electrode pair 324 on opposite sides of first channel 308 in microfluidic chip 302, and/or such as downstream channels associated with pairs 334, 336, 338, 340 of electrodes in respective associated fifth 342, sixth 344, seventh 346, and eighth 348 channels of exemplary microfluidic chip 302, etc.).

For instance, FIG. 8 can be considered a schematic illustration of a chip, for example such as exemplary microfluidic chip 302, etc., that can be designed to facilitate the functions of droplets logic control (e.g., ER droplet logic control, GER droplet logic control, etc.) including digital encoding, direction switching, and storage, for example, via a controller component 802. As described above regarding FIG. 3, in an aspect, droplet display or microfluidic chip 800 can comprise a network of channels (e.g., one of more of channels 308, 310, 312, 314, 342, 344, 346, 348, main channel out 350, side channel 352, etc.), including a first portion adapted to generate droplets (e.g., ER droplets, GER droplets, etc.) comprising a first channel 308, second channel 310, third channel 312, and fourth channel 314 as described above with reference to FIG. 3. According to further non-limiting aspects, fourth channel 314 can be adapted to provide a main input channel to a second portion of the network of channels, which can be adapted to store droplets (e.g., ER droplets, GER droplets, etc.) at desired locations in the network of channels as previously described. Thus, according to exemplary non-limiting embodiments, the second portion of the network of channels of droplet display or microfluidic chip 800 can be used as a display.

For instance, fourth channel 314 adapted to provide a main input channel can have a plurality of channels 344 (“A” or sixth channel), 346 (“B” or seventh channel), 348 (“C” or eighth channel) and channel 342 (fifth channel) branching off from the fourth channel 314, according to a non-limiting implementation. In the example illustrated in FIG. 8, secondary channels 344 (“A” or sixth channel), 346 (“B” or seventh channel), 348 (“C” or eighth channel) can branch from fourth channel 314 at a junction 804 and can recombine at a junction 806 that can be connected to main output channel 350. In addition, electrode pairs 2 (334), 3 (336), 4 (338), and 5 (340) can be embedded, as previously described regarding pair 324 of electrodes, to respective associated secondary channels to facilitate applying one or more electric field(s) (e.g., via one or more control signal(s), etc.) that can control or manipulate the flow of ER fluid (e.g., GER fluid, etc.) in the respective secondary channels.

According to various non-limiting embodiments, functions of droplets logic control (e.g., ER droplet logic control, GER droplet logic control, etc.) including digital encoding, direction switching, and/or storage in microfluidic chip 302, droplet display or microfluidic chip 800, and so on, can be facilitated, for example, via a controller component 802. The controller component 802 can comprise one or components, subcomponents, or modules adapted to perform functions, or portions thereof, of droplets logic control (e.g., ER droplet logic control, GER droplet logic control, etc.). As a non-limiting example, controller component 802 can comprise a component 808 adapted to provide one or more coded signal(s) 810 for droplet generation (e.g., ER droplet generation, GER droplet generation, etc.) as described above, for example, regarding FIGS. 3-7, etc.

As a further non-limiting example, controller component 802 can also comprise a component 812 adapted to provide one or more coded signal(s) 814 for droplet control, storage, and/or manipulation (e.g., ER droplet control, storage, and/or manipulation, GER droplet control, storage, and/or manipulation, etc.) in the network of channels. As can be seen in FIG. 8, component 808 can be configured to send one or more coded signal(s) 810 to electrode pair 1 (324), while component 812 can be configured to send one or more coded signal(s) 814 for droplet control to one or more of electrode pair(s) 2 (334), 3 (336), 4 (338), and 5 (340) in the plurality of secondary channels (e.g., one of more of channels 344 (“A” or sixth channel), 346 (“B” or seventh channel), 348 (“C” or eighth channel), etc.) branching from fourth channel 314.

It can be understood that, according to various non-limiting implementations, embodiments of the disclosed subject can be adapted to provide at least some of the secondary channels with an associated electrode pair for applying an electric field (e.g., E>0, electric field above a threshold, etc.) to the respective secondary channel to stop the flow of a droplet (e.g., ER droplet, GER droplet, etc.), either temporarily or otherwise. Thus, in an aspect, droplets (e.g., ER droplet, GER droplet, etc.) in a respective secondary channel having stopped channel flow can form a “plug” to stop other fluid flow (e.g., ER droplet, GER droplet, carrier fluid, gas bubbles, etc.) in the respective secondary channel. Thus, in various non-limiting implementations, controller component 802 (or component(s), subcomponent(s), module(s), or portion(s) thereof) can provide functions of droplets logic control (e.g., ER droplet logic control, GER droplet logic control, etc.) including digital encoding, direction switching and storage in microfluidic chip 302, droplet display or microfluidic chip 800, for example, by sending one or more coded signal(s) 814 to one or more of electrode pair(s) 2 (334), 3 (336), 4 (338), and 5 (340) in the plurality of secondary channels (e.g., one of more of channel(s) 344 (“A” or sixth channel), 346 (“B” or seventh channel), 348 (“C” or eighth channel), etc.), which can direct droplets (e.g., ER droplets, GER droplets, etc.) and/or allow flow of carrier fluid into desired channels according to the one or more coded signal(s) 814.

Thus, according to non-limiting aspects, microfluidic chip 302, droplet display or microfluidic chip 800 can be controlled to generate droplets (e.g., ER droplets, GER droplets, etc.), direct droplets, and/or allow flow of carrier fluid into desired channels according to one or more coded signal(s) 810 and one or more coded signal(s) 814. It can be understood that the direction of droplets, and/or allowance of flow of carrier fluid into a secondary channel of interest can be achieved by blocking, inhibiting, or otherwise preventing flow of fluid into the other secondary channels by employing one or more of the coded signal(s) 814 that facilitate blocking those other secondary channels. In other words, in various non-limiting implementations, one or more electric field(s) can be applied with one or more electrode pair(s) in those other secondary channels so as to stop a droplet (e.g., ER droplets, GER droplets, etc.) in those other secondary channels, which can result in forming a “plug” blocking further flow of carrier fluid and droplets into those other secondary channels, until such a time as the one or more electric field(s) is reduced or turned off.

For example, in FIG. 8, fifth channel 342 can be blocked by trapping a droplet (e.g., ER droplet, GER droplet, etc.) adjacent to electrode pair 2 (334) by applying an electric field of sufficient strength with electrode pair 2 (334). As a further example, by directing droplets (e.g., ER droplets, GER droplets, etc.) to one secondary channel of interest at a time (e.g., such as by blocking flow to the other secondary channels), droplets can be stored at desired locations in the secondary channels.

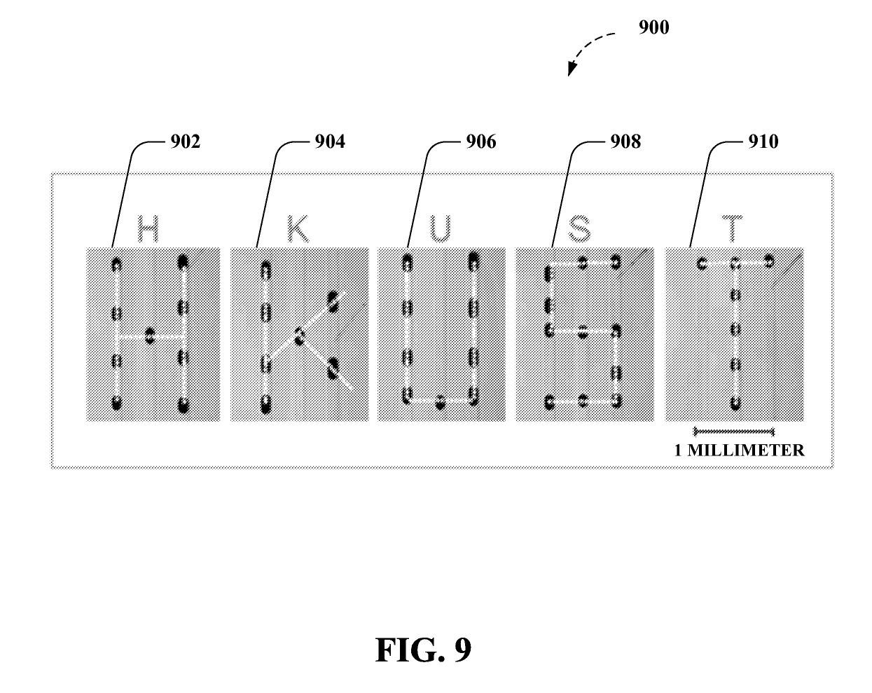

As yet another non-limiting example, the approach described above can be used to make a display, according to various aspects of the disclosed subject matter. For instance, in the example shown in FIG. 8 the secondary channels (e.g., one of more of channel(s) 344 (“A” or sixth channel), 346 (“B” or seventh channel), 348 (“C” or eighth channel), etc.) can be used to store the droplets (e.g., ER droplets, GER droplets, etc.) so as to form a display panel with characters displayed as a result of suitably formed one or more coded signal(s) 814. Thus, it can be seen from FIGS. 8 and 9 that the droplets can be arranged to form the letter “H,” such as in image 902 of FIG. 9.

For instance, FIG. 9 depicts optical images 902, 904, 906, 908, and 910 generated by the exemplary non-limiting droplet display or microfluidic chip 800 as described with reference to FIG. 8. As previously described, to direct droplets (e.g., ER droplets, GER droplets, etc.) to a secondary channel of interest, the one or more coded signal(s) 814 can apply voltage to one or more electrode pair(s) to create electric fields of sufficient strength in the other non-selected secondary channels so as to stop the flow in these other non-selected secondary channels, leaving only the secondary channel of interest open for flow. Meanwhile, according to a further non-limiting aspect, droplets (e.g., ER droplets, GER droplets, etc.) of the desired attributes (e.g. size, spacing, timing, etc.) can be generated, for example, at the time desired and/or spaced apart by the desired amount, by control of the first electrode pair 1 (324) using techniques described above with reference to FIGS. 1-7. Optical images 904, 906, 908, and 910 further demonstrate capabilities of the exemplary non-limiting droplet display or microfluidic chip 800.

According to a particular non-limiting embodiment of the disclosed subject matter, controller component 802 of droplet display or microfluidic chip 800 can comprise a voltage switching device (e.g., a LabVIEW™-controlled high voltage switching device, etc.) that can facilitate applying one or more digital signals (e.g., one or more coded signal(s) 810 for droplet generation) to pair 324 of electrodes facing each other on opposite sides of first channel 308 to generate encoded droplets (e.g., encoded ER droplets, encoded GER droplets, etc.) on demand. In addition one or more digital signals (e.g., one or more coded signal(s) 814 for droplet control, etc.) can be applied to one or more of electrode pair(s) 2 (334), 3 (336), 4 (338), and 5 (340) to facilitate droplet control (e.g., switching direction, storing ER or GER droplets secondary channels, etc.) in a respective one or more of the plurality of secondary channel(s) (e.g., one of more of channel(s) 344 (“A” or sixth channel), 346 (“B” or seventh channel), 348 (“C” or eighth channel), etc.) branching from fourth channel 314. Thus, in further non-limiting implementations, a character (e.g., such as character, “H,” “K,” etc. as depicted in images 902, 904, etc., respectively) can be programmed via a controller subcomponent or module 816 of controller component 802 to facilitate droplet direction switching and storage, and which associated control signals can be sent to electrode pairs 1 (324), 2 (334), 3 (336), 4 (338), and 5 (340).

For the exemplary character, “H,” four droplets (e.g., ER droplets, GER droplets, etc.) can be stored in channels 344 (“A” or sixth channel) and 348 (“C” or eighth channel), while one droplet can be stored in channel 346 (“B” or seventh channel), such as is illustrated, for example, via one or one or more coded signal(s) 814 for droplet control (e.g., illustrated as control signals A, B, and C in FIG. 8). In further non-limiting implementations, one or more coded signal(s) 810 for droplet generation can be sent to pair 324 of electrodes facing each other on opposite sides of first channel 308 to form the desired droplet sequence corresponding to each of character depicted in optical images 902, 904, 906, 908, and 910. Thus, in accordance with various aspects, the one or more encoded droplets sequence(s) can be sorted and stored in the plurality of secondary channels (e.g., one of more of channels 344 (“A” or sixth channel), 346 (“B” or seventh channel), 348 (“C” or eighth channel), etc.) as desired. In addition, it can be seen in FIG. 9 that the subsequent characters “K,” “U,” “S,” and “T” can be similarly formed. According to further non-limiting aspects, once a desired character sequence is finished, or otherwise, unused or further droplets can be moved out to side channel 352 via the fifth channel 342 by switching off electrode pair 2 (342). As a result, FIG. 9 demonstrates an exemplary non-limiting implementation of a display having characters “HKUST” clearly visible.

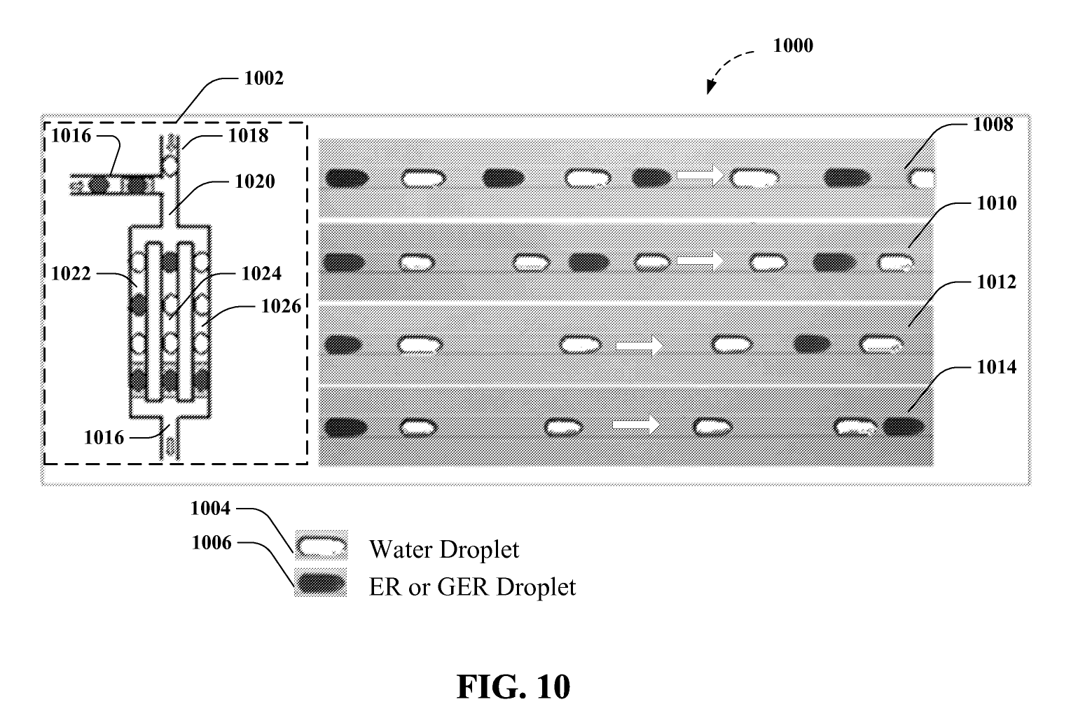

FIG. 10 illustrates a schematic diagram of an exemplary non-limiting chip component 1002 (e.g., a network of channels in microfluidic chip 302, in droplet display or microfluidic chip 800, etc.) suitable for incorporation of aspects of the disclosed subject matter. For instance, FIG. 10 depicts one or more orthogonal channel(s) that can be adapted to form droplet “packages” (e.g., water droplet “packages,” etc.) and optical images, such as is depicted with one or more water droplet(s) 1004 being formed and sandwiched between two ER droplets 1006 (e.g., GER droplets, etc.). For example, channels 1008, 1010, 1012, and 1014 depict one, two, three, and four water droplets 1004 being formed and sandwiched between two ER droplets 1006 (e.g., GER droplets, etc.) respectively.

Thus, in yet other non-limiting implementations, ER droplets (e.g., ER droplets, GER droplets, etc.) can also facilitate control other types of fluid (e.g., liquid droplets, gaseous bubbles, etc.). In other words, as demonstrated in FIG. 10, for example, by injecting ER droplets 1006 (e.g., ER droplets, GER droplets, etc.) among water droplet 1004 trains, various non-limiting embodiments can form “packages” of virtually any number of water droplets sandwiched between ER droplets 1006 (e.g., ER droplets, GER droplets, etc.), which ER droplets 1006 can facilitate guiding the liquid droplets train (e.g., water droplet 1004 trains, etc.).

Thus, as can be seen in FIG. 10, exemplary non-limiting chip component 1002 (e.g., a network of channels in microfluidic chip 302, in droplet display or microfluidic chip 800, etc.) can comprise a first channel 1016 adapted to inject ER droplets 1006 (e.g., ER droplets, GER droplets, etc.) and a second channel 1018 adapted to inject droplets of a first fluid (e.g., water droplets 1004) carried in a second fluid (e.g., a carrier fluid, such as oil, etc.) into a main channel 1020. According to a non-limiting aspect, main channel 1020 can branch into one or more of a plurality of secondary channel(s) (e.g., one or more of a first 1022, a second 1024, a third 1026 secondary channel, and so on), which secondary channels can recombine to form a main outlet channel 1028. According to a further non-limiting aspect, one or more of the first channel 1016 and one or more of the plurality of secondary channel(s) (e.g., one or more of a first 1022, a second 1024, a third 1026 secondary channel, and so on) can be provided with respective electrode pairs such as described above, regarding FIGS. 3, 8, etc., for example.

Accordingly, in various non-limiting embodiments, the disclosed subject matter can facilitate controlling flow of the carrier fluid into a secondary channel of interest of the one or more of the plurality of secondary channel(s) (e.g., one or more of a first 1022, a second 1024, a third 1026 secondary channel, and so on) by using associated electrode pairs to trap one or more ER droplet(s) 1006 (e.g., one or more ER droplet(s), one or more GER droplet(s), etc.) as a plug to block the other secondary channels. As a result, carrier fluid can then carry any droplets of the first fluid (e.g., water droplets 1004), which have been injected upstream of the trapped one or more ER droplet(s) 1006 (e.g., one or more ER droplet(s), one or more GER droplet(s), etc.) to the secondary channel of interest.

In further non-limiting implementations, injection frequency (e.g., timing relative to one or more injected water droplet(s) 1004) and/or phase (e.g., spacing relative to one or more injected water droplet(s) 1004) of the one or more ER droplet(s) 1006 (e.g., one or more ER droplet(s), one or more GER droplet(s), etc.) can be adjusted, controlled, and/or manipulated by a controller component, such as a controller component 802 as described regarding FIG. 8, for example, so that one ER droplet of the one or more ER droplet(s) 1006 (e.g., one or more ER droplet(s), one or more GER droplet(s), etc.) can lead a desired train of water droplets (e.g., ER droplets 1006 can be downstream of a desired train of water droplets with respect to the direction of flow given by the arrows in the respective channels). For instance, as depicted in FIG. 10, channels 1008, 1010, 1012, and 1014 depict one, two, three, and four water droplets 1004 being formed and sandwiched between two ER droplets 1006 (e.g., GER droplets, etc.) respectively.

Accordingly, in various non-limiting implementations, the disclosed subject matter facilitates controlling one or more ER droplet(s) 1006 (e.g., one or more ER droplet(s), one or more GER droplet(s), etc.), which in turn can enable controlling (e.g., directing, sorting, delivering, or otherwise manipulating a train of a first fluid droplets (e.g., such as a train of one or more water droplet(s) 1004, etc.)). It can be understood that, in turn, the train of the first fluid droplets (e.g., such as a train of one or more water droplet(s) 1004, etc.) can be to targeted destination(s) inside exemplary non-limiting chip component 1002 (e.g., a network of channels in microfluidic chip 302, in droplet display or microfluidic chip 800, etc.), where other desired operations (e.g., mixing, heating, and/or other processing, etc.) can be performed. It can be further understood that according to various non-limiting embodiments, the disclosed subject matter can facilitate such controls via controller component 802, or portions thereof, and/or digital programming, and so on, etc.

While the disclosed subject matter has been described above in connection with various embodiments, it is to be understood that other similar embodiments may be used with, or modifications and additions may be made to, the described embodiments for performing the same or similar functions as described herein without deviating from the disclosed subject matter. For instance, while water is described above as one possible “first fluid” in the train of the first fluid droplets (e.g., such as a train of one or more water droplet(s) 1004, etc.), which is disparate from the ER fluid droplets (e.g., ER droplets 1006, GER droplets 1006, etc.) and the second fluid (e.g., a carrier fluid, such as oil, etc.), it can be understood that such selections represent only one such possible example. It can be further understood that in practical application, various reagents and/or chemicals, etc. can be suitable as a “first fluid,” depending in part on selection of an ER fluid, a second fluid (e.g., a carrier fluid, etc.), and so on, etc. As a result, in various non-limiting implementations, the disclosed subject matter can advantageously direct particular fluids of interest (e.g., liquids, gases, chemicals, reagents, biological agents, etc.) to desired locations in a network of channels on a microfluidic chip (e.g., a network of channels in microfluidic chip 302, in droplet display or microfluidic chip 800, a network of channels in exemplary non-limiting chip component 1002, etc.).

As a further example, while the above non-limiting examples described control and/or manipulation of another fluid (e.g., a first fluid, water, liquids, gases, chemicals, reagents, biological agents, etc.) by controlling ER droplets (e.g., ER droplets 1006, GER droplets 1006, etc.) in a second fluid (e.g., a carrier fluid, such as oil, etc.), further non-limiting embodiments can facilitate control and/or manipulation of another fluid (e.g., a first fluid, water, liquids, gases, chemicals, reagents, biological agents, etc.) more directly by using ER fluid (e.g., ER fluid, GER fluid, etc.) as a second fluid (e.g., a carrier fluid, etc.) as described herein regarding FIGS. 2, 11-14, etc., for example. Thus, as further described below, it can be understood how such modifications can be applied to various non-limiting implementations as described above, regarding FIGS. 3, 8, 10, etc. for example.

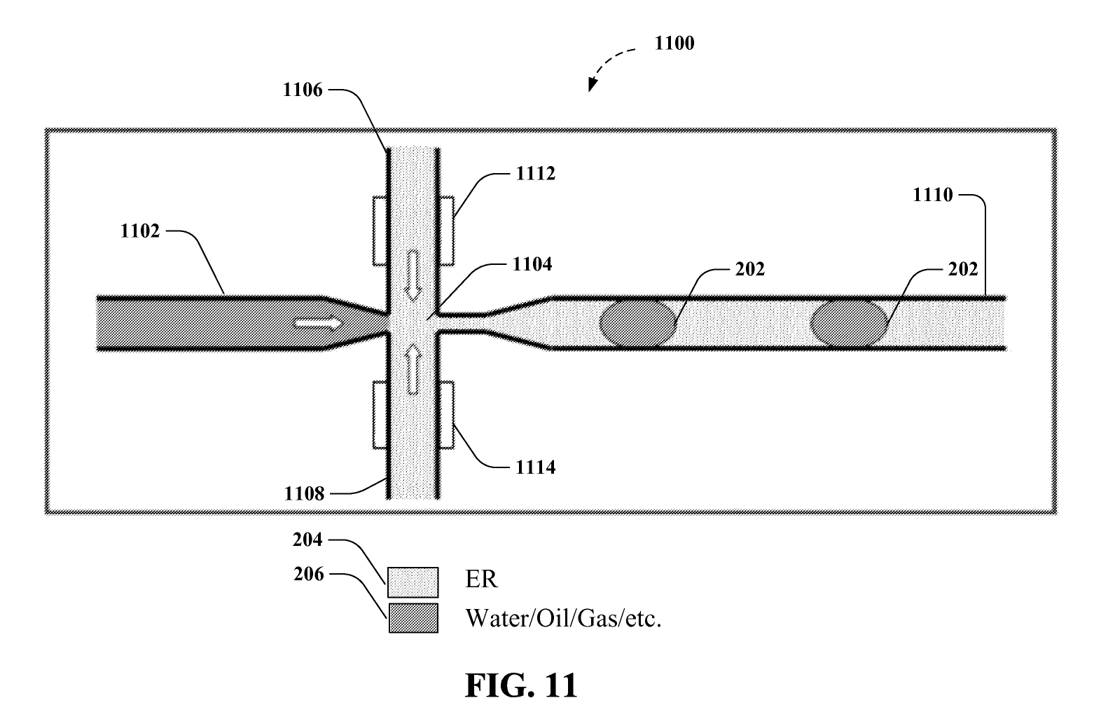

For ease of explanation and not limitation, FIGS. 11-12 use similar nomenclature and/or reference characters as that for FIG. 2, where appropriate, to depict similar functional characteristics or features as that described above, for example, regarding FIG. 2, etc. Accordingly, FIG. 11 depicts a schematic illustration demonstrating non-limiting aspects of droplet 202 generation for a fluid (e.g., a first fluid, water, liquids, gases, chemicals, reagents, biological agents, etc.) in ER fluid 204 (e.g., ER fluid, GER fluid, etc.) as a second fluid (e.g., a carrier fluid, etc.) and using an exemplary flow-focusing junction 1100, according to further aspects of the disclosed subject matter. For instance, FIGS. 2 and 11 are schematic diagrams showing how droplets 202 of a first fluid 206 can be generated and formed when the carrier fluid is an ER fluid 204 (e.g., ER fluid, GER fluid, etc.).

According to exemplary non-limiting embodiments, first fluid 206 can be immiscible, or at least partially immiscible, with ER fluid 204 (e.g., ER fluid, GER fluid, etc.). As a non-limiting example, first fluid 206 can be water, one or more liquid(s), one or more gas/gases, one or more chemical(s), one or more reagent(s), one or more biological agent(s), and/or mixture(s) thereof, etc. In various embodiments, first fluid 206 can be injected into a first channel 1102, which can lead to junction 1104. In turn, junction 1104 can join one or more of second 1106 and third 1108 side channel(s), which, in various non-limiting implementations, can be injected with one or more stream(s) of ER fluid 204 (e.g., ER fluid, GER fluid, etc.). In a further aspect, fourth channel 1110 can lead downstream of junction 1104. As described above with regard to FIGS. 1-2, for example, one or more of first 1102 and fourth 1110 channel(s) can taper to a narrower width as they approach junction 1104, which can advantageously promote the focusing of the flow of fluid (e.g., ER fluid, GER fluid, such as ER 204, etc.) and can facilitate generating droplet(s) (e.g., droplets 202, etc.).

In further non-limiting implementations rather than employing a four channel arrangement as described with regard to FIGS. 2 and 11, a T-junction arrangement can be employed as depicted in FIG. 12. For instance, FIG. 12 depicts a schematic illustration of further non-limiting aspects of droplet generation 202 for a fluid (e.g., a first fluid, water, liquids, gases, chemicals, reagents, biological agents, etc.) in ER fluid 204 (e.g., ER fluid, GER fluid, etc.) as a second fluid (e.g., a carrier fluid, etc.) and using an exemplary T-junction 1200, according to further aspects of the disclosed subject matter. For instance, FIG. 12 is a schematic diagrams showing how droplets 202 of a first fluid 206 can be generated and formed when the carrier fluid is an ER fluid 204 (e.g., ER fluid, GER fluid, etc.). According to further non-limiting implementations, first fluid 206 can be immiscible, or at least partially immiscible, with ER fluid 204 (e.g., ER fluid, GER fluid, etc.).

As a non-limiting example, first fluid 206 can be water, one or more liquid(s), one or more gas/gases, one or more chemical(s), one or more reagents(s) one or more biological agent(s), and/or mixture(s) thereof, etc.). In various embodiments, first fluid 206 can be injected into a first channel 1202, which can lead to junction 1204. In turn, junction 1204 can join second 1206 side channel, which, in various non-limiting embodiments, can be injected with ER fluid 204 (e.g., ER fluid, GER fluid, etc.). In a further aspect, fourth channel 1210 can lead downstream of junction 1204. In addition, in various exemplary implementations, second 1206 channel can taper to a narrower width as it approaches junction 1204, which can advantageously promote the focusing of the flow of fluid (e.g., ER fluid, GER fluid, such as ER 204, etc.) and can facilitate generating droplet(s) (e.g., droplets 202, etc.).

Referring again to FIGS. 11-12, it can be understood that flow of ER fluid 204 (e.g., ER fluid, GER fluid, etc.) in the second (1106/1206) and/or third (1108) channels can be controlled by one or more of associated electrode pair(s) (1112/1212 and 1114, respectively) embedded into walls of associated channels, as described above regarding FIGS. 3-10, for example. As a further non-limiting example, digital signals can be employed to control one or more of electrode pair(s) (1112/1212 and 1114) to facilitate controlling, modulating, manipulating, etc. the flow of ER fluid 204 (e.g., ER fluid, GER fluid, etc.). For instance, by controlling, modulating, manipulating, etc. the flow of ER fluid 204 (e.g., ER fluid, GER fluid, etc.), such as by reducing its flow rate, switching it on and off, and so on, for example, various non-limiting implementations can produce droplets 202 of first fluid 206.

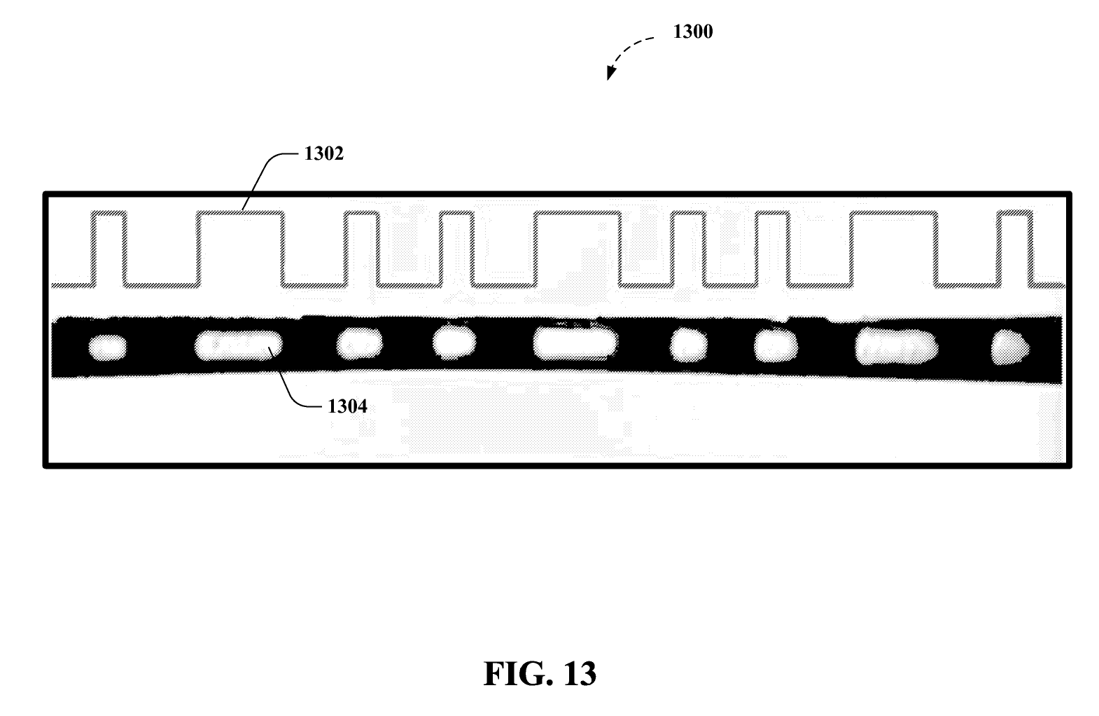

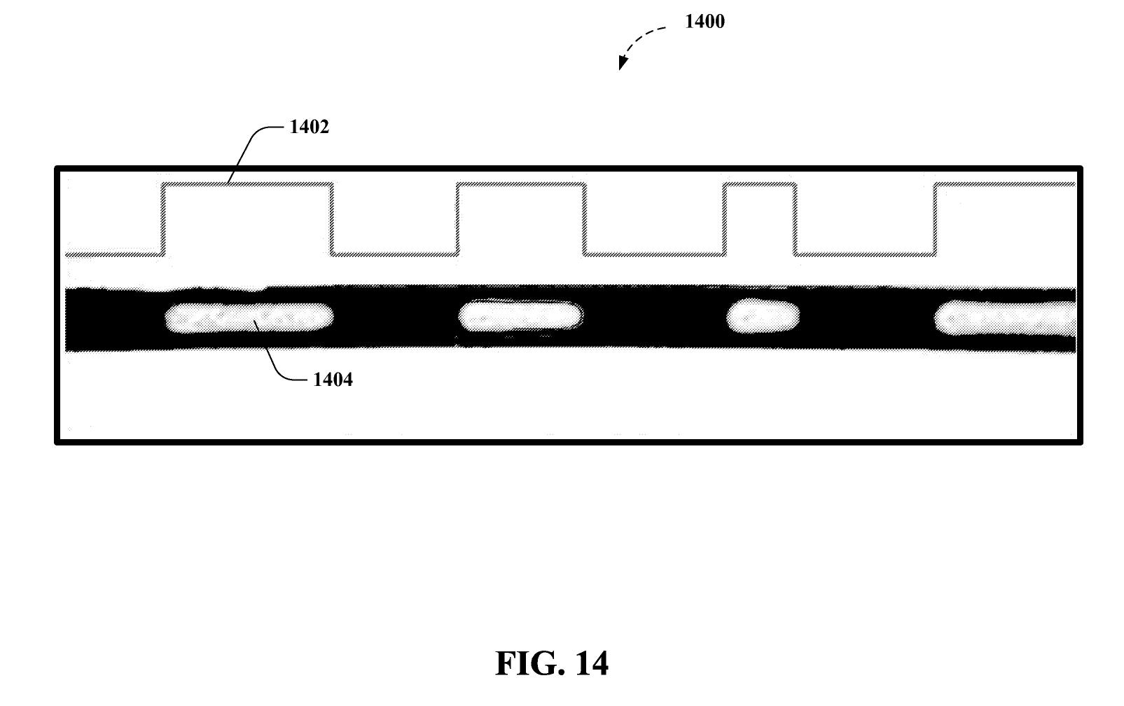

It can be understood that size and phase of first fluid 206 droplets 202 can be actively controlled by one or more control signal(s) applied to one or more of associated electrode pair(s) (1112/1212 and 1114, respectively), as depicted in FIGS. 13-14, and as described above regarding FIGS. 3-10, for example. For instance, FIGS. 13-14 depict exemplary non-limiting electrical control signals 1302 and 1402 with black and white optical images of resultant droplet trains 1304, 1404 generated according to various aspects of the disclosed subject matter. Thus, in various aspects, by properly controlling the flow rate of one or more of ER fluid 204 (e.g., ER fluid, GER fluid, etc.) and first fluid 206, one or more droplet(s) 202 of first fluid 206 of desired size can be generated. In further non-limiting aspects, droplet size (e.g., size of droplet(s) 202 of first fluid 206) and/or separation between two successive droplets can be tuned by adjusting, for instance, frequency and/or duty cycle of control signals (e.g., electrical control signals 1302, 1402, etc.) applied to electrode pairs (e.g., one or more of associated electrode pair(s) (1112/1212 and 1114), respectively in FIGS. 11-12, etc.). For instance, it can be seen in FIGS. 13-14 that droplets 202 of first fluid 206 can be generated when one or more control signal(s) (e.g., electrical control signals 1302, 1402, etc.) is raised sufficiently (e.g., above a certain threshold), for example, at the pulses. As a result, flow of ER fluid 204 (e.g., ER fluid, GER fluid, etc.) can be stopped and/or slowed, such that flow of first fluid 206 first fluid prevails and passes through the junction (1104/1204) and into the fourth channel (1110/1210), according to various non-limiting embodiments of the disclosed subject matter.

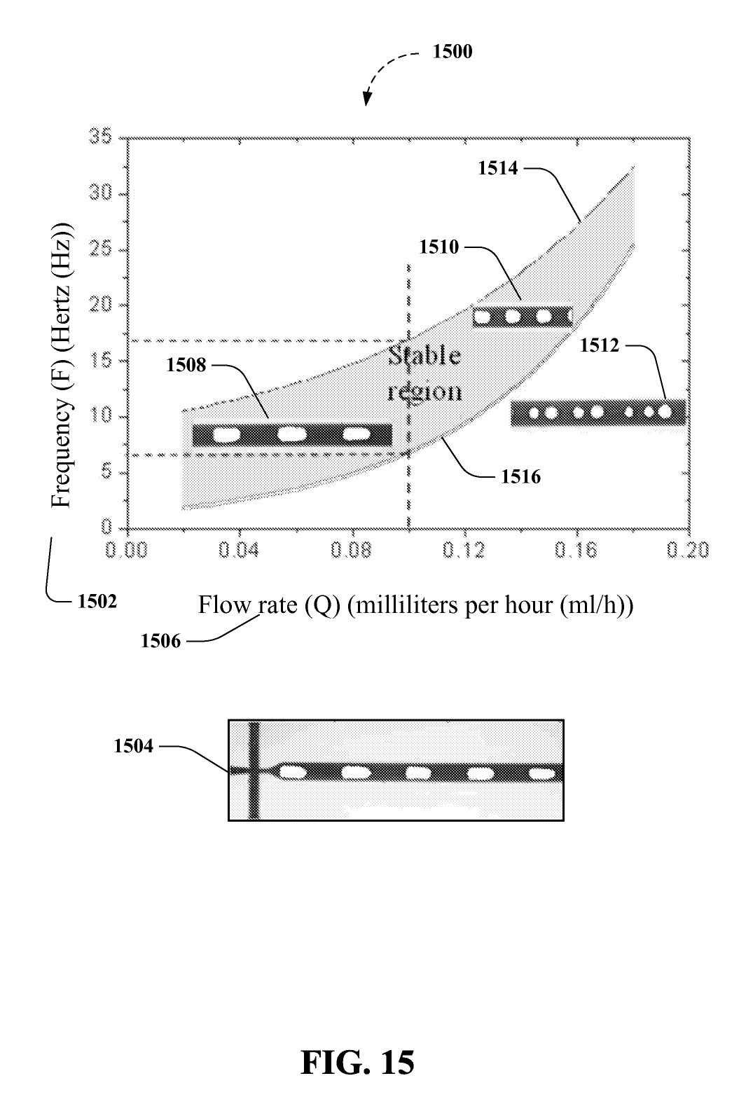

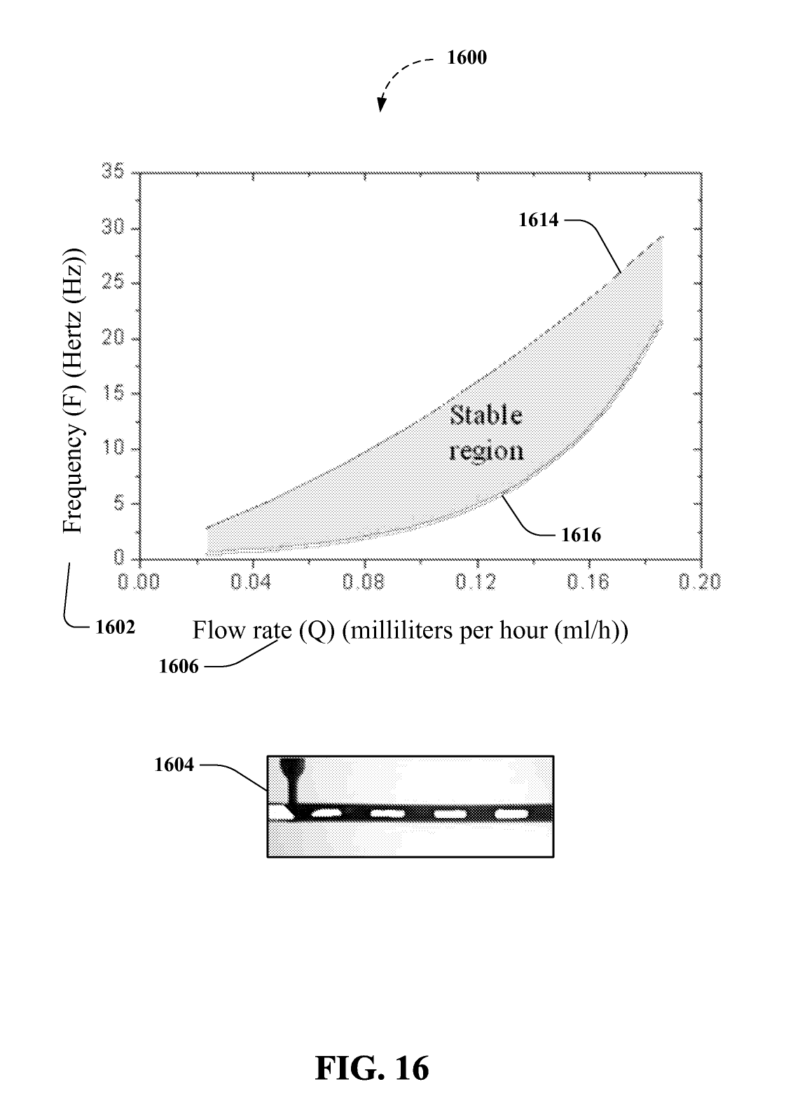

For example, FIGS. 15-16 depict graphs 1500 and 1600 demonstrating exemplary frequency of droplet generation (F) (1502/1602) under two non-limiting implementations (1504/1604), plotted as a function of flow rate (Q) (1506/1606). Black and white optical images 1508, 1510, and 1512 depict exemplary droplet generation results under different conditions. In addition, lines 1514 and 1614 indicate the approximate highest frequency, whereas lines 1516 and 1616 indicate the approximate lowest frequency, that stable droplet generation could be achieved for a given flow rate in two non-limiting implementations 1504 and 1604, respectively. It can be understood that the shaded areas between lines 1514 (1614) and 1516 (1616) can be denoted as a stable droplet generation regime (e.g., labeled as stable region). As a non-limiting example, a stable droplet generation regime can include sets of corresponding F and Q having a one-to-one correspondence between frequency of applied electrical control signals and a rate or frequency of droplet generation (F), for example.

Thus, for various non-limiting embodiments of the disclosed subject matter, FIGS. 15-16 demonstrate potential effects of applied electrical control signals at different injection rates (e.g., flow rates (Q) (1506/1606)). Accordingly, stable droplet generation regions are depicted as a function of rate or frequency of droplet generation (F) that correspond to applied electrical signals' frequency. It is noted that, with stable droplet generation regions, droplet generation (e.g., generation of one or more droplet(s) 202 of first fluid 206, etc.) may be actively tuned by varying frequency of control signals (e.g., electrical control signals 1302, 1402, etc.) applied to electrode pairs (e.g., one or more of associated electrode pair(s) (1112/1212 and 1114), respectively) in various non-limiting implementations (e.g., a flow-focusing implementation, (FIG. 11), T-junction implementations (FIG. 12), etc.). Accordingly, in various non-limiting implementations, the disclosed subject matter can facilitate tuning droplet generation parameters, (e.g., droplet generation rate, droplet generation size, etc.) for example, by convenient variation of external electrical signal(s) (e.g., coded signal(s), digital signal(s), electrical control signal(s) 1302, 1402, etc.).

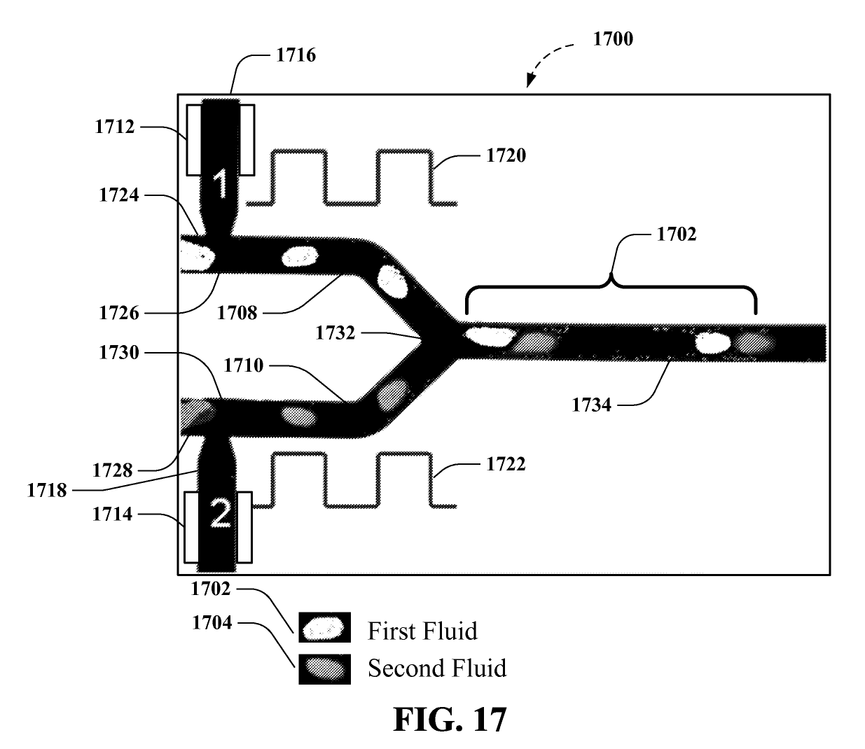

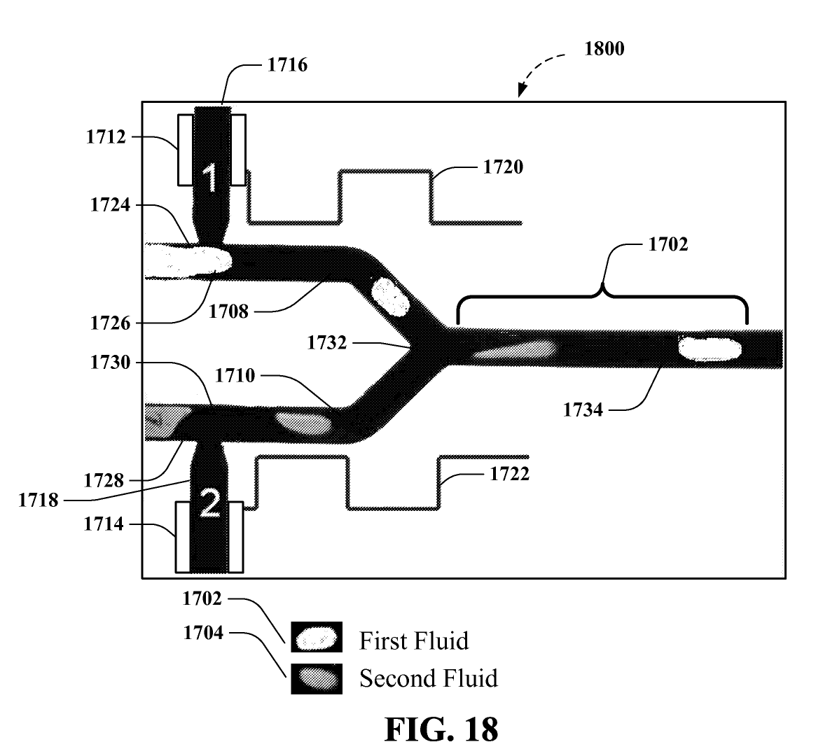

In further non-limiting implementations, the disclosed subject matter facilitates generating one or more droplet(s) of a first fluid and one or more droplet(s) of a second fluid, which can then both be carried by ER fluid (e.g., ER fluid, GER fluid, etc.) employed as a carrier fluid. As non-limiting examples, FIGS. 17-18 demonstrate electrically controlled generation of an exemplary droplet train 1702 comprising one or more droplet(s) of a first fluid 1704 and one or more droplet(s) of a second fluid 1706 from two converging channels 1708 and 1710 via one or more pair(s) 1712 and 1714 of electrodes facing each other on opposite sides of channels 1 (1716) and 2 (1718), to which electrical control signals 1720 an 1722 can be applied, respectively.

Thus, FIGS. 17-18 demonstrates electrically controlled generation of exemplary droplet train 1702 with electrical control signals 1720 and 1722 having the same phase (FIG. 17) and having opposite phases (FIG. 18). While the above non-limiting example employs a first 1702 and second 1704 fluid, however, in practical applications, either of the first fluid or the second fluid can be particular fluids of interest (e.g., liquids, gases, chemicals, reagents, biological agents, mixtures thereof, etc.). In addition, while FIGS. 17-18 depict an exemplary non-limiting T-junction arrangement in which droplets of first 1702 and second 1704 fluid can be generated, such as described above regarding FIG. 12, it can be understood that an exemplary flow-focusing arrangement could be used, such as described above regarding FIG. 11.

Accordingly, in further non-limiting implementations, first fluid 1702 droplets can be generated in a first channel 1724 adapted to convey the first fluid 1702 proximate to junction 1726 with channel 1 (1716), adapted to convey ER fluid (e.g., ER fluid, GER fluid, etc.) employed as a carrier fluid, and converging channel 1708. Likewise, second fluid 1704 droplets can be generated in a second channel 1728 adapted to convey the second fluid 1704 proximate to junction 1730 with channel 2 (1718), adapted to convey ER fluid (e.g., ER fluid, GER fluid, etc.) employed as a carrier fluid, and converging channel 1710. In addition, channels 1708 and 1710 can join at junction 1732 and can form a main channel 1734. As previously described, control of one or more pair(s) 1712 and 1714 of electrodes facing each other on opposite sides of channels 1 (1716) and 2 (1718) can be accomplished by applying one or more electrical control signal(s) (e.g., electrical control signal(s) 1720 and 1722, etc.) to facilitate generation of the droplets. As a result, as can be seen in FIGS. 17-18, two types of droplets (e.g., of a first 1702 and of a second 1704 fluid, etc.) can be generated simultaneously to flow to main channel 1734 depending upon, for example whether electrical control signals 1720 and 1722 to electrode pairs 1712 and 1714 are in phase (e.g., having associated uniform pairs of droplets) or out of phase with each other (e.g., having no associated no pair formation), and so on.

While the disclosed subject matter has been described above in connection with various embodiments, it is to be understood that other similar embodiments may be used with, or modifications and additions may be made to, the described embodiments for performing the same or similar functions as described herein without deviating from the disclosed subject matter.

### Further Non-Limiting Embodiments of Microfluidic Droplet Generation, Manipulation

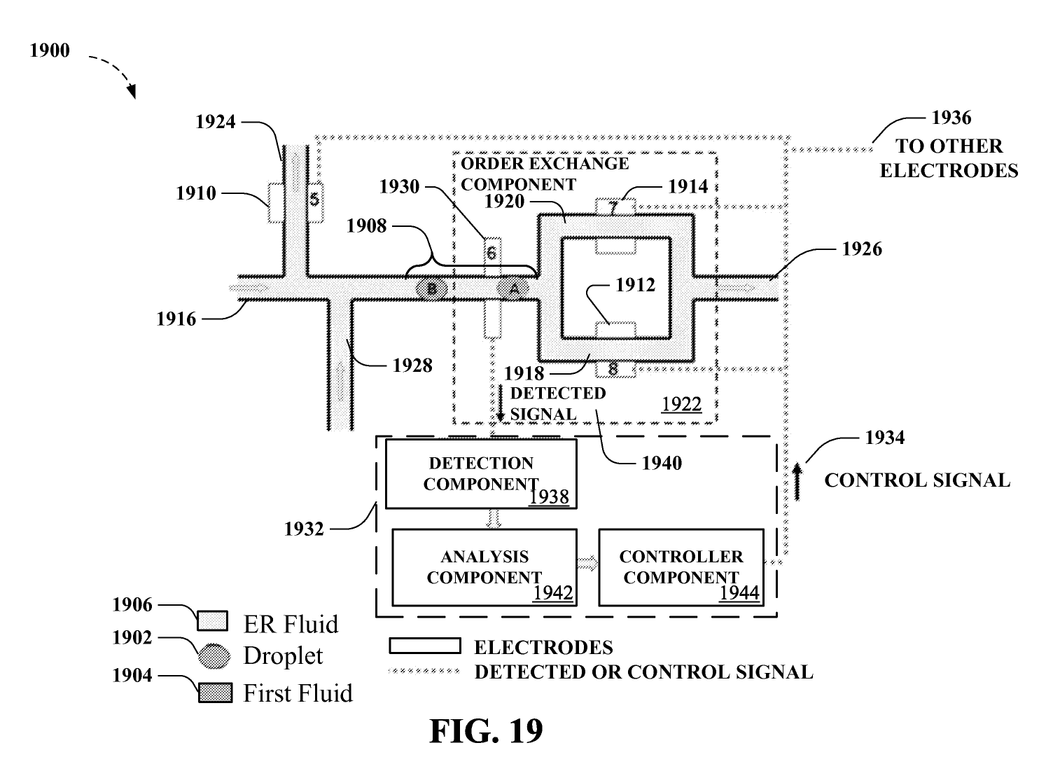

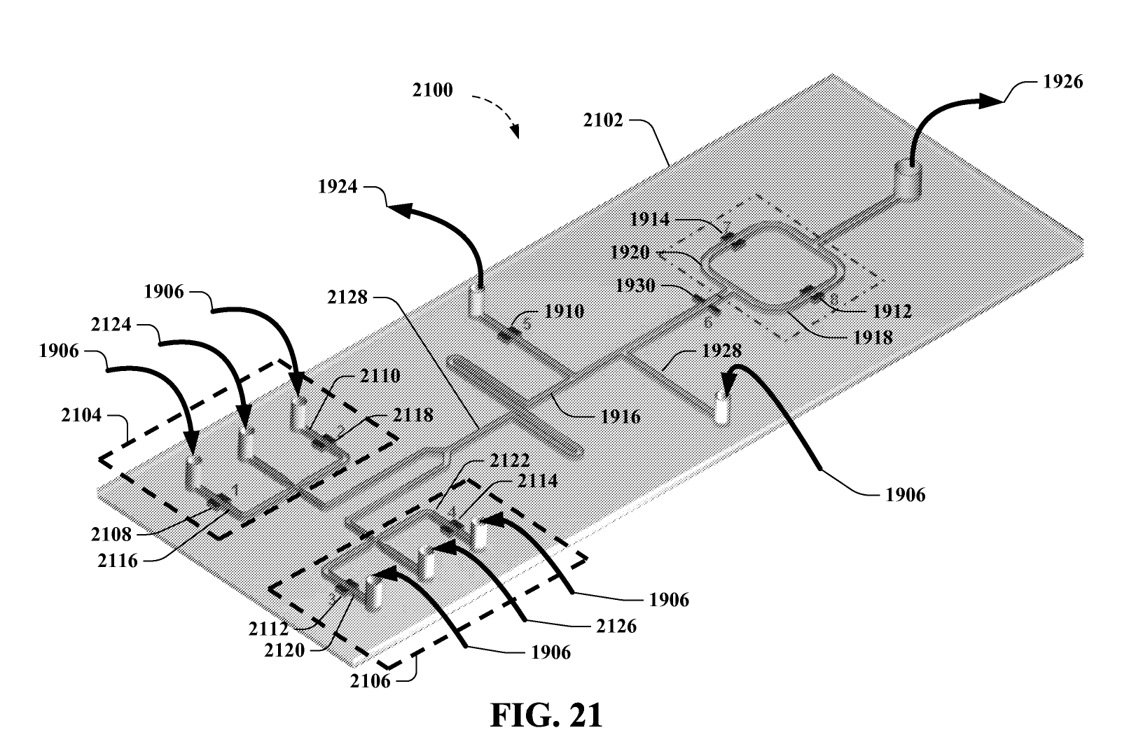

In a further non-limiting aspect, the disclosed subject matter facilitates droplet manipulation by ER fluid (e.g., ER fluid, GER fluid, etc.) employed as a carrier fluid as described above, and as further described below regarding FIGS. 19-21. Accordingly, FIG. 19 depicts an exemplary non-limiting schematic diagram of a portion of a microfluidic chip 1900 comprising a network of channels suitable for incorporation of aspects of the disclosed subject matter, and in which the ordering of droplets 1902 can be exchanged. For ease of explanation and not limitation, FIGS. 20-21 use similar nomenclature and/or reference characters as that for FIG. 19, where appropriate, to depict similar functional characteristics or features as that described below, for example, regarding FIG. 19, etc. Accordingly, FIG. 20 depicts exemplary non-limiting optical images (e.g., time series of optical images 2002, 2004, 2006, and 2008) of a subset of a network of channels, in which exchanging order of droplets is demonstrated. In addition, FIG. 21 illustrates a non-limiting schematic depiction 2100 of an exemplary microfluidic chip 2102 suitable for incorporation of aspects of the disclosed subject matter, in which droplets 1902 of a first fluid 1904 can be generated and/or controlled in ER fluid 1906 (e.g., ER fluid, GER fluid, etc.) employed as a carrier fluid.

Thus, in a non-limiting aspect, FIG. 19 illustrates an exemplary non-limiting implementation that can use flow rate control to switch ordering in a train 1908 of droplets 1902. In addition, while droplets 1902 (e.g., indicated as droplet 1902 “A” and droplet 1902 “B” in FIGS. 19-20) have been depicted as comprising a first fluid 1904 for ease of explanation, it is understood that the disclosed subject matter is not so limited. For instance, droplet 1902 “A” and droplet 1902 “B” can comprise similar or disparate compositions of interest (e.g., liquids, gases, chemicals, reagents, biological agents, mixtures thereof, etc.). Moreover, while train 1908 is depicted as comprising two of droplets 1902 (e.g., droplet 1902 “A” and droplet 1902 “B”), it can be understood that train 1908 of droplets 1902 can comprise one or more droplet(s) 1902, as previously described. In an aspect, train 1908 of different droplets 1902 can be regarded as a coded message, which, according to various non-limiting embodiments, can be revised and/or corrected via exchanging or switching the order of droplets 1902.

Accordingly, in various non-limiting implementations, the disclosed subject matter facilitates controlling, modulating, and/or manipulating direction and/or flow rate of droplets 1902 of a fluid (e.g., first fluid 1904, second fluid (not shown), etc.) carried by ER fluid 1906 (e.g., ER fluid, GER fluid, etc.) employed as a carrier fluid via application of one or more electric field(s) generated by one or more electrode pair(s) (e.g., electrode pair(s) 1910, 1912, 1914, embedded electrode pair(s), etc.) in a network of channels to ER fluid 1906 (e.g., ER fluid, GER fluid, etc.). Thus, it can be understood that in various non-limiting implementations, control of ER fluid 1906 (e.g., ER fluid, GER fluid, etc.) can be employed to carry out logic operations of droplets 1902 (e.g., guiding, order inversion, addition and/or removal from a train 1908 of droplets 1902, adjusting droplet separation, etc.).

In various non-limiting embodiments, microfluidic chip 1900 can comprise a main input channel 1916 (e.g., such as main channel 1734 as described in FIGS. 17-18, etc.), one or more branch channel(s) (e.g., first branch channel 1918, second branch channel 1920, etc.) of an order exchange component 1922 that can branch from main input channel 1916, one or more side channel(s) 1924 (e.g., channel adapted to allow disposal of excess or undesired fluid and/or droplets, to bypass first 1918 and second 1920 branch channels, and so on), main output channel 1926 adapted to collect and/or distribute droplet train 1908 from one or more branch channel(s) (e.g., first branch channel 1918, second branch channel 1920, etc.) of order exchange component 1922, and one or more additional side channels 1928 as described below. Thus, main input channel 1916 can form a main input channel for a subsection of microfluidic chip 1900 that can be adapted to facilitate controlling, modulating, and/or manipulating operations such as reversing the order of a pair of droplets, adjusting droplet separation, and so on. As a non-limiting example, a subsection of microfluidic chip 1900 supplied by main input channel 1916 could be used to change the order of chemical reagents into a desired order for a chemical reaction of interest.

As described above, in various non-limiting implementations, the disclosed subject matter facilitates controlling, modulating, and/or manipulating direction and flow rate of droplets 1902 of a fluid (e.g., first fluid 1904, etc.) carried by ER fluid 1906 (e.g., ER fluid, GER fluid, etc.) employed as a carrier fluid via application of one or more electric field(s) generated by one or more electrode pair(s) (e.g., electrode pairs 1910, 1912, 1914, etc.) in a network of channels to ER fluid 1906 (e.g., ER fluid, GER fluid, etc.). In addition, various non-limiting embodiments of the disclosed subject matter can comprise one or more electrode pair(s) that can be adapted to sense, detect, or otherwise facilitate indication proximity (e.g., by physical, electrical, mechanical, capacitive, optical, or other measurement, etc.) of one or more droplet(s) 1902 (e.g., electrode pair 1930, etc.). Thus, in an exemplary embodiment electrode pair 1910 associated with side channel 1924 can be adapted to allow disposal of excess or undesired fluid (e.g., first fluid 1904, ER fluid 1906, etc.) and/or droplets 1902, to bypass first 1918 and second 1920 branch channels, and so on. In a non-limiting aspect, electrode pair 1930 associated with main input channel 1916 can be positioned just prior a loop formed by one or more of first branch channel 1918, second branch channel 1920, etc., of order exchange component 1922, and can be adapted to sense, detect, or otherwise facilitate indication of the proximity of one or more droplet(s) 1902. In further non-limiting aspects, one or more of electrode pair(s) 1912, 1914, etc., associated with branch channels, such as first branch channel 1918, second branch channel 1920, etc., can be adapted to facilitate controlling, modulating, and/or manipulating operations such as reversing the order of a pair of droplets, adjusting droplet separation, and so on.

In further non-limiting implementations, embodiments of the disclosed subject matter (e.g., microfluidic chip 302, droplet display or microfluidic chip 800, chip component 1002, flow-focusing junction 1100, T-junction 1200, portion of a microfluidic chip 1900, etc.) can comprise a microfluidic chip controller component 1932, for example, similar to that described above regarding FIG. 8. In various non-limiting implementations, microfluidic chip controller component 1932 can be adapted to provide one or more coded signal(s) 1934, 1936 for droplet generation (e.g., first fluid droplet generation, second fluid droplet generation, etc.) as described above, for example, regarding FIGS. 3-8, etc., as well as to facilitate controlling, modulating, and/or manipulating operations such as reversing the order of a pair of droplets, adjusting droplet separation, and so on, via application of one or more electric field(s) generated by one or more electrode pair(s) (e.g., electrode pairs 1910, 1912, 1914, other electrode pairs associated with microfluidic chip 1900, etc.) in a network of channels to ER fluid 1906 (e.g., ER fluid, GER fluid, etc.).

Accordingly, as previously described, microfluidic chip controller component 1932 can facilitate applying an electric field of sufficient strength with an electrode pair associated with a channel such that flow of ER fluid 1906 (e.g., ER fluid, GER fluid, etc.) in the associated channel can be reduced (e.g., stopped, diminished, temporarily or otherwise, and so on). In further non-limiting implementations, microfluidic chip controller component 1932 can comprise one or components, subcomponents, or modules adapted to perform functions, or portions thereof, of droplets logic control (e.g., first fluid droplet logic control, second fluid droplet logic control, etc.). As further described below regarding FIG. 25, for example, in non-limiting implementations of the disclosed subject matter, microfluidic chip controller component 1932, subcomponents, or portions thereof can comprise a general purpose computer (e.g., a general purpose computer equipped with LabVIEW™ software, etc.), an appropriate data acquisition and/or input output hardware, associated connections, etc. As a further non-limiting example, microfluidic chip controller component 1932 can comprise a detection component 1938 adapted to facilitate detection of the proximity of one or more droplet(s) 1902, such as for example, by receiving and/or processing detected signal 1940 from electrode pair 1930 associated with main input channel 1916.

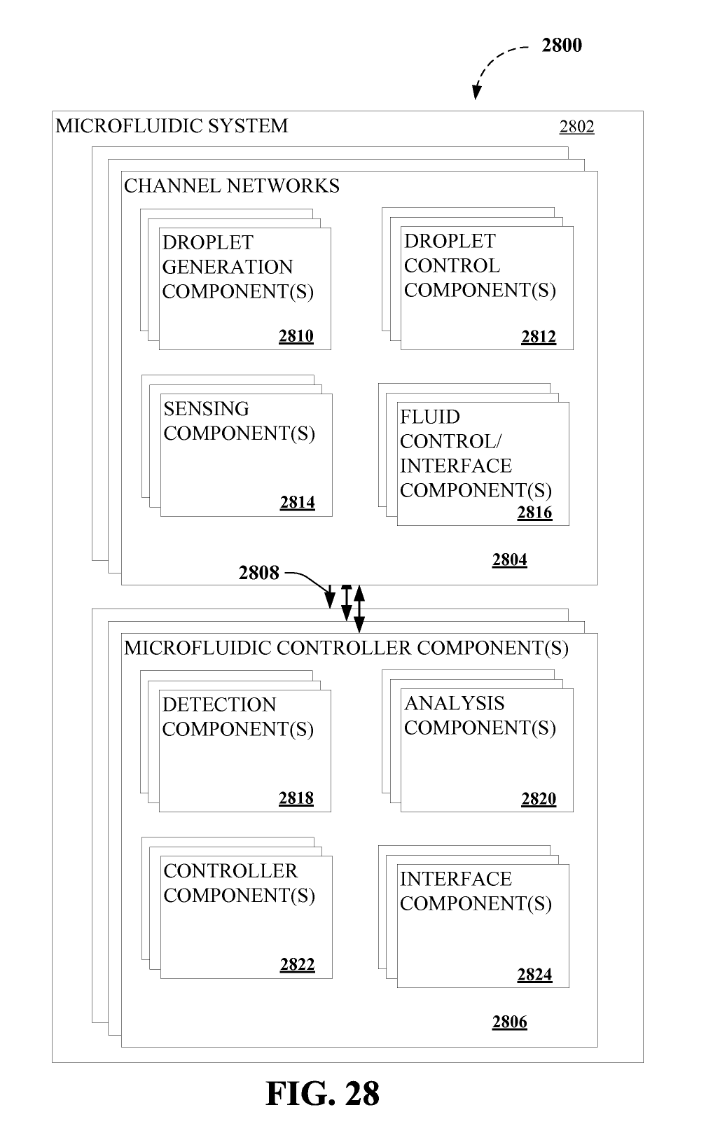

As a further non-limiting example, microfluidic chip controller component 1932 can comprise an analysis component 1942 adapted to store, study, predict, develop, and/or otherwise analyze detected and/or processed signal(s), set points, thresholds, and so on associated with one or more parameter(s) of a the various fluids (e.g., an ER fluid, a non-ER fluid, gases, etc.) as an aid to effecting microfluidic system control, as further described below, regarding FIG. 28, for example. In addition, in various non-limiting implementations, microfluidic chip controller component 1932 can comprise a controller component 1944 that can facilitate providing one or more coded signal(s) 1934, 1936 for droplet generation (e.g., first fluid droplet generation, second fluid droplet generation, etc.) as described above, for example, regarding FIGS. 3-8, etc. as well as to facilitate controlling, modulating, and/or manipulating operations such as reversing the order of a pair of droplets, adjusting droplet separation, and so on, via application of one or more electric field(s) generated by one or more electrode pair(s) (e.g., electrode pairs 1910, 1912, 1914, other electrode pairs associated with microfluidic chip 1900, etc.) in a network of channels to ER fluid 1906 (e.g., ER fluid, GER fluid, etc.). As can be seen in FIG. 19, controller component 1944 can be configured to send one or more coded signal(s) 1934, 1936 to one or more electrode pair(s) (e.g., electrode pairs 1910, 1912, 1914, other electrode pair(s) associated with microfluidic chip 1900, etc.) in a network of channels for droplet generation and/or control.

For instance, as can be seen in FIGS. 19-20, in the non-limiting portion of exemplary microfluidic chip 1900, droplet 1902 “A” and droplet 1902 “B” of a first fluid 1904 can be allowed to flow down the main input channel 1916. In the non-limiting time series of optical images 2002, 2004, 2006, and 2008, initially droplet 1902 “A” can lead (e.g., can be downstream of) droplet 1902 “B” in the main input channel 1916, as depicted in optical image 2002 (at time zero seconds (0 s)), for example. In various embodiments, electrode pair 1930 (labeled as “6” in 1922, optical images 2002, 2004, 2006, and 2008, 2100, etc.) can sense or detect that droplet 1902 “A” is in the proximity of electrode pair 1930 (e.g., approaching, adjacent, passing, passed, etc.) and can communicate this information to microfluidic chip controller component 1932.

In turn, microfluidic chip controller component 1932 can facilitate sending, at an appropriate time, one or more coded signal(s) 1934 (e.g., 300 Volts (300V)) to electrode pair 1914 (labeled as “7” in 1922, optical images 2002, 2004, 2006, and 2008, 2100, etc.) to apply an electric field to second branch channel 1920 so as to diminish or stop flow of ER fluid 1906 (e.g., ER fluid, GER fluid, etc.) employed as a carrier fluid in the second branch channel 1920 as depicted in optical image 2002 (at time zero seconds (0 s)). As a result, droplet 1902 “A” can be caused to flow from main input channel 1916 to first branch channel 1918 as depicted in optical image 2004 (at time 1.5 seconds (1.5 s)), for example. Later, electrode pair 1930 (labeled as 6) can sense or detect that droplet 1902 “B” is in the proximity of electrode pair 1930 (e.g., approaching, adjacent, passing, passed, etc.) and can communicate this information to microfluidic chip controller component 1932. Accordingly, microfluidic chip controller component 1932 can facilitate sending, again at an appropriate time, one or more coded signal(s) 1934 (e.g., 300 Volts (300V)) to electrode pair 1912 (labeled as “8” in 1922, optical images 2002, 2004, 2006, and 2008, 2100, etc.) to apply an electric field to first branch channel 1918 so as to diminish or stop flow of ER fluid 1906 (e.g., ER fluid, GER fluid, etc.) employed as a carrier fluid in the first branch channel 1918, while the one or more coded signal(s) 1934 to electrode pair 1914 can be removed (e.g., set to zero Volts (0V,) below a threshold, etc.) so as to reestablish, continue, or increase flow of ER fluid 1906 (e.g., ER fluid, GER fluid, etc.) employed as a carrier fluid in the second branch channel 1920 as in optical image 2004 (at time 1.5 seconds (1.5 s)).

As a result, droplet 1902 “B” can be caused to flow from main input channel 1916 to second branch channel 1920 while droplet 1902 “A” can be caused to remain relatively stationary (e.g., relative to the motion of droplet 1902 “B,” other droplets, etc.) as depicted in optical image 2006 (at time 5.5 seconds (5.5 s)), for example. Note that, as depicted in optical image 2006 (at time zero seconds (5.5 s)), the voltage applied to electrode pair 1912 (labeled as “8”) and electrode pair 1914 (labeled as “7”) indicates 0V, which indicates that the one or more coded signal(s) 1934 to electrode pairs 1912 and 1914 have been removed. Further note that droplet 1902 “A” has been delayed relative to droplet 1902 “B” as the droplets flow through order exchange component 1922. Consequently, as droplet 1902 “A” and droplet 1902 “B” approach main output channel 1926, droplet 1902 “B” now leads (e.g., is downstream of) droplet 1902 “A,” which is the reverse order as depicted in optical image 2002 (at time zero seconds (0 s)).

Thus, in various non-limiting embodiments, it can be understood that the relative rates at which one or more droplet(s) 1902 (e.g., droplet 1902 “A,” droplet 1902 “B,” etc.) flow through order exchange component 1922 can be controlled by microfluidic chip controller component 1932, for example, by sending one or more control signal(s) 1934, 1936, etc. to modulate one or more electric field(s) applied by one or more electrode pair(s) 1912, 1914, etc. in the one or more branch channel(s) (e.g., first branch channel 1918, second branch channel 1920, etc.), respectively. Additionally, in further non-limiting embodiments, flow of ER fluid 1906 (e.g., ER fluid, GER fluid, etc.) can be diminished or stopped in one or more of the branch channel(s) (e.g., first branch channel 1918, second branch channel 1920, etc.) for a predetermined period of time, for example, to facilitate a droplet in another of the one or more other branch channel(s) to overtake, increase, and/or reduce its separation relative to the droplet in the ‘halted’ branch channel (e.g., the branch channel with diminished or stopped ER fluid 1906 flow). Thus, as can be seen in FIG. 20 optical image 2008 (at time ten seconds (10 s)), droplet 1902 “B” has overtaken droplet 1902 “A,” and their order is reversed by the time they enter the main output channel 1926, as described above.

It is noted that, while first branch channel 1918 and second branch channel 1920 are similar in physical characteristics (e.g., length, width, number and placement of electrode pairs, etc.), it can be understood that various modifications can be implemented without departing from the scope of the disclosed subject matter. As a non-limiting example, in additional and/or alternative embodiments, order and/or separation of one or more droplet(s) 1902 can be facilitated by employing branch channels where one branch channel (e.g., one of first branch channel 1918 and second branch channel 1920, etc.) can be longer than the other, which can presumably increase channel transit time when compared to a shorter channel (e.g., at the same effective channel flow rate, etc.).

As described above, microfluidic chip controller component 1932 facilitates droplet 1902 generation such that droplets 1902 can be input into main input channel 1916 separated by a distance determined in part by microfluidic chip controller component 1932. Thus, when droplet 1902 (e.g., droplet 1902 “A,” droplet 1902 “B,” etc.) is proximate to electrode pair 1930 communicatively coupled to detection component 1938, microfluidic chip controller component 1932 can facilitate sending one or more control signal(s) 1934, 1936 to electrode pairs 1910, 1912, 1914, and/or other electrode pairs associated with microfluidic chip 1900, as further described below regarding FIG. 21. It can be understood that modulation of the one or more control signal(s) to these one or more electrode pair(s) can be varied according to requirements for the one or more droplet(s) 1902. Accordingly, order of the one or more droplet(s) 1902 can be switched (e.g., can be reversed from A-B to B-A in the droplet 1902 “A” and droplet 1902 “B” example, etc.) by properly controlling the duty cycle of applied voltages on the one or more electrode pair(s) (e.g., electrode pair(s) 1912 and 1914, etc.). In addition, droplets' 1902 separation (e.g., distance between one or more droplet(s) 1902) can be varied according to requirements for the one or more droplet(s) 1902.

Referring again to FIG. 21, exemplary schematic depiction 2100 of microfluidic chip 2102 depicts further aspects of microfluidic chip 1900 in which droplets 1902 of a first fluid 1904 can be generated and/or controlled in ER fluid 1906 (e.g., ER fluid, GER fluid, etc.) employed as a carrier fluid. In addition to functional characteristics and/or features as that described above, for example, regarding FIG. 19, etc., microfluidic chip 2102 can comprise one or more network(s) of channels (e.g., exemplary channel networks 2104, 2106, etc.) adapted to generate one or more droplet(s) comprised of one or more fluids (e.g., a first fluid 1904, a second fluid, a third fluid, etc.). In addition, for purposes of illustration and not limitation, microfluidic chip 302 can comprise a microfluidic chip having a chip size of approximately 3 cm×1.5 cm×0.4 cm. In further non-limiting aspects, cross section of a main channel (e.g., main input channel 1916) can be 200 μm in width and 100 μm in height, whereas channel width for one or more branch channel(s) (e.g., first branch channel 1918, second branch channel 1920, etc.) of an order exchange component 1922 can be 300 μm. It can be understood that while the exemplary dimensions are described for illustration and not limitation, different dimensions of microfluidic chips and channels could be employed.

In yet another non-limiting aspect, while exemplary channel networks 2104, 2106 are depicted in FIG. 21 as comprising exemplary flow-focusing junctions, such as described above regarding exemplary flow-focusing junction 1100 of FIG. 11, for example, exemplary channel networks 2104, 2106 can comprise other channel configurations suitable for droplet generation (e.g., such as an exemplary T-junction 1200 such as described above for example regarding FIG. 12, other channel configurations, combinations thereof, etc.). Accordingly, it can be understood that flow of ER fluid 1906 (e.g., ER fluid, GER fluid, etc.) in exemplary channel networks 2104 and 2106 can be controlled by one or more of associated electrode pair(s) (2108 and 2110 in exemplary channel network 2104 and 2112 and 2114 in channel network 2106, respectively) embedded into walls of associated channels (e.g., one or more of associated channel(s) 2116, 2118, 2120. 2122, etc.), as described above regarding FIG. 11, for example. In turn, as further described above, such control of ER fluid 1906 (e.g., ER fluid, GER fluid, etc.) in exemplary channel networks 2104 and 2106 can facilitate generation of one or more droplet(s), such as generation of one or more droplet(s) 1902 of a fluid (e.g., first fluid 1904, etc.) at channel 2124 in exemplary channel network 2104, for example. Likewise, control of ER fluid 1906 (e.g., ER fluid, GER fluid, etc.) in exemplary channel network 2106 can facilitate generation of one or more droplet(s), such as generation of one or more droplet(s) 1902 of a fluid (e.g., a first fluid 1904, a second fluid, etc.) at channel 2126 in exemplary channel network 2106, for example.

Thus, as further described above regarding FIGS. 19-20, initial droplet generation characteristics (e.g., size, spacing, order, etc.) can be controlled by microfluidic chip controller component 1932, for example, by sending one or more control signal(s) 1936, etc. to modulate electric fields applied by one or more electrode pair(s) 2108, 2110, 2112, 2114, etc. in the one or more exemplary channel network(s) 2104 and 2106, respectively, according to various non-limiting embodiments. As a result, a train 1908 of one or more droplet(s) 1902 of a fluid (e.g., a first fluid 1904, a second fluid, and so on, and any combination thereof etc.) can be generated in channel 2128, for example. In further non-limiting aspects, as further described above regarding FIGS. 19-20, for example, droplet train 1908 in channel 2128 can be subject to further logic and/or control operations, manipulations, directions, or other microfluidic chips, components, and/or subcomponents thereof (e.g., such as by being input to a main input channel 1916, microfluidic chip 302, droplet display or microfluidic chip 800, chip component 1002, etc.).

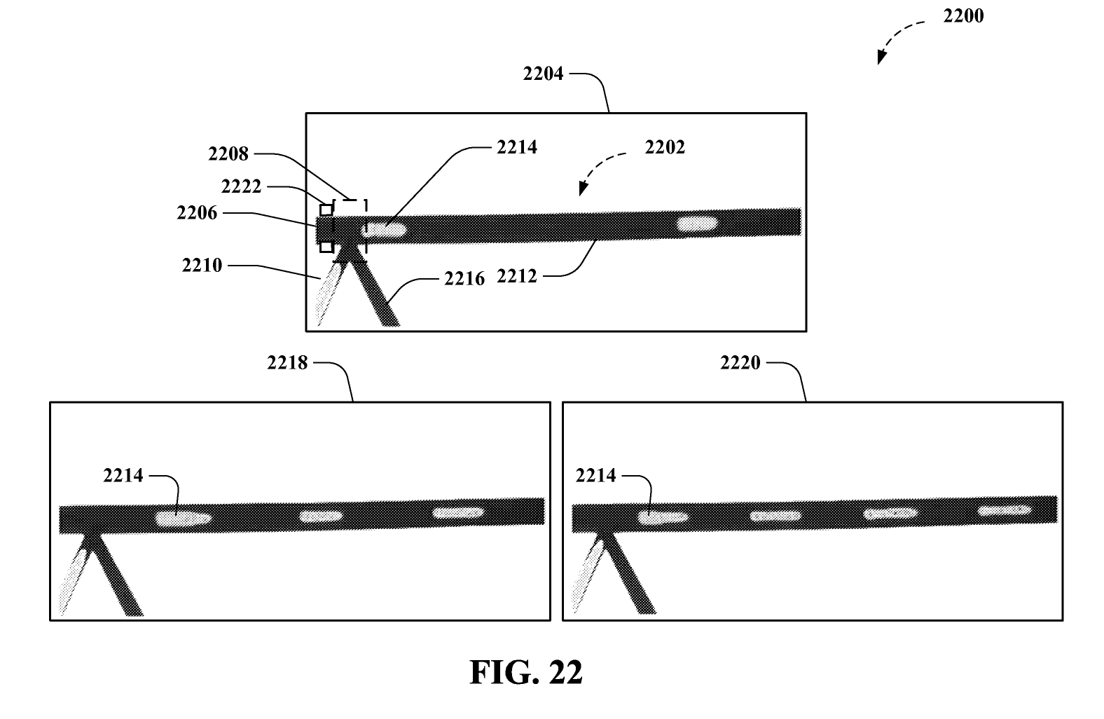

As described above, reference to droplets (e.g., of a non-ER fluid), can comprise either or both liquid droplets and gaseous droplets (e.g., bubbles of a gas) in various non-limiting implementations. Thus, it can be understood that a first fluid in an ER fluid (e.g., ER fluid, GER fluid, etc.) as a second fluid (e.g., a carrier fluid, etc.) can comprise any number and/or types of fluid (e.g., a first fluid, water, liquids, gases, chemicals, reagents, biological agents, etc.) as exemplified above. In further non-limiting examples, FIGS. 22-24 depict optical images of an exemplary channel network 2202 in which nitrogen (N₂) bubbles have been generated under different gas pressures at the same flow rate of carrier fluid (e.g., ER fluid, GER fluid, etc.). For example, as can be seen in optical image 2204, exemplary channel network 2202 can comprise a first channel 2206 (e.g., a channel adapted to convey ER fluid, GER fluid, etc.) to a junction 2208 that can connect to one or more channel(s) such as a second 2210 (e.g., a channel adapted to provide N₂ to junction 2208) and third 2212 channel (e.g., a channel adapted to convey carrier fluid and bubbles of gas, such as one or more N₂ gas bubble(s) 2214). In further non-limiting implementations, exemplary channel network 2202 can comprise a fourth channel 2216 (e.g., one or more channel(s) adapted to carry carrier fluid displaced by bubble generation away from junction 2208).

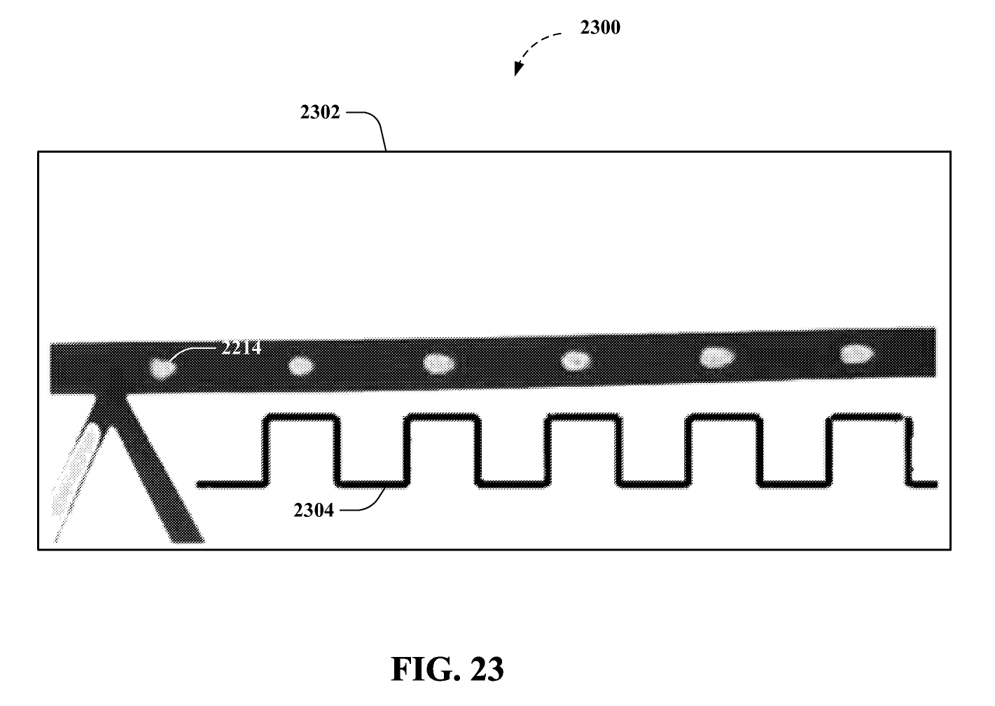

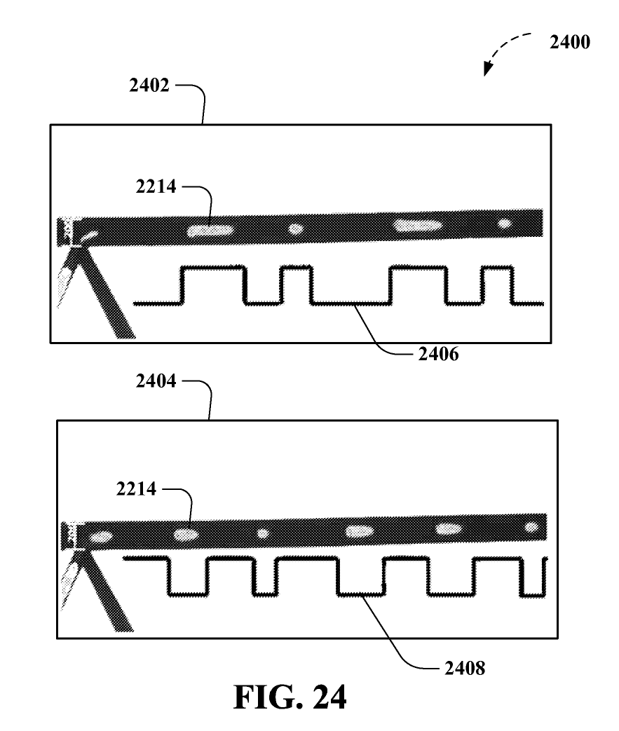

Accordingly, FIG. 22 depicts exemplary optical images 2204, 2218, and 2220 of N₂ gas bubble 2214 generation at a N₂ pressure P=4.0 kPa (2204), 6.33 kPa (2218), and 6.8 kPa (2220) with no electrical control signal applied. As a further non-limiting example, FIG. 23 depicts an optical image 2302 of N₂ gas bubble 2214 generation at a N₂ pressure P=6.8 kPa and with an exemplary electrical control signal 2304 having period, T=400 ms, applied. In yet other non-limiting examples, FIG. 24 depicts optical images 2402 and 2404 of N₂ gas bubble 2214 generation at a N₂ pressure P=6.8 kPa and with differently coded electrical control signals 2406 and 2408 applied, respectively. It is noted that while the cross section of the exemplary channel depicted in FIGS. 22-24 can comprise a channel of 200 μm in width, various non-limiting embodiments of the disclosed subject matter are not so limited. In addition, while the non-limiting implementations depicted in FIGS. 22-24 can employ an ER fluid (e.g., ER fluid, GER fluid, etc.) as a carrier fluid for gaseous droplet generation, it is also noted that further non-limiting implementations can employ other non-ER fluid(s) (e.g., oils, such as sunflower oil, etc.).

Thus, it can be seen that in various non-limiting implementations, the disclosed subject matter can facilitate adjusting and/or controlling bubble size (e.g., size of N₂ gas bubble(s) 2214, other gaseous bubbles, etc.), for example, by adjusting pressure of gas supplied to exemplary channel network 2202 via second channel 2210. In other non-limiting embodiments, the disclosed subject matter facilitates adjusting and/or controlling bubble size via controlling, modulating, and/or manipulating applied electrical signals as depicted above, regarding FIG. 24, without changing the gas pressure. This can be seen in FIGS. 22-24, for example, such as in optical images 2220, 2302, 2402, 2404, where N₂ gas bubble 2214 generation is depicted at a consistent N₂ pressure P=6.8 kPa and with no (2220) or differently coded electrical control signals 2304, 2406, and 2408 applied, respectively. As a further non-limiting example, encoded N₂ gas bubbles 2214 having different sizes and spacing are depicted in FIG. 24, which can be advantageously generated (e.g. generated digitally, etc.). For instance, the disclosed subject matter facilitates generation of gas bubbles 2214 having different sizes and spacing by adjusting time duration of an applied field to ER fluid (e.g., ER fluid, GER fluid, etc.) employed as a carrier fluid for gaseous droplet generation via an associated electrode pair (e.g., electrode pair 2222) similar to that described above regarding FIGS. 19-21, for example.

Accordingly, in FIGS. 22-24, N₂ gas bubbles 2214 can be generated, for example, when a signal sent to electrode pair 2222 is of sufficient strength (e.g., above a given threshold, signal high, at a pulse, etc.). This can be understood by noting that when a signal sent to electrode pair 2222 is of sufficient strength, flow of ER fluid (e.g., ER fluid, GER fluid, etc.) can be diminished and/or stopped (e.g., temporarily or otherwise, etc.), which can enable gas to easily enter junction 2208. In addition, it is further noted that further, additional, and/or alternative control of gas bubbles (e.g., N₂ bubbles, etc.) can also be achieved by using a similar microfluidic chips as described above regarding FIGS. 3, 8, 10, 19-21, etc. Thus, in various non-limiting implementations the disclosed subject matter can facilitate gaseous bubble generation and/or control, which can be advantageously employed, for example, in digital microfluidics, microfluidic bio-systems, etc.

It should be noted that yet other configurations, arrangements, structures, and embodiments are possible according to the disclosed subject matter. Thus, according to exemplary non-limiting implementations the disclosed subject matter provides microfluidic devices that facilitate generating and/or controlling one or more fluid droplet(s), for example, as described herein regarding FIGS. 1-3, 8-12, 17-24, 26, 28-30. In a non-limiting aspect, an exemplary microfluidic device (e.g., microfluidic chip 302, droplet display or microfluidic chip 800, chip component 1002, flow-focusing junction 1100, T-junction 1200, portion of a microfluidic chip 1900, etc.) can comprise a fluid channel network having one or more associated electrode(s).

For instance, as describe herein, a fluid channel network can comprise one or more channel(s) or fluid channel(s) adapted to contain, store, carry, direct, guide, deliver, or otherwise serve as a conduit for flow of a fluid of interest in a microfluidic application. Thus, it can be understood that, in various aspects, a “fluid channel network” can comprise one or more connection(s) to one or more other channel(s), fluid channel(s), junction(s), other channel network(s) and/or fluid channel network(s), and/or other component(s), subcomponent(s), or portion(s) thereof (e.g., one or more connection(s) to one or more sensor(s), valve(s), heat exchanger(s), flow controller(s), fluid accumulator(s) or reservoir(s), such as liquid, and/or gas accumulator(s) or reservoir(s), etc., connection(s) to liquid(s) and/or gas supply/supplies, connection(s) to liquid(s) and/or gas reaction vessel(s), disposal line(s), chemical and/or biological assay(s), biological tissue(s), such as blood vessel(s), or other fluid carrying tissue(s), etc.).

Additionally, in further exemplary microfluidic devices, the fluid channel network can be adapted to carry an ER fluid (e.g., ER fluid, GER fluid, such as ER 104, etc.) and one or more of a non-ER fluid (e.g., a fluid that lacks significant electrorheological effect relative to the ER fluid, etc.) or a gas (e.g., N₂, a liquid vapor, etc.). Moreover, in further non-limiting aspects, a fluid channel network can also comprise one or more associated electrode(s) adapted to send and/or receive an electrical signal (e.g., a detected signal, an electrical control signal, etc.) that can facilitate one or more of generation and controlling or manipulating one or more fluid droplet(s). Accordingly, as described above, in yet other non-limiting implementations, the one or more associated electrode(s) of embodiments of the exemplary microfluidic devices can be adapted to receive an electrical signal, for example, to apply an electric field to a portion of the fluid channel network to change or influence (e.g., stop, start, accelerate, slow, increase, diminish, etc.) flow of the ER fluid (e.g., ER fluid, GER fluid, such as ER 104, etc.) in the fluid channel network to facilitate generating and/or controlling or manipulating one or more fluid droplet(s) (e.g., one or more ER fluid droplet(s), non-ER fluid droplet(s) comprising a fluid that lacks significant electrorheological effect relative to the ER fluid, gas bubble(s), combinations thereof, etc.).

In still other exemplary microfluidic devices, the fluid channel network can be further configured to generate one or more fluid droplet(s) as described herein, regarding FIGS. 1-6, 8-12, 15-24, etc., for example. In non-limiting examples, the fluid channel network can comprise one or more of a flow-focusing junction or a T-junction, for example, where the one or more of a flow-focusing junction or a T-junction can be adapted to generate one or more fluid droplet(s). In yet other non-limiting implementations, fluid channel network(s) of exemplary microfluidic devices can be further configured to control or manipulate one or more fluid droplet(s) as described herein, regarding FIGS. 1-6, 8-12, 15-24, etc., for instance. In still other non-limiting examples, the fluid channel network can be further configured to facilitate one or more of droplet fission, droplet fusion, droplet sorting, droplet encoding, droplet digitalizing, droplet directional switching, droplet storage, droplet disposal, droplet order exchange, droplet arrangement, droplet size, shape, spacing, or sequence specification, determining relative position of different types of droplets, or droplet display as described herein, as well as other control or manipulation functions as desired.

### Exemplary Microfluidic Channel Fabrication

By way of non-limiting example, FIG. 25 depicts a diagram that illustrates fabrication 2500 of an exemplary non-limiting microfluidic channel mold in accordance with various aspects of the disclosed subject matter as an aid to further understand various non-limiting implementations of the disclosed subject matter. For instance, non-limiting aspects of microfluidic chips have been described above regarding FIGS. 3, 19, 21, etc. According to various non-limiting implementations, the disclosed subject matter can employ soft lithographic process to facilitate microfluidic chip fabrication. It can be understood that microfluidic chip fabrication can also employ other appropriate processes.

By way of non-limiting overview, a mold 2502 can be formed by coating a substrate 2504 (e.g., a wafer, such as a silicon wafer, glass, etc.) with a set of one or more photoresist(s) (e.g., one or more of a first photoresist 2506, a second photoresist 2508, etc.) and patterning the one or more photoresist(s) by selective exposure to light. In various non-limiting implementations, two different photoresists can be employed. For instance, a first photoresist 2506 can be used to create one or more mold(s) that facilitate fabricating fluid channels, while the second photoresist 2508 can be used to create one or more mold(s) that facilitate fabricating one or more cavity/cavities for receiving one or more electrode(s), conducting line(s), etc.

For example, a first photoresist 2506 (e.g., a negative photoresist, SU-8 photoresist, etc.) can be used fabricate one or more channel mold(s) (e.g., channel molds 2510, 2512, etc.), for example, such as by spin coating a layer of sufficient thickness. After selective exposure to light (e.g., exposure of light through an appropriately patterned photomask, scanning a beam of light or particles, etc.), channel molds 2510, 2512, can be developed. In further non-limiting implementations, first 2506 and second 2508 photoresists can have the same or substantially the same thickness (e.g., height above the substrate). In other non-limiting implementations, second photoresist 2508 can be removed (e.g., developed) by an organic solvent (e.g. acetone, etc.), while the first photoresist 2506 type would not be as susceptible the organic solvent (e.g., would resist being removed by the organic solvent). In a further non-limiting example, first photoresist 2506 can comprise a negative photoresist (e.g., SU-8 photoresist, etc.), and second photoresist 2508 can comprise a positive photoresist (e.g., AZ-4903, etc.). Thus, in further non-limiting implementations, the disclosed subject matter can employ SU-8 to facilitate fabricating one or more fluid channel mold(s) (e.g., channel molds 2510, 2512, etc.) of a thickness of approximately 80 to 90 μm, whereas AZ-4903 can be employed (e.g., using first 2514 and second 2516 coatings of AZ-4903, such as by spin coating layer(s) of sufficient thickness) facilitate fabricating one or more cavity/cavities (e.g., cavities 2518 and 2520) for receiving one or more conducting line(s) and/or electrode(s) (e.g., also of a thickness of approximately 80 to 90 μm).

Thus, in various non-limiting implementations, mold 2502 can accept a PDMS gel or pre-polymer, for example, that can be poured into mold 2502 and allowed to solidify. Accordingly, it can be understood that a PDMS gel can adopt a desired shape having one or more fluid channel(s) facilitated by the one or more fluid channel mold(s) (e.g., channel molds 2510, 2512, etc.) and/or one or more cavity/cavities for receiving the conductive material for the electrodes and conducting lines (e.g., such as facilitated by one or more of cavities 2518 and 2520, etc.). In yet other non-limiting implementations, one or more PDMS electrode(s) (not shown) can be patterned with a conducting particle/PDMS-based conducting composite (e.g., a carbon-black/PDMS mixture, Ag-PDMS, etc.). For example, a carbon-black/PDMS mixture can be placed on substrate 2504 with one or more channel mold(s) (e.g., one or more of channel molds 2510, 2512, etc.). In further non-limiting implementations, after solidification, the PDMS can be removed from mold 2502 and can be finished, for example, by sealing the top of the PDMS with another piece of PDMS to enclose channels and electrodes. As a result, it can be understood that microfluidic chip fabrication can be completed, for example, after curing and bonding to another piece of PDMS and/or embedding electrodes pairs in associated channel walls.

While a brief overview has been provided to aid in understanding microfluidic chip fabrication, it can be understood that the disclosed subject matter is not so limited. For example, a further detailed description of microfluidic chip fabrication processes is provided below. As described above, it can be understood that microfluidic chip fabrication can employ other appropriate processes. Thus, microfluidic chip fabrication can include steps preparatory to chip fabrication (e.g., mold 2502 creation, etc.), mold fabrication, etc. as well as fabrication of a microfluidic chip itself.

In non-limiting examples, a substrate 2504 (e.g., a glass wafer, silicon wafer, etc.) can be prepared, for example, by cleaning with an appropriate cleaning solution, (e.g., ammonium hydroxide (NH₄OH): hydrogen peroxide (H₂O₂):water (H₂O), such as in 1:1:5 ratio by volume ratio, etc.) for an appropriate time and at an appropriate temperature (e.g., 70° C. for 15 minutes (min.)), rinsing with de-ionized water to remove the cleaning solution, and then drying with compressed N₂ gas. In addition, substrate 2504 can be baked (e.g., in an oven at 120° C. for 30 min.) drive water off of the substrate 2504 surface and then allowed to cool to room temperature.

As described above, in further non-limiting examples, negative photoresist (e.g., first photoresist 2506, SU-8, etc.) can be spin coated onto substrate 2504 at a suitable spin rate and time (e.g., 500 revolutions per minute (rpm) for 10 seconds (s), then 1000 rpm for 30 s for SU-8 2025, 500 rpm for 10 s, and then 1700 rpm for 30 s for SU-8 2050, and so on, etc.). Alternatively, other photoresist(s) could be used to achieve the same desired thickness, and other characteristics (e.g., developer and/or solvent susceptibility, etc.). In addition, sides of substrate 2504 can be cleaned carefully to ensure that the surface of first photoresist provides a substantially flat surface when substrate 2504 is placed on a level clean surface for a sufficient time. Then substrate 2504 can be soft baked (e.g., soft-baked on a hotplate, for example, at 65° C. for 5 min., then 95° C. for 15 min., and then 65° C. for 2 min., etc.), after which, substrate 2504 can be placed on a level clean surface for a period of time (e.g., at least 10 min.).

In yet further non-limiting examples, substrate 2504 coated with first photoresist 2506 can be patterned with a mask having the desired pattern while exposing the photoresist 2506 to a predetermined exposure energy (e.g., about 600 kilojoules per square centimeter (mJ/cm²), etc.), after which, substrate 2504 having exposed first photoresist 2506 can be placed on a level clean surface for a period of time (e.g., at least 10 min.) to allow completion of the reaction in first photoresist 2506. Then, in further examples, substrate 2504 can be hard baked (e.g., hard baked on a hotplate at 65° C. for 5 min., then 95° C. for 10 min., and then 65° C. for 2 min.), for example, to allow for solvent evaporation, and can then be placed on a level clean surface for a period of time (e.g., at least 10 min.). In addition, substrate 2504 can then be developed in an appropriate developer (e.g., SU-8 developer, etc.) for a predetermined time (e.g., around 10 minutes, etc.) to ensure unexposed SU-8 is removed from substrate 2504. Thus, exposed and developed substrate 2504 can be checked and then cleaned with isopropanol (IPA) and dried with compressed N₂ gas.

In still other non-limiting examples, positive photoresist (e.g., second photoresist 2508, AZ-4903, etc.) can be hand coated onto substrate 2504 and the first resist 2506 pattern (e.g., SU-8 pattern) and then can be spun at a suitable spin rate and time (e.g., 500 rpm for 5 s and then 800 rpm for 30 s for SU-8 2050, and so on, etc.) to create a first coating 2514 of second photoresist 2508 (e.g., a first coating 2514 of AZ-4903, etc.). In addition, sides of substrate 2504 can be cleaned carefully to ensure that the surface of first photoresist provides a substantially flat surface when substrate 2504 is placed on a level clean surface for a sufficient time (e.g., 3 min.). Then substrate 2504 can be baked (e.g., baked on a hotplate, for example, at 50° C. for 5 min., then 110° C. for 3 min., etc.), after which, substrate 2504 can be placed on a level clean surface for a period of time (e.g., to cool to room temperature). In addition, a second coating 2516 of second photoresist 2058 (e.g., a second coating 2516 of AZ-4903, etc.) can be created (e.g., hand coated and then spun as described for first coating 2514) and baked (e.g., baked on a hotplate, for example, at 50° C. for 5 min., and then 110° C. for 8 min.), after which, substrate 2504 can be placed on a level clean surface for a period of time (e.g., to cool to room temperature). In further non-limiting examples, portions of substrate 2504 can be cleaned as desired (e.g. areas of substrate 2504 having small structures of SU-8 pattern at the side substrate 2504, etc.), which can include removing portions of second photoresist 2508 (e.g., AZ-4903) from such areas by use of a suitable solvent (e.g., acetone), such that the areas can be readily seen during subsequent alignment operations.

According to further non-limiting examples, an appropriately patterned photomask can be placed proximate to the coated substrate 2504 surface (e.g., placed on the surface coated substrate 2504, etc.) and aligned (e.g., aligned under microscope). Thus, the coated and masked substrate 2504 can be exposed to ultraviolet (UV) light with exposure energy of approximately 2000 mJ/cm², after which, substrate 2504 having exposed second photoresist 2508 can be placed on a level clean surface for a period of time (e.g., at least 10 min.) to allow completion of the reaction in second photoresist 2508. In addition, substrate 2504 can then be developed in an appropriate developer (e.g., a developer solution comprising AZ 400K:H₂O in a 1:3 ratio by volume for AZ-4903, etc.) for a predetermined time (e.g., around 10 minutes, etc.) to ensure all exposed second photoresist 2508 (e.g., AZ-4903) is removed from substrate 2504. Thus, exposed and developed substrate 2504 can be checked and then cleaned with deionized water and dried with compressed N₂ gas. As can be seen in FIG. 25, the resultant mold 2502 can comprise one or more cavity/cavities (e.g., cavities 2518 and 2520) for receiving one or more conducting line(s) and/or electrode(s) and one or more channel mold(s) (e.g., channel molds 2510, 2512, etc.).

Accordingly, further non-limiting examples of microfluidic chip fabrication can include employing a mold 2502, as described above, to facilitate further steps in microfluidic chip fabrication (e.g., electrode creation, channel creation, etc.). For instance, surface treatment of mold 2502 can comprise actions taken to avoid having electrode and/or conductive line material (e.g., a carbon-black/PDMS mixture, Ag-PDMS, etc.) from sticking to the surface substrate 2504, such as, by evaporating silane on the surface of the surface substrate 2504 under vacuum conditions, for example.

In still other non-limiting examples, a PDMS gel or pre-polymer, for example, can be poured into mold 2502 and allowed to solidify. In a non-limiting aspect, a PDMS gel can be fabricated (e.g., by mixing a base and curing agent at a 10:1 ratio by weight, etc.). Accordingly, electrode material (e.g. Ag micro-particles of 1-2 μm size, etc.) can be mixed with PDMS gel (e.g., mixed in a ratio of 6.8:1 by weight, etc.). The mixture can then be filled into the one or more cavity/cavities (e.g., cavities 2518 and 2520) on mold 2502 created on substrate 2504. In addition, redundant parts can be removed, for example by scrubbing face-down first with a flat smooth scrubber (e.g., a flat smooth scrubber such as typing paper, etc.) and then with a smoother scrubber (e.g., a relatively smoother scrubber such as weighing paper, etc.).

After baking (e.g., baking in an oven at 60° C. for 30 min., etc.) the assembly (e.g., mold 2502 having one or more cavity/cavities filled with electrode material/PDMS gel) can be bathed in a suitable solvent (e.g., acetone) for a suitable time (e.g., about 1 minute) to remove second photoresist 2508 (e.g., AZ4903), which solvent can then be removed (e.g., by bathing in ethanol, for example, to remove acetone, which ethanol can, in turn, be removed with deionized water, etc.), and the assembly can then be baked (e.g., baked in an oven at 60° C. for 10 min., etc.). In further non-limiting examples, one or more channel(s) can be fabricated. For example, a PDMS gel (e.g., a PDMS gel fabricated by mixing a base and curing agent at a 10:1 ratio by weight, etc.) of approximately 2 mm thickness (e.g., height above substrate 2504) can be poured on the surface of mold 2502, which assembly can be baked (e.g., baked in an oven at 60° C. for approximately 120 min., etc.) to create a cured PDMS slab over the mold 2502. Thus, the cured PDMS slab can be carefully removed from mold 2502 and holes can be formed (e.g., drilled, etc.) to create one or more port(s) (e.g., inlet ports, outlet ports, sensor ports, etc.). In addition, to complete an exemplary microfluidic chip fabrication, PDMS gel (e.g., a PDMS gel fabricated by mixing a base and curing agent at a 10:1 ratio by weight, etc.) of approximately 1 mm thickness can be poured on a flat surface and then be baked (e.g., baked in an oven at 60° C. for approximately 20 min., etc.) until slightly sticky (e.g., almost solidified). In further examples, the cured PDMS slab as described above can be placed on the surface of the almost-solidified PDMS layer, which can thus form a roof or top surface of the microfluidic chip to complete fabrication of the channels. In addition, after baking (e.g., baking in an oven at 60° C. for 30 min., etc.) to complete solidification of the almost-solidified PDMS layer, the whole assembly can be heated (e.g., heated on a hotplate at 150° C. for approximately 120 min., etc.) to ensure that the electrode material (e.g., conducting particle/PDMS-based conducting composite, carbon-black/PDMS mixture, Ag-PDMS, etc.) is readily conductive.

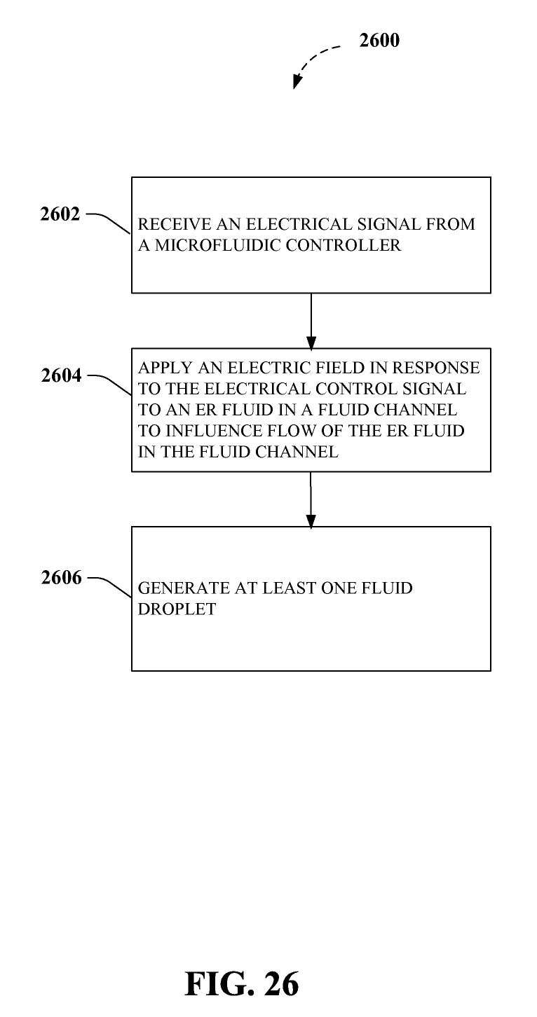

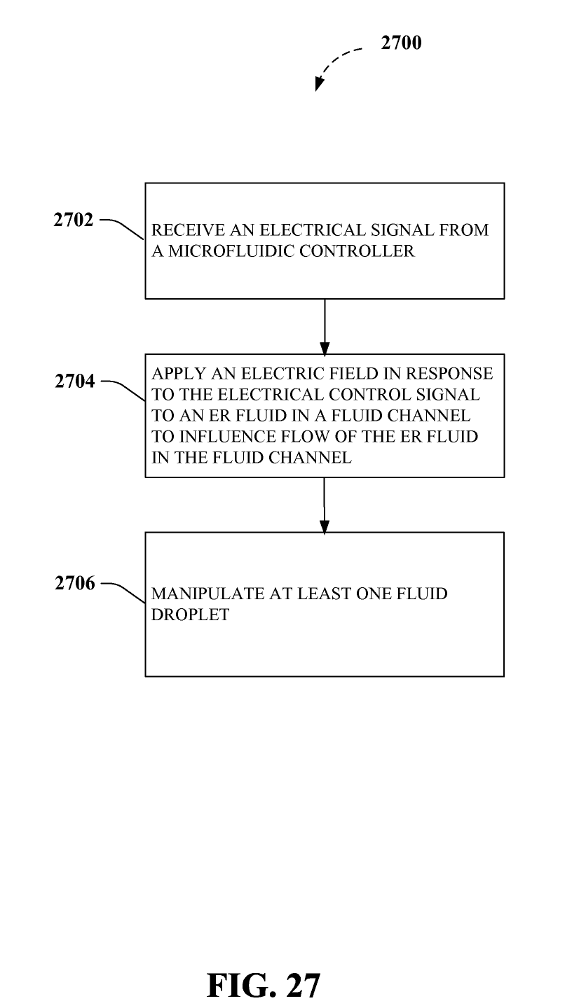

In view of the structures and devices described supra, methodologies that can be implemented in accordance with the disclosed subject matter will be better appreciated with reference to the flowcharts of FIGS. 26-27. While for purposes of simplicity of explanation, the methodologies are shown and described as a series of blocks, it is to be understood and appreciated that such illustrations or corresponding descriptions are not limited by the order of the blocks, as some blocks may occur in different orders and/or concurrently with other blocks from what is depicted and described herein. Any non-sequential, or branched, flow illustrated via a flowchart should be understood to indicate that various other branches, flow paths, and orders of the blocks, can be implemented which achieve the same or a similar result. Moreover, not all illustrated blocks may be required to implement the methodologies described hereinafter.

### Exemplary Methodologies

FIGS. 26-27 depict flowcharts demonstrating various aspects of exemplary non-limiting methodologies that facilitate microfluidic droplet generation, manipulation, and/or control. It should be understood that the various stages are depicted for ease of explanation and not limitation. For instance, it can be understood that such illustrations or corresponding descriptions are not limited by the number, order, or lack of inclusion of particular stages, as some stages may occur in different orders and/or concurrently with other stages from what is depicted and described herein. In other instances, suitable alternatives or arrangements for fabricating a particular feature or accomplishing a particular function can be devised that can be substituted for one or more stage(s) or added thereto. Accordingly, the following description is merely intended to describe a subset of possible alternatives enabled by the disclosed structures, devices, and methodologies as described herein.

As a non-limiting example, FIG. 26 depicts a flowchart demonstrating various aspects of exemplary non-limiting microfluidic methodologies 2600 that facilitate microfluidic droplet generation, manipulation, and/or control. For instance, at 2602, an electrical signal can be received (e.g., received from a microfluidic controller, a portion thereof, etc,). For example, a microfluidic controller component, as described supra, regarding FIGS. 3-10, 19-24, etc., for example, can be communicatively coupled (e.g., able to send and/or receive signals, via signal lines, etc.) to one or more channel network(s), portion(s), component(s), or subcomponent(s) thereof. As a further example, the microfluidic controller component can send one or more electrical signal(s) (e.g., coded signal(s), digital signal(s), electrical control signal(s), etc.) to one or more electrode(s) associated with the one or more channel network(s) to facilitate microfluidic droplet generation, manipulation, and/or control as described above regarding FIGS. 3, 8, 19-24, etc., for example.

In further non-limiting microfluidic methodologies 2600, in response to the electrical control signal, an electric field can be applied to an ER fluid (e.g., ER fluid, GER fluid, etc.) in a fluid channel to influence flow of the ER fluid in the fluid channel at 2604. In various non-limiting implementations of the disclosed subject matter, applying an electric field to an ER fluid (e.g., ER fluid, GER fluid, etc.) in a fluid channel can facilitate generating and/or manipulating one or more fluid droplet(s) in the fluid channel. In a non-limiting example, as described above regarding FIGS. 3, 6-8, 19-24, etc., for example, embodiments of the disclosed subject matter can influence flow of the ER fluid (e.g., ER fluid, GER fluid, etc.) and/or ER droplets (e.g., ER droplets, GER droplets, etc.) by application of an electric field (e.g., by excitation of one or more electrode(s), which, according to exemplary implementations, can be embedded into a wall of associated channel(s) carrying the ER fluid (e.g., ER fluid, GER fluid, etc.).

According to various aspects, ER fluid (e.g., ER fluid, GER fluid, etc.) or one or more droplet(s) can be caused to stop temporarily by employing an electric field of sufficient strength (e.g., an electric field above a certain threshold), which can be dependent upon, for example, flow rate(s), density of ER particles in one or more droplet(s) or ER fluid (e.g., ER fluid, GER fluid, etc.), ER material used, dimensions of the channel (e.g., width and height of channel etc.). In further non-limiting aspects of microfluidic methodologies 2600, generating and/or manipulating one or more fluid droplet(s) in the fluid channel at 2604 can include generating or manipulating one or more of an ER fluid droplet (e.g., ER fluid droplet, GER fluid droplet, etc.), a non-ER fluid droplet including a fluid that lacks significant electrorheological effect relative to the ER fluid (e.g., ER fluid, GER fluid, etc.), a gas bubble, etc.

In yet other exemplary microfluidic methodologies 2600, at 2606, a fluid droplet can be generated. For instance, as described above regarding FIGS. 3, 8, 19-24, etc., for example, fluid droplets (e.g., ER fluid droplets, GER fluid droplets, non-ER fluid droplets, gas bubbles, etc. can be formed by one or more of a flow-focusing junction, a T-junction, or other suitable arrangement(s), etc. Moreover, in further non-limiting aspects of microfluidic methodologies 2600, at 2606, fluid droplets one of a predetermined droplet size, predetermined droplet shape, predetermined droplet separation an adjacent droplet, predetermined droplet timing relative to another droplet, etc. can be generated, as described above, for example, regarding FIGS. 3-8, 13-24, etc.

In further non-limiting examples of microfluidic methodologies 2700, FIG. 27 depicts a flowchart demonstrating various aspects facilitate microfluidic droplet generation, manipulation, and/or control. For example, at 2702, an electrical signal can be received (e.g., received from a microfluidic controller, a portion thereof, etc,). For instance, a microfluidic controller component, as described supra, regarding FIGS. 3-10, 19-24, etc., for example, can be communicatively coupled (e.g., able to send and/or receive signals, via signal lines, etc.) to one or more channel network(s), portion(s), component(s), or subcomponent(s) thereof. In yet another example, the microfluidic controller, a component, or portion thereof can send one or more electrical signal(s) (e.g., coded signal(s), digital signal(s), electrical control signal(s), etc.) to one or more electrode(s) associated with the one or more channel network(s) to facilitate microfluidic droplet generation, manipulation, and/or control as described above regarding FIGS. 3, 8, 19-24, etc., for example.

In still further non-limiting microfluidic methodologies 2700, at 2704, an electric field can be applied to an ER fluid (e.g., ER fluid, GER fluid, etc.) in a fluid channel to influence flow of the ER fluid in the fluid channel in response to the electrical control signal. In further non-limiting implementations, applying an electric field to an ER fluid (e.g., ER fluid, GER fluid, etc.) in a fluid channel can facilitate generating and/or manipulating one or more fluid droplet(s) in the fluid channel. In still other non-limiting examples, as described above regarding FIGS. 3, 6-8, 19-24, etc., for example, embodiments of the disclosed subject matter can influence flow of the ER fluid (e.g., ER fluid, GER fluid, etc.) and/or ER droplets (e.g., ER droplets, GER droplets, etc.) by application of an electric field (e.g., by excitation of one or more electrode(s), which, according to exemplary implementations, can be embedded into a wall of a channel carrying the ER fluid (e.g., ER fluid, GER fluid, etc.).

According to various aspects, ER fluid (e.g., ER fluid, GER fluid, etc.) or one or more droplet(s) can be caused to stop temporarily by employing an electric field of sufficient strength (e.g., an electric field above a certain threshold), which can be dependent upon, for example, flow rate(s), density of ER particles in one or more droplet(s) or ER fluid (e.g., ER fluid, GER fluid, etc.), ER material used, dimensions of the channel (e.g., width and height of channel etc.). In further non-limiting aspects of microfluidic methodologies 2700, generating and/or manipulating one or more fluid droplet(s) in the fluid channel at 2704 can include generating or manipulating one or more of an ER fluid droplet (e.g., ER fluid droplet, GER fluid droplet, etc.), a non-ER fluid droplet including a fluid that lacks significant electrorheological effect relative to the ER fluid (e.g., ER fluid, GER fluid, etc.), or gas bubble, etc.

In yet other exemplary microfluidic methodologies 2700, at 2706, a fluid droplet can be manipulated, for instance, as described above regarding FIGS. 3, 8, 19-24, etc. For example, fluid droplets (e.g., ER fluid droplets, GER fluid droplets, non-ER fluid droplets, gas bubbles, etc. can be manipulated, for example, by accomplishing one or more of droplet fission, droplet fusion, droplet sorting, droplet encoding, droplet digitalizing, droplet directional switching, droplet storage, droplet disposal, droplet order exchange, droplet arrangement, droplet size, shape, spacing, or sequence specification, determining relative position of different types of droplets, droplet display for one or more fluid droplet(s), as described herein.

In yet other exemplary implementations of the disclosed subject matter, microfluidic methodologies can comprise generating droplets of ER fluid (e.g., ER fluid, GER fluid, etc.). For instance, as described above for example, regarding FIGS. 1-3, 8, 11, 12, etc., generating droplets (e.g., droplets 102, 326, etc.) of ER fluid (e.g., ER fluid, GER fluid, ER 104, etc.) can include directing a stream of ER fluid (e.g., ER fluid, GER fluid, etc.) in a first channel (e.g., first channel 308, etc.) and a stream of carrier fluid (e.g., carrier fluid 106, such as an oil, etc.) in a second channel (e.g., one or more of a second 310 and a third 312 channel, etc.) to a junction (e.g., a junction 316, etc.) between the first channel, the second channel, and a fourth channel (e.g., fourth 314 channel, etc.), so as to form one or more droplet(s) (e.g., droplet(s) 102, 326, etc.) of ER fluid (e.g., ER fluid, GER fluid, ER 104, etc.) carried by carrier fluid (e.g., carrier fluid 106, such as an oil, etc.) in the fourth channel. As a further example, generating droplets can further include applying an electrical signal (e.g., one or more control signal(s) such as control signal(s) 116, 216, 330, 332, 814, etc.) to a pair of associated electrodes in the first channel (e.g., pair 324 of electrodes facing each other on opposite sides of first channel 308, etc.) so as to control, change, or otherwise influence flow of ER fluid (e.g., ER fluid, GER fluid, ER 104, etc.) in the first channel to facilitate controlling the characteristics such as size, frequency, etc. of droplets (e.g., droplets 102, 326, etc.) of ER fluid (e.g., ER fluid, GER fluid, ER 104, etc.) entering the fourth channel.

In various non-limiting implementations, the junction (e.g., a junction 316, etc.) can include a flow-focusing junction, a T-junction having a second channel (e.g., second side channel 1206), which according to further non-limiting aspects, can be at angles other than right angles (e.g., not equal to 90 degrees, not substantially perpendicular, etc.). In further non-limiting implementations, one or more of first (e.g., first channel 308, etc.) and fourth (e.g., fourth channel 314) channel(s) can taper to a narrower width as they approach a junction (e.g., a junction 316, etc.), for example, in an exemplary flow-focusing junction. In yet other non-limiting implementations, a second side channel (e.g., second side channel 1206, etc.) can taper to a narrower width as it approaches its respective junction (e.g., junction 1204), for example, in an exemplary T-junction, as described above in reference to FIG. 12, for example.

In still other non-limiting implementations of microfluidic methodologies, an electrical signal (e.g., one or more control signal(s) such as control signal(s) 116, 216, 330, 332, 814, etc.) can be applied to the associated electrode pair (e.g., pair 324 of electrodes facing each other on opposite sides of first channel 308, etc.) to generate an electric field sufficient to stop, or substantially diminish (e.g., temporarily, or otherwise, etc.) the flow of ER fluid (e.g., ER fluid, GER fluid, ER 104, etc.) in the first channel first channel (e.g., first channel 308, 1202, etc.), such as by a pair of electrodes facing each other on opposite sides of the associated channel, in further non-limiting implementations. Thus, in various non-limiting implementations of microfluidic methodologies, an electric field can be applied across the associated channel between the pair of electrodes (e.g., pair 324 of electrodes facing each other on opposite sides of first channel 308, etc.). In yet other non-limiting implementations, one or more of the pair of electrodes (e.g., pair 324 of electrodes facing each other on opposite sides of first channel 308, etc.) and other electrodes as described herein can be embedded into the first channel (e.g., first channel 308, etc.).

According to further non-limiting implementations, the electrical signal (e.g., one or more control signal(s) such as control signal(s) 116, 216, 330, 332, 814, etc.) can be a digital signal (e.g., a wave, a train of pulses, etc.). In a non-limiting aspect, the frequency and/or duty cycle of the electrical signal can affect droplet characteristics (e.g., droplet size, length, volume, separation, timing, etc.), as described above. As a non-limiting example, it can be understood that for a given flow rate, droplet length can vary linearly with the period of the electrical signal, as described above, for example, regarding FIG. 4. Thus, in various non-limiting implementations of microfluidic methodologies, as further described above, droplets (e.g., droplets 102, 326, etc.) of ER fluid (e.g., ER fluid, GER fluid, ER 104, etc.) can be generated when the electrical signal (e.g., one or more control signal(s) such as control signal(s) 116, 216, 330, 332, 814, etc.) is reduced (e.g., at zero amplitude, below a threshold value, etc.).

As further described above, in various non-limiting implementations of microfluidic methodologies, ER fluid (e.g., ER fluid, GER fluid, ER 104, etc.) can comprise ER particles in a surrounding fluid, which according to a non-limiting aspect can comprise a liquid (e.g., one or more of an electrically insulating liquid, a hydrophobic liquid, etc.). According to further non-limiting aspects, a percentage of ER particles by weight in an ER fluid can be in a suitable range (e.g., 5% to 40%, etc.), and can include a GER fluid as further described herein. In addition, as further described above regarding FIGS. 1, 3, 8, etc. in various non-limiting implementations, a carrier fluid can comprise an oil, a gas, water, and so on, etc., can be immiscible with ER fluid (e.g., ER fluid, GER fluid, ER 104, etc.), or can be at least partially immiscible.

In a further non-limiting aspect of exemplary microfluidic methodologies, various non-limiting implementations of the disclosed subject matter can facilitate controlling droplet characteristics for one or more droplet(s) (e.g., droplet shape, rate of flow, etc.) of ER fluid (e.g., ER fluid, GER fluid, ER 104, etc.) carried along a channel (e.g., fourth 314 channel, etc.) in a carrier fluid (e.g., carrier fluid 106, such as an oil, etc.), such as described above, for example, regarding FIGS. 1, 3-8, etc. For instance, in a non-limiting aspect, various exemplary microfluidic methodologies can include controlling droplet characteristics for one or more droplet(s) (e.g., droplet shape, rate of flow, etc.) of ER fluid (e.g., ER fluid, GER fluid, ER 104, etc.) by applying an electric field to a channel via a pair of electrodes associated with the channel (e.g., pair 324 of electrodes facing each other on opposite sides of first channel 308, etc.).

In various non-limiting implementations, the flow of one or more droplet(s) (e.g., droplets 102, 326, etc.) of ER fluid (e.g., ER fluid, GER fluid, ER 104, etc.) can be stopped, or substantially diminished (e.g., temporarily, or otherwise, etc.) due in part to electrodes (e.g., pairs 334, 336, 338, 340 of electrodes in respective associated fifth 342, sixth 344, seventh 346, and eighth 348 channels of exemplary microfluidic chip 302, etc.) applying a sufficient electric field in an associated channel. In further non-limiting embodiments, the one or more droplet(s) (e.g., droplets 102, 326, etc.) of ER fluid (e.g., ER fluid, GER fluid, ER 104, etc.) can be stopped by the one or more pair(s) of electrodes (e.g., pair(s) 334, 336, 338, 340 of electrodes in respective associated fifth 342, sixth 344, seventh 346, and eighth 348 channels of exemplary microfluidic chip 302, etc.) to form a plug blocking passage of fluid down the associated channel, such as described above, for example, regarding FIGS. 3, 6-8, etc.

Accordingly, in yet other non-limiting implementations of microfluidic methodologies, carrier fluid (e.g., carrier fluid 106, such as an oil, etc.) pressure in the channel can be controlled by slowing or halting movement of the one or more droplet(s) (e.g., droplets 102, 326, etc.) of ER fluid (e.g., ER fluid, GER fluid, ER 104, etc.) carried by the carrier fluid (e.g., carrier fluid 106, such as an oil, etc.). It can be understood that, according to an aspect, the slowed or halted movement of the one or more droplet(s) (e.g., droplets 102, 326, etc.) of ER fluid (e.g., ER fluid, GER fluid, ER 104, etc.) can sufficiently block the associated channel, thus creating a pressure differential, where pressure upstream of the one or more droplet(s) (e.g., droplets 102, 326, etc.) of ER fluid (e.g., ER fluid, GER fluid, ER 104, etc.) can be expected to be higher than pressure downstream of the one or more droplet(s), as described above, regarding FIG. 7, for example.

In yet other non-limiting aspects of exemplary microfluidic methodologies, various non-limiting implementations of the disclosed subject matter can facilitate directing one or more droplet(s) (e.g., droplet(s) 102, 326, etc.) of ER fluid (e.g., ER fluid, GER fluid, ER 104, etc.) to one or more selected, desired, or predetermined channel(s) in a fluid flow device (e.g., one or more selected, desired, or predetermined fifth 342, sixth 344, seventh 346, and eighth 348 channel(s) of exemplary microfluidic chip 302, etc.), such as described above, for example, regarding FIGS. 1, 3-8, etc. For instance, as described above regarding FIGS. 3, 8, etc., a fluid flow device (e.g., exemplary microfluidic chip 302, etc.) can comprise a main channel (e.g., fourth channel 314, etc.) and a plurality of secondary channels (e.g., one or more of fifth 342, sixth 344, seventh 346, and eighth 348 channel(s) of exemplary microfluidic chip 302, etc.) branching from the main channel.

Thus, in exemplary non-limiting microfluidic methodologies, fluid including one or more droplet(s) (e.g., droplet(s) 102, 326, etc.) of ER fluid (e.g., ER fluid, GER fluid, ER 104, etc.) carried by the carrier fluid (e.g., carrier fluid 106, such as an oil, etc.) can be allowed flow into one or more selected, desired, or predetermined channel(s) of the secondary channels (e.g., one or more of fifth 342, sixth 344, seventh 346, and eighth 348 channel(s) of exemplary microfluidic chip 302, etc.), for instance, by stopping the flow of fluid into one or more non-selected ones of the secondary channel(s) (e.g., the other of the one or more of fifth 342, sixth 344, seventh 346, and eighth 348 channel(s) of exemplary microfluidic chip 302, etc.) by applying an electrical field to the associated secondary channels with one or more pair(s) of electrodes in the non-selected secondary channels (e.g., by applying one or more electrical signal(s) to non-selected pair(s) 334, 336, 338, 340 of electrodes in respective associated fifth 342, sixth 344, seventh 346, and eighth 348 channels of exemplary microfluidic chip 302, etc.). Accordingly, as described above, it can be understood that the flow of one or more droplet(s) (e.g., droplet(s) 102, 326, etc.) of ER fluid (e.g., ER fluid, GER fluid, ER 104, etc.) can be stopped, or substantially diminished (e.g., temporarily, or otherwise, etc.) due in part to electrodes (e.g., pairs 334, 336, 338, 340 of electrodes in respective associated fifth 342, sixth 344, seventh 346, and eighth 348 channels of exemplary microfluidic chip 302, etc.) applying a sufficient electric field in an associated channel, in various non-limiting implementations.

In still other non-limiting aspects of exemplary microfluidic methodologies, various non-limiting implementations of the disclosed subject matter can facilitate storing one or more droplet(s) (e.g., droplet(s) 102, 326, etc.) of ER fluid (e.g., ER fluid, GER fluid, ER 104, etc.) at desired location(s) in a network of channels (e.g., network of one of more of channels 308, 310, 312, 314, 342, 344, 346, 348, main channel out 350, side channel 352, of droplet display or microfluidic chip 800, etc.). For instance, in an exemplary non-limiting aspect of microfluidic methodologies, one or more droplet(s) (e.g., droplet(s) 102, 326, etc.) of a first fluid (e.g., ER fluid, GER fluid, ER 104, etc.) carried by a second fluid that can act as a carrier fluid (e.g., a carrier fluid, such as oil, etc.) can be generated by controlling droplet characteristics (e.g., droplet shape, rate of flow, droplet timing, spacing between successive droplets, etc.) for one or more droplet(s) of the first fluid (e.g., ER fluid, GER fluid, ER 104, etc.) and directing the droplet(s) of ER fluid, as described above regarding stopping the flow of fluid into one or more non-selected one(s) of the secondary channel(s) (e.g., the other of the one or more of fifth 342, sixth 344, seventh 346, and eighth 348 channel(s) of exemplary microfluidic chip 302, etc.) by applying an electrical field to the associated secondary channel(s) with one or more pair(s) of electrodes in the non-selected secondary channel(s).

Thus, as described above, in further non-limiting aspects, exemplary non-limiting microfluidic methodologies can create a desired image (e.g., a desired sign, character, letter, or other image, etc.) by directing and storing one or more droplet(s) (e.g., droplet(s) 102, 326, etc.) of ER fluid (e.g., ER fluid, GER fluid, ER 104, etc.) in locations within a network of channels. For example, non-limiting microfluidic methodologies can create a desired image by directing and storing one or more droplet(s) (e.g., droplet(s) 102, 326, etc.) of ER fluid (e.g., ER fluid, GER fluid, ER 104, etc.) to one or more selected, desired, or predetermined channels in a fluid flow device (e.g., one or more selected, desired, or predetermined fifth 342, sixth 344, seventh 346, and eighth 348 channel(s) of exemplary microfluidic chip 302, droplet display or microfluidic chip 800, etc.), such as described above, for example, regarding FIGS. 1, 3-8, etc.

In yet other non-limiting aspects, exemplary non-limiting microfluidic methodologies can facilitate controlling the flow of one or more droplet(s) (e.g., droplet(s) 102, 326, etc.) of a first fluid (e.g., ER fluid, GER fluid, ER 104, etc.) carried by a second fluid that can act as a carrier fluid (e.g., a carrier fluid, such as oil, etc.). For example, in non-limiting implementations of microfluidic methodologies, one or more droplet(s) (e.g., droplet(s) 102, 326, etc.) of a first fluid (e.g., ER fluid, GER fluid, ER 104, etc.) can be generated and carried by a second fluid that can act as a carrier fluid (e.g., a carrier fluid, such as oil, etc.). In further non-limiting implementations, microfluidic methodologies can include injecting one or more additional droplet(s) of the first fluid (e.g., ER fluid, GER fluid, ER 104, etc.) upstream of one of the one or more droplet(s) (e.g., droplet(s) 102, 326, etc.) of ER fluid (e.g., ER fluid, GER fluid, ER 104, etc.), for example, as described above regarding FIG. 8. In a non-limiting aspect, exemplary microfluidic methodologies can further include controlling or manipulating the movement of the one or more additional droplet(s) of the first fluid, for instance, by using an electric field (e.g., generated by one or more associated electrode(s), etc.), as described above, including injecting the one or more additional droplet(s) of the first fluid in between more than one of the one or more droplet(s) (e.g., droplet(s) 102, 326, etc.) of ER fluid (e.g., ER fluid, GER fluid, ER 104, etc.).

In additional implementations, exemplary non-limiting microfluidic methodologies can also include controlling or manipulating the movement of one or more droplet(s) (e.g., one or more droplet(s) 202, 1902, gas bubble(s) 2214, etc.) of a first fluid (e.g., a non-ER fluid, such as water, oil, gas, etc., 206, 1904, etc.) using ER fluid (e.g., ER fluid, GER fluid, ER 204, 1906, etc.) employed as a carrier fluid, as described above regarding FIGS. 2, 11-12, 17-24, etc., for example. For instance, in a non-limiting aspect, microfluidic methodologies can further include changing or influencing (e.g., starting, increasing, diminishing, stopping, changing rate, accelerate, slow, etc.) flow of the ER fluid (e.g., ER fluid, GER fluid, ER 204, 1906, etc.) employed as a carrier fluid, for example, by applying an electric field to an associated channel (e.g., generated by one or more associated electrode(s), etc.), or portion thereof, within which the ER fluid can be conveyed. In still other non-limiting embodiments, one or more droplet(s) (e.g., one or more droplet(s) 202, 1902, gas bubble(s) 2214, etc.) of the first fluid (e.g., a non-ER fluid, such as water, oil, gas, etc., 206, 1904) can be caused to flow into one or more channel(s) selected from of a plurality of channels branching from a main channel (e.g., one or more branch channel(s) such as a first branch channel 1918, a second branch channel 1920, etc., branching from a main input channel 1916 such as main channel 1734 as described in FIGS. 17-18, etc.) by stopping flow of ER fluid in one or more non-selected channel(s) (e.g., stopping, substantially diminishing, or otherwise hindering flow of the ER fluid in one or more non-selected channel(s) relative to one or more selected channel(s), etc.), such as by applying an electric field to one or more of the one or more non-selected channel(s).

According to further non-limiting implementations, exemplary microfluidic methodologies can include generating one or more droplet(s) (e.g., one or more droplet(s) 202, gas bubble(s) 2214, etc.) of a first fluid (e.g., a non-ER fluid, such as water, oil, gas, etc., 206, etc.) using ER fluid (e.g., ER fluid, GER fluid, ER 204, 1906, etc.) employed as a carrier fluid, as described above regarding FIGS. 12, 17-18, 22-24, etc., for example. For instance, in a non-limiting aspect, exemplary non-limiting microfluidic methodologies can include directing a stream of first fluid (e.g., a non-ER fluid, such as water, oil, gas, etc., 206, etc.) in a first channel (e.g., first channel 1202, etc.) and a stream of ER fluid (e.g., ER fluid, GER fluid, ER 204, 1906, etc.) in a second channel (e.g., second side channel 1206, etc.) to a junction (e.g., junction 1204, etc.) between first, second and fourth channels (e.g., fourth channel 1210), so as to form one or more droplet(s) of the first fluid carried by the ER fluid in the fourth channel. In further non-limiting aspects, exemplary microfluidic methodologies can also include applying an electrical signal to one or more electrode(s) in the second channel (e.g., by one or more associated electrode pair(s) 1212, etc. of second side channel 1206, etc.), for instance, to facilitate controlling flow of ER fluid from second channel (e.g., second side channel 1206, etc.) to the junction (e.g., junction 1204, etc.).

In yet other non-limiting aspects, droplet size (e.g., size of droplet(s) 202 of first fluid 206, etc.) and/or separation between two successive droplets can be tuned by adjusting, for instance, frequency and/or duty cycle of control signals (e.g., electrical control signals 1302, 1402, etc.) applied to one or more electrode pair(s) (e.g., one or more of associated electrode pair(s) 1212, etc.), for example, as described above regarding FIG. 12, etc. In still other non-limiting aspects, the junction between first, second and fourth channels (e.g., junction 1204, etc.) can comprise an exemplary T-junction, as described above regarding FIG. 12, for example, as well as comprising an exemplary flow-focusing junction, as described above regarding FIG. 11, that can include a third channel (e.g., third side channel 1108, etc.) adapted to convey ER fluid to the junction (e.g., junction 1104, etc.).

In further non-limiting aspects, the control signals (e.g., electrical control signals 1302, 1402, etc.) applied to electrode pairs (e.g., one or more of associated electrode pairs 1112, 1114, 1212, etc.) can generate an electric field (e.g., an electric field of sufficient strength to stop, substantially diminish, or otherwise hinder flow of the ER fluid, etc.) in the second channel, or portions thereof. In yet other non-limiting aspects, control signal(s) (e.g., electrical control signal(s) 1302, 1402, etc.) applied to one or more electrode pair(s) (e.g., one or more of associated electrode pair(s) 1112, 1114, 1212, etc.) can comprise a train of pulses, a digital signal, and so on, etc., such that the droplet size (e.g., size of droplet(s) 202 of first fluid 206, etc.), length, separation between two successive droplets, and/or frequency, and so on can be tuned by adjusting, for instance, frequency and/or duty cycle of control signal(s) (e.g., electrical control signal(s) 1302, 1402, etc.) applied to one or more electrode pair(s) (e.g., one or more of associated electrode pair(s) 1112, 1114, 1212, etc.). In various non-limiting implementations, it can be understood that, at a given flow rate in the channel of interest, droplet length can vary linearly with the period of the pulses, as further described above regarding FIGS. 13-18, 22-24, etc., for example. In yet other non-limiting embodiments, it can be further understood that droplet(s) (e.g., droplet(s) 202 of first fluid 206, etc.) of first fluid (e.g., a non-ER fluid, such as water, oil, gas, etc., 206, etc.) can be generated when control signal(s) (e.g., electrical control signal(s) 1302, 1402, etc.) are applied to electrode pair(s) (e.g., one or more of associated electrode pair(s) 1112, 1114, 1212, etc.) are above a threshold value.

According to still other non-limiting implementations, exemplary non-limiting microfluidic methodologies can include generating a sequence of droplets of a first fluid and droplets of a second fluid (e.g., generating an exemplary droplet train 1702 comprising one or more droplet(s) of a first fluid 1704 and one or more droplet(s) of a second fluid 1706, etc.), as described above regarding FIGS. 17-18, for example. In a non-limiting aspect, exemplary non-limiting microfluidic methodologies can further comprise generating droplets of the first fluid (e.g., one or more droplet(s) of a first fluid 1704, etc.) and generating droplets of the second fluid (e.g., one or more droplet(s) of a second fluid 1706, etc.), as described above regarding exemplary T-junctions and FIGS. 17-18, etc.

For instance, in various non-limiting aspects, first fluid droplets (e.g., first fluid 1702 droplets, etc.) can be generated in a first channel (e.g., first channel 1724, etc.) adapted to convey the first fluid (e.g., first fluid 1702, etc.) proximate to a junction (e.g., junction 1726, etc.) with a second channel (e.g., channel 1 (1716), etc.) adapted to convey ER fluid (e.g., ER fluid, GER fluid, etc.) employed as a carrier fluid and a third channel (e.g., converging channel 1708, etc.). Likewise, second fluid droplets (e.g., second fluid 1704 droplets etc.) can be generated in a fourth channel (e.g., second channel 1728, etc.) adapted to convey the second fluid (e.g., second fluid 1704, etc.) proximate to a second (e.g., junction 1730, etc.) with a fifth channel (e.g., channel 2 (1718), etc.) adapted to convey ER fluid (e.g., ER fluid, GER fluid, etc.) employed as a carrier fluid and a sixth channel (e.g., converging channel 1710, etc.). In addition, the third and sixth channels (e.g., channels 1708 and 1710, etc.) can join at a junction (e.g., junction 1732, etc.) and can form a main output channel (e.g., main channel 1734, etc.). In further non-limiting aspects, exemplary non-limiting microfluidic methodologies can further include controlling one or more pair(s) of electrodes (e.g., one or more pair(s) 1712 and 1714 of electrodes, etc.) facing each other on opposite sides of second and fifth channels (e.g., channels 1 (1716) and 2 (1718), etc.), for example, by applying electrical control signals (e.g., electrical control signals 1720 and 1722, etc.) to facilitate generation of the droplets. As further described above regarding FIGS. 17-18, etc., electrical control signals (e.g., electrical control signals 1720 and 1722, etc.) can be substantially in phase (e.g., to form droplet pairs, etc.), out of phase to varying degrees (e.g., to form droplets that are spaced apart to varying extents, etc.), and so on.

According to still other non-limiting implementations, exemplary non-limiting microfluidic methodologies can comprise reversing, exchanging, or otherwise changing the order of one or more droplet(s), adjusting droplet separation, etc., as described above, for example, regarding FIGS. 19-21. For instance, in various non-limiting aspects, exemplary non-limiting microfluidic methodologies can include providing a fluid flow device (e.g., microfluidic chip 1900, portions thereof, etc.) with a main input channel (e.g., main input channel 1916 such as main channel 1734 as described in FIGS. 17-18, etc.), first and second branch channels (e.g., first branch channel 1918, second branch channel 1920, etc.) branching from main input channel and a main output channel (e.g., main output channel 1926 adapted to collect and/or distribute droplet train 1908 from the one or more branch channel(s) such as first branch channel 1918, second branch channel 1920, etc.) fed by the first and second branch channels. In further non-limiting embodiments, exemplary non-limiting microfluidic methodologies can further comprise allowing one or more droplet(s) (e.g., a first and a second droplet, etc.) to flow down the main input channel (e.g., main input channel 1916, etc.) in a preliminary order (e.g., with the first droplet downstream of the second droplet, etc.).

In various non-limiting implementations, exemplary non-limiting microfluidic methodologies can further include causing one of the one or more droplet(s) (e.g., the first droplet, etc.) to flow from the main input channel (e.g., main input channel 1916, etc.) to the first branch channel (e.g., first branch channel 1918, etc.). In addition, microfluidic methodologies can include causing another of the one or more droplet(s) (e.g., the second droplet, etc.) to flow from the main input channel (e.g., main input channel 1916, etc.) to the second branch channel (e.g., second branch channel 1920, etc.). In yet other non-limiting implementations, exemplary microfluidic methodologies can include allowing the one or more droplet(s) (e.g., the first and second droplets, etc.) to flow from the first and second branch channels (e.g., first branch channel 1918, second branch channel 1920, etc.) into the main output channel (e.g., main output channel 1926, etc.).

For instance, in various non-limiting aspects, a first droplet can be caused to flow into the first branch channel by preventing flow of fluid in the second branch channel. As a non-limiting example, by applying an electric field to the second branch channel, exemplary microfluidic methodologies can stop, diminish, etc. the flow of ER fluid (e.g., ER fluid, GER fluid, ER 1906, etc.) employed as a carrier fluid or an ER droplet (e.g., ER droplet 1902, etc.) thereby forming a plug that can block the second channel, as described above regarding FIGS. 19-21, for example. Similarly, in further non-limiting aspects, a second droplet can be caused to flow into the second branch channel by preventing flow of fluid in the first branch channel. Likewise, by applying an electric field to the first branch channel, exemplary microfluidic methodologies can stop, diminish, etc. the flow of ER fluid (e.g., ER fluid, GER fluid, ER 1906, etc.) employed as a carrier fluid or an ER droplet (e.g., ER droplet 1902, etc.) thereby forming a plug that can block the first channel, as described above regarding FIGS. 19-21, for example.

In various non-limiting implementations, it can be understood that fluid flow (e.g., ER fluid, GER fluid, ER 1906, etc. employed as a carrier fluid or an ER droplet such as ER droplet 1902, etc.) can be stopped in the first branch channel (or second branch channel) for a predetermined period of time, while the second droplet (or first droplet) can be allowed to flow in the second branch channel (or first branch channel). According to various non-limiting aspects, the predetermined period of time can be determined such that it can be sufficient to cause reversal of the order of the first and second droplets (e.g., cause reversal of the order as to compared to the preliminary order, etc.) when the first and second droplets enter the main output channel (e.g., main output channel 1926, etc.), can be sufficient to achieve a desired separation adjustment between the first and second droplets (e.g., as compared to an initial droplet separation between the first and second droplets, etc.), and so on.

In a further non-limiting aspect of exemplary microfluidic methodologies, the first and second branch channels (e.g., first branch channel 1918, second branch channel 1920, etc.) can form a loop (e.g., such as in an order exchange component 1922 or portion(s) thereof, etc.), with first and second branch channels having same length or different length, as described above, regarding FIGS. 19-21, for example. It can be understood that in various non-limiting implementations, exemplary non-limiting microfluidic methodologies can further include one or more additional channel(s) (e.g., one or more side channel(s) 1924, etc.), which can be located upstream of the first and second branch channels (e.g., first branch channel 1918, second branch channel 1920, etc.), and that can be adapted to, for example, allow disposal of excess fluid, excess droplets, or to allow bypassing the first and second branch channels, as described above, regarding FIGS. 19-21, for example. As further described above, in various non-limiting embodiments of exemplary non-limiting microfluidic methodologies, the one or more droplet(s) (e.g., the first and second droplets, etc.) can comprise a first droplet of a first fluid a second droplet of a second fluid, and so on, where the first and second fluids, and so on, can comprise any number and/or types of fluid (e.g., a first fluid, water, liquids, gases, chemicals, reagents, biological agents, combinations, etc.) as exemplified above.

According to yet other non-limiting implementations, exemplary non-limiting microfluidic methodologies can comprise controlling or manipulating flow, characteristics, and/or behavior of droplets (e.g., droplets 102, 202, 326, 1004, 1006, 1304, 1404, 1902, gas bubble(s) 2214, etc.) of a first fluid (e.g., a non-ER fluid, such as water, oil, gas, etc., 206, 1904, etc.) in a microfluidic device (e.g., microfluidic chip 302, droplet display or microfluidic chip 800, chip component 1002, flow-focusing junction 1100, T-junction 1200, portion of a microfluidic chip 1900, etc.). For instance, exemplary non-limiting microfluidic methodologies can include using an ER fluid (e.g., ER fluid, GER fluid, ER 104, 204, 1006, 1906, etc.) as a switch to facilitate controlling or manipulating flow, characteristics, and/or behavior of droplets of the first fluid. In addition, exemplary non-limiting microfluidic methodologies can further include controlling the movement of ER fluid (e.g., ER fluid, GER fluid, ER 104, 204, 1006, 1906, etc.) employed as a carrier fluid or droplets of ER fluid in another carrier fluid (e.g., carrier fluid 106, such as an oil, etc.), by application of one or more electric field(s) to associated channels, or portions thereof, in the microfluidic device.

According to still further non-limiting implementations, exemplary non-limiting microfluidic methodologies can include generating and/or controlling droplets (e.g., droplets 102, 202, 326, 1004, 1006, 1304, 1404, 1902, gas bubble(s) 2214, etc.) in a carrier fluid (e.g., carrier fluid 106, such as an oil, ER fluid employed as a carrier fluid, etc.). For example, exemplary non-limiting microfluidic methodologies can include applying a digital signal, an electrical signal, etc. (e.g., an electrical control signal, etc.) to a pair of electrodes in an associated channel to facilitate one or more of changing or influencing (e.g., starting, increasing, diminishing, stopping, changing rate, etc.) flow of the ER fluid (e.g., ER fluid, GER fluid, ER 204, 1906, etc.), controlling and/or generating either droplets of ER fluid or droplets of another fluid (e.g., a non-ER fluid, such as water, oil, gas, etc., 206, 1904, etc.), or performing logical operations (e.g., exchanging the order of droplets, etc.) on one or more droplet(s) by changing or influencing flow of the ER fluid employed as a carrier fluid or ER fluid droplets, as further described herein.

In view of the methodologies described supra, systems and/or devices that can be implemented in accordance with the disclosed subject matter will be better appreciated with reference to the functional block diagrams of FIG. 28, for example. While, for purposes of simplicity of explanation, the functional block diagrams are shown and described as various assemblages of functional component blocks, it is to be understood and appreciated that such illustrations or corresponding descriptions are not limited by such functional block diagrams, as some implementations may occur in different configurations. Moreover, not all illustrated blocks may be required to implement the systems and devices described hereinafter.

### Exemplary Microfluidic Systems

Accordingly, FIG. 28 depicts an exemplary non-limiting functional block diagram for implementing microfluidic droplet generation, manipulation, and/or control systems (e.g., microfluidic systems 2802, etc.) and devices in accordance with various aspects of the disclosed subject matter. It is to be appreciated that, according to the various aspects described herein (e.g., regarding the various figures and related descriptions), various components and/or subcomponents can be implemented as computer executed components such as are generally known by those of skill in the art. For example, according to various implementations, components described herein can be configured to perform applicable methodologies, or portions thereof, disclosed herein by standard software programming techniques, and the configured components can be executed on a computer processor. In addition, as described above, it can be understood that the term “droplet” can include a liquid droplet, a gaseous droplet (e.g., a bubble), combinations thereof, and so on as the context allows. For instance, in some contexts a reference to droplets (e.g., of a non-ER fluid), can comprise either or both liquid droplets and gaseous droplets (e.g., bubbles of a gas).

To that end, exemplary non-limiting microfluidic systems 2802 can comprise one or more channel network(s) 2804 adapted to facilitate one or more of generating or controlling one or more fluid droplet(s) (e.g., one or more of ER fluid droplet(s), one or more of GER fluid droplet(s), non-ER fluid droplet(s) comprising a fluid that lacks significant electrorheological effect relative to the ER fluid, gas bubble(s), combinations, etc.), for example, as described supra, regarding FIGS. 1-3, 8-12, 17-24, etc. and as further described below. As described above, the one or more channel network(s) 2804 can comprise one or more channel(s) or fluid channel(s) adapted to contain, store, carry, direct, guide, deliver, or otherwise serve as a conduit for flow of a fluid of interest in a microfluidic application, as further described below. Thus, it can be understood that, in various aspects, the one or more channel network(s) 2804 can comprise one or more connections to one or more other channel(s), fluid channel(s), junction(s), other channel network(s) and/or fluid channel network(s), and/or other component(s), subcomponent(s), or portion(s) thereof (e.g., one or more connection(s) to one or more sensor(s), valve(s), heat exchanger(s), flow controller(s), fluid accumulator(s) or reservoir(s), such as liquid, and/or gas accumulator(s) or reservoir(s), etc., connection(s) to liquids and/or gas supply/supplies, connection(s) to liquids and/or gas reaction vessel(s), disposal line(s), chemical and/or biological assay(s), biological tissue(s), such as blood vessel(s), or other fluid carrying tissue(s), etc.), as further described below.

In yet other non-limiting implementations, microfluidic systems 2802 can further include one or more microfluidic controller component(s) 2806, as described supra, regarding FIGS. 3-10, 19-24, etc., for example, which can be communicatively coupled (e.g., able to send and/or receive signal(s), via signal line(s) 2884, etc.) to the one or more channel network(s) 2804, portion(s), component(s), or subcomponent(s) thereof. In addition, in further non-limiting aspects, the one or more channel network(s) 2804 can also comprise one or more associated electrode(s) adapted to send and/or receive an electrical signal (e.g., a detected signal, an electrical control signal, etc.) that can facilitate one or more of generation and controlling or manipulating one or more fluid droplet(s) as described below.

For example, in a non-limiting aspect, the one or more channel network(s) 2804 of microfluidic systems 2802 can further include one or more droplet generation component(s) 2810, one or more droplet control component(s) 2812, one or more sensing component(s) 2814, or one or more fluid control/interface component(s) 2816, for example, that can facilitate generation, detection, control, manipulation (e.g., fission, fusion, and/or sorting, etc.) and/or digitalization of one or more discrete micro-droplet(s) and/or bubble(s) using electrorheological fluids (e.g., ER fluids, GER fluids, etc.) and electrical signal(s)s (e.g., coded signal(s), digital signal(s), electrical control signal(s), etc.) as described supra, regarding FIGS. 1-3, 8-12, 17-24, etc. In a further non-limiting aspect, the one or more microfluidic controller component(s) 2806 of microfluidic systems 2802 can also include one or more detection component(s) 2818, one or more analysis component(s) 2820, one or more controller component(s) 2822, or one or more interface component(s) 2824, for example, that can facilitate controlling the generation, detection, control, manipulation (e.g., fission, fusion, and/or sorting, etc.) and/or digitalization of one or more discrete micro-droplet(s) and/or bubble(s) using electrorheological fluids (e.g., ER fluids, GER fluids, etc.) and electrical signal(s) (e.g., coded signal(s), digital signal(s), electrical control signal(s), etc.) as described supra, regarding FIGS. 1-3, 8-12, 17-24, etc.

Accordingly, in various non-limiting implementations, the one or more droplet generation component(s) 2810 can comprise one or more exemplary embodiments (e.g., exemplary flow-focusing implementation(s), exemplary T-junction implementation(s), other implementation(s) suitable for micro-droplet(s) and/or bubble(s) generation, adapted to generate one or more fluid droplet(s), etc.) that can facilitate generation of one or more discrete micro-droplet(s) and/or bubble(s) using electrorheological fluids (e.g., ER fluids, GER fluids, etc.) and electrical signal(s) (e.g., coded signal(s), digital signal(s), electrical control signal(s), etc.) as described supra, regarding FIGS. 1-2, 8, 11-12, 17-24, etc. For example, the one or more droplet generation component(s) 2810 can comprise one or more flow-focusing implementation(s), one or more T-junction implementations, one or more exemplary channel network(s) 2202, and so on, that can employ a carrier fluid (e.g., an ER fluid, a non-ER fluid, etc.) to facilitate generation of one or more micro-droplet(s) of a fluid (e.g., droplets of an ER fluid, droplets of a non-ER fluid, etc.) and/or bubble(s) (e.g., bubbles of one or gases, vapors, mixtures, etc.) of a desired characteristic (e.g., size, volume, separation, order, composition, etc.).

It can be understood that the one or more droplet generation component(s) 2810 can include one or more channel(s), one or more electrode(s), and so on as described herein regarding FIGS. 1-2, 8, 11-12, 17-24, etc., for example. Thus, as described above, exemplary microfluidic systems 2802 can comprise one or more electrode(s) associated with a portion of the one or more channel network(s) 2804, which one or more electrode(s) can be adapted to apply an electric field to the portion of the one or more channel network(s) 28004 to influence or change (e.g., stop, start, accelerate, slow, increase, diminish, etc.) flow of an ER fluid (e.g., ER fluid, GER fluid, such as ER 104, etc.) in the one or more channel network(s) to facilitate generating and/or controlling or manipulating one or more fluid droplet(s). It can be further understood that one or more electrode(s) can be further configured to receive and/or send an electrical signal (e.g., send and/or receive an electrical signal, such as a detected signal, an electrical control signal, etc.) from or to a portion of a microfluidic controller component (e.g., a portion of one or more microfluidic controller component(s) 2806, etc.).

As another example, in further non-limiting implementations, the one or more droplet control component(s) 2812 can include one or more exemplary embodiment(s) (e.g., implementations and/or channel arrangements suitable for micro-droplet(s) and/or bubble(s) control, manipulation, and/or digitalization, and so on, etc.) that can facilitate control, manipulation (e.g., fission, fusion, and/or sorting, etc.) and/or digitalization of one or more discrete micro-droplet(s) and/or bubble(s) using electrorheological fluids (e.g., ER fluids, GER fluids, etc.) and electrical signal(s) (e.g., coded signal(s), digital signal(s), electrical control signal(s), etc.) as described supra, regarding FIGS. 4-10, 19-21, etc. For example, the one or more droplet control component(s) 2812 can include one or more implementation(s) and/or channel arrangement(s), such as combinations of branch channel(s), side channel(s), electrode(s), connection(s) to one or more droplet generation component(s) 2810, and so on (e.g., order exchange component 1922, one or more side channel(s) 1924, 342, etc.) that can employ a carrier fluid (e.g., an ER fluid, a non-ER fluid, etc.) to facilitate control, manipulation and/or digitalization of one or more discrete micro-droplet(s) and/or bubble(s) of a fluid (e.g., droplet(s) of an ER fluid, droplets of a non-ER fluid, etc.) and/or bubble(s) (e.g., bubbles of one or gases, vapors, mixtures, etc.) of a desired characteristic (e.g., size, volume, separation, order, composition, etc.).

It can be further understood that the one or more droplet control component(s) 2812 can include one or more channel(s) with or without one or more associated electrode(s) arranged in configurations and provided with connections adapted to affect flows of the various fluids (e.g., an ER fluid, a non-ER fluid, gases, etc.) to cause desired effects, as described herein regarding FIGS. 4-10, 19-21, etc., for example. Thus, in various exemplary implementations of microfluidic systems 2802, the one or more droplet control component(s) 2812 can be configured to facilitate one or more of droplet fission, droplet fusion, droplet sorting, droplet encoding, droplet digitalizing, droplet directional switching, droplet storage, droplet disposal, droplet order exchange, droplet arrangement, droplet size, volume, shape, spacing, or sequence specification, determining relative position of different types of droplets, or droplet display, and son etc.

In still other non-limiting embodiments, the one or more sensing component(s) 2814 can comprise one or more component(s) (e.g., channel(s), electrode(s), sensor(s), instrument(s), fluid connection(s) to other component(s), etc.), such as electrode pair 1930, and so on adapted to sense, detect, measure, or otherwise facilitate indication of one or more parameter(s) of a fluid (e.g., physical, electrical, chemical, biological, composition, volume, mass, flow rate, temperature, proximity, noise, vibration, other parameter(s), and so on, etc.). For instance, the one or more sensing component(s) 2814 can be adapted to facilitate indication of one or more parameter(s) of the ER fluid (e.g., ER fluid, GER fluid, such as ER 104, etc.), the one or more fluid droplet(s) (e.g., one or more ER fluid droplet(s), non-ER fluid droplet(s) comprising a fluid that lacks significant electrorheological effect relative to the ER fluid, gas bubble(s), combinations thereof, etc.), and so on in the one or more channel network(s) 2804. As a non-limiting example, one or more sensing component(s) 2814 can facilitate indication of one or more parameter(s) of a fluid by physical, electrical, mechanical, chemical, biological, capacitive, optical, sonic, or other parametric measurement component, etc. for one or more droplet(s), bubble(s), combinations, and so on to facilitate control, manipulation and/or digitalization of one or more discrete micro-droplet(s) of a fluid (e.g., droplets of an ER fluid, droplets of a non-ER fluid, etc.) and/or bubble(s) (e.g., bubbles of one or gases, vapors, mixtures, etc.) of a desired characteristic (e.g., size, volume, separation, order, composition, etc.). It can be further understood that the one or more sensing component(s) 2814 can include one or more channel(s) with or without one or more associated electrode(s) arranged in configurations and provided with connections adapted to sense, detect, measure, or otherwise facilitate indication of one or more parameter(s) of the various fluids (e.g., an ER fluid, a non-ER fluid, gases, etc.) as an aid to effecting microfluidic system control as described herein regarding FIGS. 4-10, 19-21, etc., for example.

According to yet other non-limiting implementations, the one or more fluid control/interface component(s) 2816 can comprise one or more electrical, mechanical, and/or hydraulic connection(s) to associated or ancillary system(s), component(s), subcomponent(s), portion(s) thereof, and so on. In non-limiting examples, the one or more fluid control/interface component(s) 2816 can include one or more valve(s), heat exchanger(s), flow controller(s), fluid accumulator(s) or reservoir(s) (e.g., liquid, and/or gas accumulators or reservoirs, etc.), connection(s) to liquid and/or gas supply/supplies, connection(s) to liquid and/or gas reaction vessel(s), disposal line(s), chemical and/or biological assay(s), biological tissues (e.g., blood vessels, or other fluid carrying tissues, etc.), sensor(s), etc. In addition, the one or more fluid control/interface component(s) 2816 can include electrical connection(s) to one or more microfluidic controller component(s) 2806, as further described below, biological tissues (e.g., nerve tissues, etc.), electrical component(s) such as heater(s), light(s), etc., one or more external microfluidic controller component(s) (not shown), and so on.

In other non-limiting implementations, the one or more detection component(s) 2818 can comprise one or more exemplary embodiment(s) (e.g., one or more detection component(s) adapted to facilitate receiving and/or processing detected signal(s) indicating one or more parameter(s) of a fluid as described above, such as, detection component 1938 adapted to facilitate detection of the proximity of one or more droplet(s), other implementations, etc.) that can facilitate receiving and/or processing detected signal(s) indicating one or more parameter(s) of a fluid. For instance, by receiving and/or processing detected signal(s) indicating one or more parameter(s) of a fluid the one or more detection component(s) 2818 can facilitate control, manipulation and/or digitalization of one or more discrete micro-droplet(s) of a fluid (e.g., droplet(s) of an ER fluid, droplet(s) of a non-ER fluid, etc.) and/or bubble(s) (e.g., bubbles of one or gases, vapors, mixtures, etc.) of a desired characteristic (e.g., size, volume, separation, order, composition, etc.). It can be further understood that the one or more detection component(s) 2818 can include one or more computer component(s) and/or associated hardware, software, or other component(s), etc. and/or associated electrical connection(s), hardware device(s), and so on adapted to facilitate receiving and/or processing detected signal(s) indicating one or more parameter(s) of a the various fluids (e.g., an ER fluid, a non-ER fluid, gases, etc.) as an aid to effecting microfluidic system control, as described herein regarding FIGS. 4-10, 19-21, etc., for example.

According to still other non-limiting embodiments, the one or more analysis component(s) 2820 can comprise one or more component(s) (e.g., analysis component 1942, other components(s) adapted to analyze information associated with one or more parameter(s) of a the various fluids etc.) adapted to store, study, predict, develop, and/or otherwise analyze detected and/or processed signal(s), set points, thresholds, and so on associated with one or more parameter(s) of the various fluids (e.g., an ER fluid, a non-ER fluid, gases, etc.) as an aid to effecting microfluidic system control. For example, as further described herein, for example, one or more analysis component(s) 2820 can comprise hardware, software, combinations thereof, and so on adapted to perform one or more function(s) that facilitate storing, studying, predicting, developing, and/or otherwise analyzing detected and/or processed signal(s), set points, thresholds, and so on associated with one or more parameter(s) of a the various fluids. As a further example, one or more analysis component(s) 2820, or portion(s) thereof, can facilitate storing set points, timing requirements, thresholds, and so on and can further facilitate analysis of one or more parameter(s) of the various fluids as compared to such set points, timing requirements, thresholds, and so on. In yet another non-limiting aspect, one or more analysis component(s) 2820, or portions thereof, can provide information associated with the of one or more parameter(s) of the various fluids to the one or more controller component(s) 2822, to a data acquisition, storage, or display component, to process control algorithms, and so on, for example, via one or more interface component(s) 2824, etc.

In further non-limiting implementations, the one or more controller component(s) 2822 can comprise one or more component(s) (e.g., controller component 802, controller component 1944, other controller component(s), subcomponent(s), or portion(s) thereof, etc.) adapted to facilitate functions, or portions thereof, of droplet generation, droplet logic control, storage, and/or manipulation, etc. for the various fluids (e.g., an ER fluid, a non-ER fluid, gases, etc.) as an aid to effecting microfluidic system control. For example, the one or more controller component(s) 2822 can comprise one or more components that facilitate providing one or more coded signal(s) (e.g., coded signal(s), digital signal(s), electrical control signal(s), etc.) for discrete micro-droplet(s) and/or bubble(s) generation and control for a fluid (e.g., ER fluid, GER fluid, gases, non-ER fluids, combinations, etc.) as described above, for example, regarding FIGS. 1-24, etc. In addition, the one or more controller component(s) 2822 can further include electrical connection(s) to one or more electrode(s) of the one or more droplet generation component(s) 2810 or of the one or more droplet control component(s) 2812 as well as connection(s) to component(s), subcomponent(s), or portion(s) thereof, of the one or more fluid control/interface component(s) 2816.

Additionally in still further non-limiting embodiments, the one or more interface component(s) 2824 can include one or more electrical, mechanical, and/or hydraulic connection(s) to associated or ancillary system(s), component(s), subcomponent(s), portion(s) thereof, and so on. In non-limiting examples, the one or more interface component(s) 2824 can include interface(s) (e.g., electrical, hydraulic, mechanical, or otherwise, etc.) to valve(s), heat exchanger(s), flow controller(s), fluid accumulator(s) or reservoir(s) (e.g., liquid, and/or gas accumulator(s) or reservoir(s), etc.), connection(s) to liquid and/or gas supply/supplies, connection(s) to liquid and/or gas reaction vessel(s), disposal line(s), chemical and/or biological assay(s), biological tissues (e.g., blood vessels, or other fluid carrying tissues, etc.), sensor(s), etc. In addition, the one or more interface component(s) 2824 can include electrical connection(s) to one or more fluid control/interface component(s) 2816, one or more channel network(s) as further described above, biological tissues (e.g., nerve tissues, etc.), electrical component(s) such as heater(s), light(s), etc., one or more external microfluidic controller component(s) (not shown), and so on.

It can be understood that while a brief overview of exemplary microfluidic systems 2802 has been provided, the disclosed subject matter is not so limited. Thus, it can be further understood that various modifications, alterations, addition, and/or deletions can be made without departing from the scope of the embodiments as described herein. Accordingly, similar non-limiting implementations can be used or modifications and additions can be made to the described embodiments for performing the same or equivalent function of the corresponding embodiments without deviating therefrom.

In addition, the word “exemplary” is used herein to mean serving as an example, instance, or illustration. For the avoidance of doubt, the subject matter disclosed herein is not limited by such examples. Moreover, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more component(s) may reside within a process and/or thread of execution and a component may be localized on one computer and/or distributed between two or more computer(s).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more component(s) may be combined into a single component providing aggregate functionality or divided into several separate sub-components, and that any one or more middle component layer(s), such as a management layer, can be provided to communicatively couple to such sub-components in order to provide integrated functionality. Any components described herein may also interact with one or more other component(s) not specifically described herein but generally known by those of skill in the art.

In view of the exemplary systems described supra, methodologies that can be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more function(s) described herein, and similarly, storage can be effected across a plurality of devices. Accordingly, the invention should not be limited to any single embodiment, but rather should be construed in breadth, spirit and scope in accordance with the appended claims.

While the disclosed subject matter has been described in connection with the preferred embodiments of the various figures, it is to be understood that other similar embodiments may be used or modifications and additions may be made to the described embodiments for performing the same function of the disclosed subject matter without deviating therefrom. For example, one skilled in the art will recognize that aspects of the disclosed subject matter as described in the various embodiments of the present application may apply to programmable control of discrete processes in bio-analysis, chemical reactions, digital microfluidics, digital droplet display, and so on, etc.

In other instances, variations of process parameters (e.g., dimensions, configuration, concentrations, compositions, process step timing and order, addition and/or deletion of process steps, addition of preprocessing and/or post-processing steps, etc.) can be made to further optimize the provided structures, devices and methodologies, as shown and described herein. In any event, the structures and devices, as well as the associated methodologies described herein have many applications in microfluidics. Therefore, the disclosed subject matter should not be limited to any single embodiment described herein, but rather should be construed in breadth and scope in accordance with the appended claims.

What is claimed is:

1. A microfluidic system, comprising:
at least one channel network that facilitates at least one of generating or controlling at least one fluid droplet including at least one of an electrorheological (ER) fluid droplet, a non-electrorheological (non-ER) fluid droplet, or a gas bubble;
at least one electrode associated with at least a portion of the at least one channel network and adapted to apply an electric field to the at least a portion of the at least one channel network to influence flow of an ER fluid in the at least one channel network to facilitate the at least one of generating or controlling at least one fluid droplet; and
wherein the at least one electrode is configured to at least one of receive or send an electrical signal from or to at least a portion of a microfluidic controller component.

2. The microfluidic device of claim 1, wherein the ER fluid and ER fluid droplet comprise a giant electrorheological (GER) fluid and the non-ER fluid droplet comprises a fluid that lacks significant electrorheological effect relative to the ER fluid.

3. The microfluidic system of claim 1, wherein the at least one channel network comprises at least one droplet generation component adapted to generate the at least one fluid droplet.

4. The microfluidic system of claim 3, wherein the at least one droplet generation component comprises at least one of a flow-focusing junction or a T-junction.

5. The microfluidic system of claim 1, wherein the at least one channel network comprises at least one droplet control component.

6. The microfluidic system of claim 5, wherein the at least one droplet control component is further configured to facilitate at least one of droplet fission, droplet fusion, droplet sorting, droplet encoding, droplet digitalizing, droplet directional switching, droplet storage, droplet disposal, droplet order exchange, droplet arrangement, droplet size, volume, shape, spacing, or sequence specification, determining relative position of different types of droplets, or droplet display.

7. The microfluidic system of claim 1 further comprising at least one sensing component adapted to facilitate indication of at least one parameter of the ER fluid or the at least one of the ER fluid droplet, the non-ER fluid droplet, or the gas bubble in the at least one channel network.

8. A microfluidic method comprising:
applying an electric field to an electrorheological (ER) fluid in a fluid channel to facilitate at least one of generating or manipulating at least one fluid droplet in the fluid channel.

9. The method of claim 8, wherein the applying the electric field to the ER fluid includes applying the electric field to a giant electrorheological (GER) fluid.

10. The method of claim 8, wherein the generating or manipulating the at least one fluid droplet includes generating or manipulating at least one of an ER fluid droplet, a non-electrorheological (non-ER) fluid droplet including a fluid that lacks significant electrorheological effect relative to the ER fluid, or a gas bubble.

11. The method of claim 8, further comprising generating the at least one fluid droplet.

12. The method of claim 11, wherein the generating includes generating the at least one fluid droplet with at least one of a flow-focusing junction or a T-junction.

13. The method of claim 11, wherein the generating includes generating the at least one fluid droplet having at least one of a predetermined droplet size, predetermined droplet shape, predetermined droplet separation from at least one adjacent droplet, or predetermined droplet timing relative to at least one other droplet.

14. The method of claim 8, further comprising manipulating the at least one fluid droplet.

15. The method of claim 14, wherein the manipulating includes accomplishing at least one of droplet fission, droplet fusion, droplet sorting, droplet encoding, droplet digitalizing, droplet directional switching, droplet storage, droplet disposal, droplet order exchange, droplet arrangement, droplet size, shape, spacing, or sequence specification, determining relative position of different types of droplets, or droplet display for the at least one fluid droplet.

16. The method of claim 8, wherein the applying includes applying the electric field with at least one electrode associated with the fluid channel in response to an electrical control signal to influence flow of the ER fluid in the fluid channel.

17. The method of claim 16, further comprising receiving the electrical control signal from at least a portion of a microfluidic controller.

18. A microfluidic device that facilitates at least one of generating or controlling at least one fluid droplet, the microfluidic device comprising:
a fluid channel network having at least one associated electrode;
the fluid channel network adapted to carry an electrorheological (ER) fluid and at least one of a non-electrorheological (non-ER) fluid or a gas; and
wherein the at least one associated electrode is adapted to receive an electrical signal to apply an electric field to at least a portion of the fluid channel network to change flow of the ER fluid in the fluid channel network to facilitate the at least one of generating or controlling the at least one fluid droplet.

19. The microfluidic device of claim 18, wherein the ER fluid comprises a giant electrorheological (GER) fluid and the non-ER fluid droplet comprises a fluid that lacks significant electrorheological effect relative to the ER fluid.

20. The microfluidic device of claim 18, wherein the at least one fluid droplet comprises at least one of an ER fluid droplet, a non-ER fluid droplet, or a gas bubble.

21. The microfluidic device of claim 18, wherein the fluid channel network further configured to generate the at least one fluid droplet.

22. The microfluidic device of claim 21, wherein the fluid channel network comprises at least one of a flow-focusing junction or a T-junction, wherein the at least one of the flow-focusing junction or the T-junction is adapted to generate the at least one fluid droplet.

23. The microfluidic device of claim 18, wherein the fluid channel network is configured to manipulate the at least one fluid droplet.

24. The microfluidic device of claim 23, wherein the fluid channel network is further configured to facilitate at least one of droplet fission, droplet fusion, droplet sorting, droplet encoding, droplet digitalizing, droplet directional switching, droplet storage, droplet disposal, droplet order exchange, droplet arrangement, droplet size, shape, spacing, or sequence specification, determining relative position of different types of droplets, or droplet display.
